(19) United States
(12) Patent Application Publication
(10) Pub. No.: US 2013/0296436 A1
(43) Pub. Date: Nov. 7, 2013

(54) AMIDINE COMPOUNDS AND USE THEREOF FOR PLANT DISEASE CONTROL

(71) Applicants: Tohru Inoue, Osaka-shi (JP); Yoshihiko Nokura, Takarazuka-shi (JP)

(72) Inventors: Tohru Inoue, Osaka-shi (JP); Yoshihiko Nokura, Takarazuka-shi (JP)

(73) Assignee: SUMITOMO CHEMICAL COMPANY, LIMITED

(21) Appl. No.: 13/997,019

(22) PCT Filed: Dec. 20, 2011
(86) PCT No.: PCT/JP2011/080136

§ 371 Date: Jun. 21, 2013

(30) Foreign Application Priority Data
Dec. 27, 2010 (JP) 2010-289608

(51) Int. Cl. A01N 37/52

(52) U.S. Cl. CPC A01N 37/52
USPC 514/637; 564/245

(57) ABSTRACT

An amidine compound represented by formula (1): wherein R¹ represent a C1-C11 fluoroalkyl group, a C3-C11 fluoroalkenyl group or a C3-C11 fluoroalkynyl group; R² represent a C1-C3 alkyl group; R³ represent a C1-C3 alkyl group; R⁴ represent a C3-C6 cycloalkyl group or a C1-C6 alkyl group optionally having one or more halogens and R⁵ represent a C3-C6 cycloalkyl group or a C1-C6 alkyl group optionally having one or more halogens, said compound having excellent plant disease controlling effect.

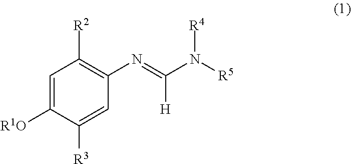

### TECHNICAL FIELD

The present invention relates to amidine compounds and use thereof for plant disease control.

### BACKGROUND ART

Hitherto, agents for controlling plant diseases have been developed, and compounds having a plant disease controlling effect have been found and put to practical use.

### DISCLOSURE OF THE INVENTION

### Problems to be Solved by the Invention

An object of the present invention is to provide a compound having excellent plant disease controlling effect.

### Means for Solving the Problems

As a result of intensive research conducted by the present inventors in an attempt to find compounds having excellent plant disease controlling effect, it has been found that amidine compounds represented by the following formula (1) have excellent plant disease controlling effect. Thus, the present invention has been accomplished.

That is, the present invention provides:

[1] An amidine compound represented by the formula (1):

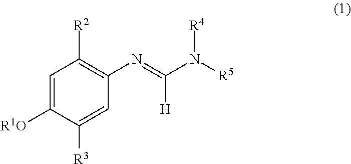

wherein R¹ represent a C1-C11 fluoroalkyl group, a C3-C11 fluoroalkenyl group or a C3-C11 fluoroalkynyl group;
R² represent a C1-C3 alkyl group;
R³ represent a C1-C3 alkyl group;
R⁴ represent a C3-C6 cycloalkyl group or a C1-C6 alkyl group optionally having one or more halogens and R⁵ represent a C3-C6 cycloalkyl group or a C1-C6 alkyl group optionally having one or more halogens (hereinafter referred to as the present compound);
[2] The amidine compound according to above [1], wherein R⁴ is a C1-C6 alkyl group optionally having one or more halogens and R⁵ is a C1-C6 alkyl group having one or more halogens;
[3] The amidine compound according to above [1], wherein R⁴ is a C1-C6 alkyl group and R⁵ is a C1-C6 alkyl group;
[4] A plant disease controlling agent, which comprises the amidine compound according to above [1] as an active ingredient;
[5] A method for controlling plant diseases, which comprises the step of applying an effective amount of the amidine compound according to above [1] to plants or soils; and
[6] Use of the amidine compound according to above [1] for controlling plant diseases.

### Effect of the Invention

The present compound has excellent plant disease controlling effect, and hence is useful as an active ingredient of plant disease controlling agents.

### MODE FOR CARRYING OUT THE INVENTION

The explanation of substituents of the present invention is as follows.

The C1-C11 fluoroalkyl group represents the C1-C11 alkyl group having one or more fluorines.

Examples of the C1-C11 fluoroalkyl group include a monofluoromethyl group, a difluoromethyl group, a trifluoromethyl group, a 2,2,2-trifluoroethyl group, a pentafluoroethyl group, a 2,2,3,3-tetrafluoropropyl group, a 2,2,3,3,3-pentafluoropropyl group, a heptafluoropropyl group, a 3,3,3-trifluoropropyl group, a 2-fluorobutyl group, a 4-fluorobutyl group, a 2,4-difluorobutyl group, a 2,2,4-trifluorobutyl group, a 2,4,4-trifluorobutyl group, a 2,2,4,4-tetrafluorobutyl group, a 2,4,4,4-tetrafluorobutyl group, a 2,2,4,4,4-pentafluorobutyl group, a 3,3,3-trifluoro-2-trifluoromethylpropyl group, a 2,2,3,4,4,4-hexafluorobutyl group, a 2,2,3,3,4,4,4-heptafluorobutyl group, a 4,4,4-trifluorobutyl group, a nonafluorobutyl group, a 4,4,4-trifluoro-3-trifluoromethylbutyl group, a 2,2-difluorobutyl group, a 2,2,3,3,4,4,5,5,5-nonafluoropentyl group, a 5,5,5-trifluoropentyl group, a undecafluoropentyl group, a 5,5,5-trifluoro-4-trifluoromethylpentyl group, a 2,2,3,3,4,4,5,5,6,6,6-undecafluorohexyl group, a 6,6,6-trifluorohexyl group, a tridecafluorohexyl group, a 6,6,6-trifluoro-5-trifluoromethylhexyl group, a 2-fluoropentyl group, a 2,2-difluoropentyl group, a (2-fluoro-4-methyl)pentyl group, a (2,2-difluoro-4-methyl)pentyl group, a 2,2,3,3,4,4,5,5,6,6,7,7,7-tridecafluoroheptyl group, a 7,7,7-trifluoroheptyl group, a pentadecafluoroheptyl group, a 7,7,7-trifluoro-6-trifluoromethylheptyl group, a (2-fluoro-4,4-dimethyl)pentyl group, a (2,2-difluoro-4,4-dimethyl)pentyl group, a 2,2,3,3,4,4,5,5,6,6,7,7,8,8,8-pentadecafluorooctyl group, a 8,8,8-trifluorooctyl group, a heptadecafluorooctyl group, a 8,8,8-trifluoro-7-trifluoromethyloctyl group, a 2,2,3,3,4,4,5,5,6,6,7,7,8,8,9,9,9-heptadecafluorononyl group, a 9,9,9-trifluorononyl group, a nonadecafluorononyl group, a 9,9,9-trifluoro-8-trifluoromethylnonyl group, a 2,2,3,3,4,4,5,5,6,6,7,7,8,8,9,9,10,10,10-nonadecafluorodecyl group, a 10,10,10-trifluorodecyl group, a henicosafluorodecyl group, a 10,10,10-trifluoro-9-trifluoromethyldecyl group, a 2,2,3,3,4,4,5,5,6,6,7,7,8,8,9,9,10,10,11,11,11-henicosafluoroundecyl group, a 11,11,11-trifluoroundecyl group and a tricosafluoroundecyl group.

The C3-C11 fluoroalkenyl group represents the C3-C11 alkenyl group having one or more fluorines.

Examples of the C3-C11 fluoroalkenyl group include a 2,3-difluoro-2-propenyl group, a 2,3,3-trifluoro-2-propenyl group, a 1,1,2,3,3-pentafluoro-2-propenyl group, a 2,3-difluoro-2-butenyl group, a 4,4,4-trifluoro-2-butenyl group, a 4,4-difluoro-3-butenyl group, a 2-fluoro-2-butenyl group, a 3-fluoro-2-butenyl group, a 3,4,4-trifluoro-3-butenyl group, a 5,5,5-trifluoro-2-pentenyl group, a 5,5,5-trifluoro-3-pentenyl group, a 5,5,5-trifluoro-4-trifluoromethyl-2-pentenyl group, a 5,5-difluoro-4-pentenyl group, a 3,4-difluoro-3-pentenyl group, a 2-fluoro-2-pentenyl group, a 3-fluoro-2-pentenyl group, a 4,5,5-trifluoro-4-pentenyl group, a 2-fluoro-4-methyl-2-pentenyl group, a 2-fluoro-4,4-dimethyl-2-pentenyl group, a 6,6,6-trifluoro-2-hexenyl group, a 6,6,6-trifluoro-3-hexenyl group, a 6,6,6-trifluoro-5-trifluoromethyl-2-hexenyl group, a 6,6-difluoro-5-hexenyl group, a 7,7,7-trifluoro-2-heptenyl group, a 7,7,7-trifluoro-67-trifluoromethyl-2-heptenyl group, a 8,8,8-trifluoro-5-octenyl group, a 8,8,8-trifluoro-7-trifluoromethyl-3-octenyl group, a 9,9,9-trifluoro-2-nonenyl group, a 9,9,9-trifluoro-8-trifluoromethyl-2-nonenyl group, a 10,10,10-trifluoro-4-decenyl group, a 10,10,10-trifluoro-9-trifluoromethyl-8-decenyl group and a 11,11,11-trifluoro-2-undecenyl group.

The C3-C11 fluoroalkynyl group represents the C3-C11 alkynyl group having one or more fluorines.

Examples of the C3-C11 fluoroalkynyl group include a 1-fluoro-2-propynyl group, a 1,4-difluoro-2-butynyl group, a 4,4,4-trifluoro-2-butynyl group, a 4-fluoro-2-butynyl group, a 4,4-difluoro-2-butynyl group, a 2-fluoro-3-butynyl group, a 5,5,5-trifluoro-3-pentynyl group, a 5,5,5-trifluoro-2-pentynyl group, a 4-fluoro-2-pentynyl group, a 5,5-difluoro-2-pentynyl group, a 2-fluoro-3-pentynyl group, a 2,5,5,5-tetrafluoro-3-pentynyl group, a 2,2,3,3-tetrafluoro-4-pentynyl group, a 3-fluoro-4-pentynyl group, a 5,5,6,6,6-pentafluoro-2-hexynyl group, a 6,6,6-trifluoro-5-trifluoromethyl-2-hexynyl group, a 7,7,7-trifluoro-3-heptynyl group, a 7,7,7-trifluoro-6-trifluoromethyl-2-heptynyl group, a 8,8,8-trifluoro-2-octynyl group, a 8,8,8-trifluoro-7-trifluoromethyl-4-octynyl group, a 9,9,9-trifluoro-2-nonyl group, a 9,9,9-trifluoro-8-trifluoromethyl-2-nonyl group, a 10,10,10-trifluoro-2-decynyl group, a 10,10,10-trifluoro-9-trifluoromethyl-6-decynyl group and a 11,11,11-trifluoro-5-undecynyl group.

Examples of C1-C3 alkyl group include a methyl group, an ethyl group, a propyl group and an isopropyl group.

The C1-C6 alkyl group optionally having one or more halogens represents the C1-C6 alkyl group and the C1-C6 haloalkyl group.

Examples of the C1-C6 alkyl group include a methyl group, an ethyl group, a propyl group, an isopropyl group, a butyl group, an isobutyl group, a tert-butyl group, a pentyl group, a 2-methylbutyl group, a 3-methylbutyl group, a 2-methylpentyl group, a 3-methylpentyl group, a 4-methylpentyl group and a hexyl group.

The C1-C6 haloalkyl group is the C1-C6 alkyl group having one or more halogen atoms, provided that when it has two or more halogen atoms, then the halogen atoms may be same or different.

Examples of the C1-C6 haloalkyl group include a monofluoromethyl group, a difluoromethyl group, a trifluoromethyl group, a pentafluoroethyl group, a heptafluoropropyl group, a nonafluorobutyl group, an undecafluoropentyl group, a tridecafluorohexyl group, a 2-chloropropyl group, a 2-bromopropyl group, a 2-iodopropyl group, a 6-chlorohexyl group, a 6-bromohexyl group and a 6-iodohexyl group.

Examples of the C3-C6 cycloalkyl group include a cyclopropyl group, a cyclobutyl group, a cyclopentyl group and a cyclohexyl group.

Examples of the amidine compound represent by the formula (1) include:

an amidine compound represented by the formula (1), wherein R¹ is a C1-C11 fluoroalkyl group;
an amidine compound represented by the formula (1), wherein R¹ is a C3-C11 fluoroalkenyl group;
an amidine compound represented by the formula (1), wherein R¹ is a C3-C11 fluoroalkynyl group;
an amidine compound represented by the formula (1), wherein R¹ is a C1-C6 fluoroalkyl group;
an amidine compound represented by the formula (1), wherein R¹ is a C3-C6 fluoroalkenyl group;
an amidine compound represented by the formula (1), wherein R¹ is a C3-C6 fluoroalkynyl group;
an amidine compound represented by the formula (1), wherein R¹ is a C7-C11 fluoroalkyl group;
an amidine compound represented by the formula (1), wherein R¹ is a C7-C11 fluoroalkenyl group;
an amidine compound represented by the formula (1), wherein R¹ is a C7-C11 fluoroalkynyl group;
an amidine compound represented by the formula (1), wherein R² is a methyl group;
an amidine compound represented by the formula (1), wherein R³ is a methyl group;
an amidine compound represented by the formula (1), wherein R⁴ is a C1-C6 alkyl group optionally having one or more halogens;
an amidine compound represented by the formula (1), wherein R⁴ is a C3-C6 cycloalkyl group;
an amidine compound represented by the formula (1), wherein R⁴ is a methyl group;
an amidine compound represented by the formula (1), wherein R⁵ is an ethyl group;
an amidine compound represented by the formula (1), wherein R¹ is a C1-C11 fluoroalkyl group and R² is a methyl group;
an amidine compound represented by the formula (1), wherein R¹ is a C3-C11 fluoroalkenyl group and R² is a methyl group;
an amidine compound represented by the formula (1), wherein R¹ is a C3-C11 fluoroalkynyl group and R² is a methyl group;
an amidine compound represented by the formula (1), wherein R¹ is a C1-C6 fluoroalkyl group and R² is a methyl group;
an amidine compound represented by the formula (1), wherein R¹ is a C3-C6 fluoroalkenyl group and R² is a methyl group;
an amidine compound represented by the formula (1), wherein R¹ is a C3-C6 fluoroalkynyl group and R² is a methyl group;
an amidine compound represented by the formula (1), wherein R¹ is a C7-C11 fluoroalkyl group and R² is a methyl group;
an amidine compound represented by the formula (1), wherein R¹ is a C7-C11 fluoroalkenyl group and R² is a methyl group;
an amidine compound represented by the formula (1), wherein R¹ is a C7-C11 fluoroalkynyl group and R² is a methyl group;
an amidine compound represented by the formula (1), wherein R¹ is a C1-C11 fluoroalkyl group and R³ is a methyl group;
an amidine compound represented by the formula (1), wherein R¹ is a C3-C11 fluoroalkenyl group and R³ is a methyl group;
an amidine compound represented by the formula (1), wherein R¹ is a C3-C11 fluoroalkynyl group and R³ is a methyl group;
an amidine compound represented by the formula (1), wherein R¹ is a C1-C6 fluoroalkyl group and R³ is a methyl group;
an amidine compound represented by the formula (1), wherein R¹ is a C3-C6 fluoroalkenyl group and R³ is a methyl group;
an amidine compound represented by the formula (1), wherein R¹ is a C3-C6 fluoroalkynyl group and R³ is a methyl group;
an amidine compound represented by the formula (1), wherein R¹ is a C7-C11 fluoroalkyl group and R³ is a methyl group;
an amidine compound represented by the formula (1), wherein R¹ is a C7-C11 fluoroalkenyl group and R³ is a methyl group;
an amidine compound represented by the formula (1), wherein R¹ is a C7-C11 fluoroalkynyl group and R³ is a methyl group;
an amidine compound represented by the formula (1), wherein R¹ is a C1-C11 fluoroalkyl group and R⁴ is a C1-C6 alkyl group optionally having one or more halogens;
an amidine compound represented by the formula (1), wherein R¹ is a C1-C11 fluoroalkyl group and R⁴ is a C3-C6 cycloalkyl group;
an amidine compound represented by the formula (1), wherein R¹ is a C3-C11 fluoroalkenyl group and R⁴ is a C1-C6 alkyl group optionally having one or more halogens;
an amidine compound represented by the formula (1), wherein R¹ is a C3-C11 fluoroalkenyl group and R⁴ is a C3-C6 cycloalkyl group;
an amidine compound represented by the formula (1), wherein R¹ is a C3-C11 fluoroalkynyl group and R⁴ is a C1-C6 alkyl group optionally having one or more halogens;
an amidine compound represented by the formula (1), wherein R¹ is a C3-C11 fluoroalkynyl group and R⁴ is a C3-C6 cycloalkyl group;
an amidine compound represented by the formula (1), wherein R¹ is a C1-C11 fluoroalkyl group and R⁴ is a methyl group;
an amidine compound represented by the formula (1), wherein R¹ is a C3-C11 fluoroalkenyl group and R⁴ is a methyl group;
an amidine compound represented by the formula (1), wherein R¹ is a C3-C11 fluoroalkynyl group and R⁴ is a methyl group;
an amidine compound represented by the formula (1), wherein R¹ is a C1-C6 fluoroalkyl group and R⁴ is a methyl group;
an amidine compound represented by the formula (1), wherein R¹ is a C3-C6 fluoroalkenyl group and R⁴ is a methyl group;
an amidine compound represented by the formula (1), wherein R¹ is a C3-C6 fluoroalkynyl group and R⁴ is a methyl group;
an amidine compound represented by the formula (1), wherein R¹ is a C7-C11 fluoroalkyl group and R⁴ is a methyl group;
an amidine compound represented by the formula (1), wherein R¹ is a C7-C11 fluoroalkenyl group and R⁴ is a methyl group;
an amidine compound represented by the formula (1), wherein R¹ is a C7-C11 fluoroalkynyl group and R⁴ is a methyl group;
an amidine compound represented by the formula (1), wherein R¹ is a C1-C6 fluoroalkyl group and R⁴ is a C1-C6 alkyl group optionally one or more halogens;
an amidine compound represented by the formula (1), wherein R¹ is a C3-C6 fluoroalkenyl group and R⁴ is a C1-C6 alkyl group optionally having one or more halogens;
an amidine compound represented by the formula (1), wherein R¹ is a C3-C6 fluoroalkynyl group and R⁴ is a C1-C6 alkyl group optionally having one or more halogens;
an amidine compound represented by the formula (1), wherein R¹ is a C7-C11 fluoroalkyl group and R⁴ is a C1-C6 alkyl group optionally having one or more halogens;
an amidine compound represented by the formula (1), wherein R¹ is a C7-C11 fluoroalkenyl group and R⁴ is a C1-C6 alkyl group optionally having one or more halogens;
an amidine compound represented by the formula (1), wherein R¹ is a C7-C11 fluoroalkynyl group and R⁴ is a C1-C6 alkyl group optionally having one or more halogens;
an amidine compound represented by the formula (1), wherein R¹ is a C1-C6 fluoroalkyl group and R⁴ is a C3-C6 cycloalkyl group;
an amidine compound represented by the formula (1), wherein R¹ is a C3-C6 fluoroalkenyl group and R⁴ is a C3-C6 cycloalkyl group;
an amidine compound represented by the formula (1), wherein R¹ is a C3-C6 fluoroalkynyl group and R⁴ is a C3-C6 cycloalkyl group;
an amidine compound represented by the formula (1), wherein R¹ is a C7-C11 fluoroalkyl group and R⁴ is a C3-C6 cycloalkyl group;
an amidine compound represented by the formula (1), wherein R¹ is a C7-C11 fluoroalkenyl group and R⁴ is a C3-C6 cycloalkyl group;
an amidine compound represented by the formula (1), wherein R¹ is a C7-C11 fluoroalkynyl group and R⁴ is a C3-C6 cycloalkyl group;
an amidine compound represented by the formula (1), wherein R¹ is a C1-C11 fluoroalkyl group and R⁵ is an ethyl group;
an amidine compound represented by the formula (1), wherein R¹ is a C3-C11 fluoroalkenyl group and R⁵ is an ethyl group;
an amidine compound represented by the formula (1), wherein R¹ is a C3-C11 fluoroalkynyl group and R⁵ is an ethyl group;
an amidine compound represented by the formula (1), wherein R¹ is a C1-C6 fluoroalkyl group and R⁵ is an ethyl group;
an amidine compound represented by the formula (1), wherein R¹ is a C3-C6 fluoroalkenyl group and R⁵ is an ethyl group;
an amidine compound represented by the formula (1), wherein R¹ is a C3-C6 fluoroalkynyl group and R⁵ is an ethyl group;
an amidine compound represented by the formula (1), wherein R¹ is a C7-C11 fluoroalkyl group and R⁵ is an ethyl group;
an amidine compound represented by the formula (1), wherein R¹ is a C7-C11 fluoroalkenyl group and R⁵ is an ethyl group;
an amidine compound represented by the formula (1), wherein R¹ is a C7-C11 fluoroalkynyl group and R⁵ is an ethyl group;
an amidine compound represented by the formula (1), wherein R² is a methyl group and R³ is a methyl group;
an amidine compound represented by the formula (1), wherein R² is a methyl group and R⁴ is a C1-C6 alkyl group optionally having one or more halogens;
an amidine compound represented by the formula (1), wherein R² is a methyl group and R⁴ is a C3-C6 cycloalkyl group;
an amidine compound represented by the formula (1), wherein R² is a methyl group and R⁴ is a methyl group;
an amidine compound represented by the formula (1), wherein R² is a methyl group and R⁵ is an ethyl group;
an amidine compound represented by the formula (1), wherein R³ is a methyl group and R⁴ is a C1-C6 alkyl group optionally having one or more halogens;
an amidine compound represented by the formula (1), wherein R³ is a methyl group and R⁴ is a C3-C6 cycloalkyl group;
an amidine compound represented by the formula (1), wherein R³ is a methyl group and R⁴ is a methyl group;
an amidine compound represented by the formula (1), wherein R³ is a methyl group and R⁵ is an ethyl group;
an amidine compound represented by the formula (1), wherein R⁴ is a C1-C6 alkyl group optionally having one or more halogens and R⁵ is a C1-C6 alkyl group optionally having one or more halogens;
an amidine compound represented by the formula (1), wherein R⁴ is a C1-C6 alkyl group optionally having one or more halogens and R⁵ is a C3-C6 cycloalkyl group;
an amidine compound represented by the formula (1), wherein R⁴ is a C3-C6 cycloalkyl group and R⁵ is a C3-C6 cycloalkyl group;
an amidine compound represented by the formula (1), wherein R⁴ is a methyl group and R⁵ is a C1-C6 alkyl group optionally having one or more halogens;
an amidine compound represented by the formula (1), wherein R⁴ is a methyl group and R⁵ is a C3-C6 cycloalkyl group;
an amidine compound represented by the formula (1), wherein R⁴ is a C1-C6 alkyl group optionally having one or more halogens and R⁵ is an ethyl group;
an amidine compound represented by the formula (1), wherein R⁴ is a C3-C6 cycloalkyl group and R⁵ is an ethyl group;
an amidine compound represented by the formula (1), wherein R⁴ is a methyl group and R⁵ is a methyl group;
an amidine compound represented by the formula (1), wherein R⁴ is a methyl group and R⁵ is an ethyl group;
an amidine compound represented by the formula (1), wherein R¹ is a C1-C11 fluoroalkyl group, R² is a methyl group and R³ is a methyl group;
an amidine compound represented by the formula (1), wherein R¹ is a C3-C11 fluoroalkenyl group, R² is a methyl group and R³ is a methyl group;
an amidine compound represented by the formula (1), wherein R¹ is a C3-C11 fluoroalkynyl group, R² is a methyl group and R³ is a methyl group;
an amidine compound represented by the formula (1), wherein R¹ is a C1-C6 fluoroalkyl group, R² is a methyl group and R³ is a methyl group;
an amidine compound represented by the formula (1), wherein R¹ is a C3-C6 fluoroalkenyl group, R² is a methyl group and R³ is a methyl group;
an amidine compound represented by the formula (1), wherein R¹ is a C3-C6 fluoroalkynyl group, R² is a methyl group and R³ is a methyl group;
an amidine compound represented by the formula (1), wherein R¹ is a C7-C11 fluoroalkyl group, R² is a methyl group and R³ is a methyl group;
an amidine compound represented by the formula (1), wherein R¹ is a C7-C11 fluoroalkenyl group, R² is a methyl group and R³ is a methyl group;
an amidine compound represented by the formula (1), wherein R¹ is a C7-C11 fluoroalkynyl group, R² is a methyl group and R³ is a methyl group;
an amidine compound represented by the formula (1), wherein R¹ is a C1-C11 fluoroalkyl group, R² is a methyl group and R⁴ is a methyl group;
an amidine compound represented by the formula (1), wherein R¹ is a C3-C11 fluoroalkenyl group, R² is a methyl group and R⁴ is a methyl group;
an amidine compound represented by the formula (1), wherein R¹ is a C3-C11 fluoroalkynyl group, R² is a methyl group and R⁴ is a methyl group;
an amidine compound represented by the formula (1), wherein R¹ is a C1-C6 fluoroalkyl group, R² is a methyl group and R⁴ is a methyl group;
an amidine compound represented by the formula (1), wherein R¹ is a C3-C6 fluoroalkenyl group, R² is a methyl group and R⁴ is a methyl group;
an amidine compound represented by the formula (1), wherein R¹ is a C3-C6 fluoroalkynyl group, R² is a methyl group and R⁴ is a methyl group;
an amidine compound represented by the formula (1), wherein R¹ is a C7-C11 fluoroalkyl group, R² is a methyl group and R⁴ is a methyl group;
an amidine compound represented by the formula (1), wherein R¹ is a C7-C11 fluoroalkenyl group, R² is a methyl group and R⁴ is a methyl group;
an amidine compound represented by the formula (1), wherein R¹ is a C7-C11 fluoroalkynyl group, R² is a methyl group and R⁴ is a methyl group;
an amidine compound represented by the formula (1), wherein R¹ is a C1-C11 fluoroalkyl group, R² is a methyl group and R⁴ is a C1-C6 alkyl group optionally having one or more halogens;
an amidine compound represented by the formula (1), wherein R¹ is a C1-C11 fluoroalkyl group, R² is a methyl group and R⁴ is a C3-C6 cycloalkyl group;
an amidine compound represented by the formula (1), wherein R¹ is a C3-C11 fluoroalkenyl group, R² is a methyl group and R⁴ is a C1-C6 alkyl group optionally having one or more halogens;
an amidine compound represented by the formula (1), wherein R¹ is a C3-C11 fluoroalkenyl group, R² is a methyl group and R⁴ is a C3-C6 cycloalkyl group;
an amidine compound represented by the formula (1), wherein R¹ is a C3-C11 fluoroalkynyl group, R² is a methyl group and R⁴ is a C1-C6 alkyl group optionally having one or more halogens;
an amidine compound represented by the formula (1), wherein R¹ is a C3-C11 fluoroalkynyl group, R² is a methyl group and R⁴ is a C3-C6 cycloalkyl group;
an amidine compound represented by the formula (1), wherein R¹ is a C1-C6 fluoroalkyl group, R² is a methyl group and R⁴ is a C1-C6 alkyl group optionally having one or more halogens;
an amidine compound represented by the formula (1), wherein R¹ is a C1-C6 fluoroalkyl group, R² is a methyl group and R⁴ is a C3-C6 cycloalkyl group;
an amidine compound represented by the formula (1), wherein R¹ is a C3-C6 fluoroalkenyl group, R² is a methyl group and R⁴ is a C1-C6 alkyl group optionally having one or more halogens;
an amidine compound represented by the formula (1), wherein R¹ is a C3-C6 fluoroalkenyl group, R² is a methyl group and R⁴ is a C3-C6 cycloalkyl group;
an amidine compound represented by the formula (1), wherein R¹ is a C3-C6 fluoroalkynyl group, R² is a methyl group and R⁴ is a C1-C6 alkyl group optionally having one or more halogens;
an amidine compound represented by the formula (1), wherein R¹ is a C3-C6 fluoroalkynyl group, R² is a methyl group and R⁴ is a C3-C6 cycloalkyl group;
an amidine compound represented by the formula (1), wherein R¹ is a C7-C11 fluoroalkyl group, R² is a methyl group and R⁴ is a C1-C6 alkyl group optionally having one or more halogens;
an amidine compound represented by the formula (1), wherein R¹ is a C7-C11 fluoroalkyl group, R² is a methyl group and R⁴ is a C3-C6 cycloalkyl group;
an amidine compound represented by the formula (1), wherein R¹ is a C7-C11 fluoroalkenyl group, R² is a methyl group and R⁴ is a C1-C6 alkyl group optionally having one or more halogens;
an amidine compound represented by the formula (1), wherein R¹ is a C7-C11 fluoroalkenyl group, R² is a methyl group and R⁴ is a C3-C6 cycloalkyl group;
an amidine compound represented by the formula (1), wherein R¹ is a C7-C11 fluoroalkynyl group, R² is a methyl group and R⁴ is a C1-C6 alkyl group optionally having one or more halogens;
an amidine compound represented by the formula (1), wherein R¹ is a C7-C11 fluoroalkynyl group, R² is a methyl group and R⁴ is a C3-C6 cycloalkyl group;
an amidine compound represented by the formula (1), wherein R¹ is a C1-C11 fluoroalkyl group, R² is a methyl group and R⁵ is an ethyl group;
an amidine compound represented by the formula (1), wherein R¹ is a C3-C11 fluoroalkenyl group, R² is a methyl group and R⁵ is an ethyl group;
an amidine compound represented by the formula (1), wherein R¹ is a C3-C11 fluoroalkynyl group, R² is a methyl group and R⁵ is an ethyl group;
an amidine compound represented by the formula (1), wherein R¹ is a C1-C6 fluoroalkyl group, R² is a methyl group and R⁵ is an ethyl group;
an amidine compound represented by the formula (1), wherein R¹ is a C3-C6 fluoroalkenyl group, R² is a methyl group and R⁵ is an ethyl group;
an amidine compound represented by the formula (1), wherein R¹ is a C3-C6 fluoroalkynyl group, R² is a methyl group and R⁵ is an ethyl group;
an amidine compound represented by the formula (1), wherein R¹ is a C7-C11 fluoroalkyl group, R² is a methyl group and R⁵ is an ethyl group;
an amidine compound represented by the formula (1), wherein R¹ is a C7-C11 fluoroalkenyl group, R² is methyl group and R⁵ is an ethyl group;
an amidine compound represented by the formula (1), wherein R¹ is a C7-C11 fluoroalkynyl group, R² is a methyl group and R⁵ is an ethyl group;
an amidine compound represented by the formula (1), wherein R¹ is a C1-C11 fluoroalkyl group, R³ is a methyl group and R⁴ is a methyl group;
an amidine compound represented by the formula (1), wherein R¹ is a C3-C11 fluoroalkenyl group, R³ is a methyl group and R⁴ is a methyl group;
an amidine compound represented by the formula (1), wherein R¹ is a C3-C11 fluoroalkynyl group, R³ is a methyl group and R⁴ is a methyl group;
an amidine compound represented by the formula (1), wherein R¹ is a C1-C6 fluoroalkyl group, R³ is a methyl group and R⁴ is a methyl group;
an amidine compound represented by the formula (1), wherein R¹ is a C3-C6 fluoroalkenyl group, R³ is a methyl group and R⁴ is a methyl group;
an amidine compound represented by the formula (1), wherein R¹ is a C3-C6 fluoroalkynyl group, R³ is a methyl group and R⁴ is a methyl group;
an amidine compound represented by the formula (1), wherein R¹ is a C7-C11 fluoroalkyl group, R³ is a methyl group and R⁴ is a methyl group;
an amidine compound represented by the formula (1), wherein R¹ is a C7-C11 fluoroalkenyl group, R³ is a methyl group and R⁴ is a methyl group;
an amidine compound represented by the formula (1), wherein R¹ is a C7-C11 fluoroalkynyl group, R³ is a methyl group and R⁴ is a methyl group;
an amidine compound represented by the formula (1), wherein R¹ is a C1-C11 fluoroalkyl group, R³ is a methyl group and R⁴ is a C1-C6 alkyl group optionally having one or more halogens;
an amidine compound represented by the formula (1), wherein R¹ is a C1-C11 fluoroalkyl group, R³ is a methyl group and R⁴ is a C3-C6 cycloalkyl group;
an amidine compound represented by the formula (1), wherein R¹ is a C3-C11 fluoroalkenyl group, R³ is a methyl group and R⁴ is a C1-C6 alkyl group optionally having one or more halogens;
an amidine compound represented by the formula (1), wherein R¹ is a C3-C11 fluoroalkenyl group, R³ is a methyl group and R⁴ is a C3-C6 cycloalkyl group;
an amidine compound represented by the formula (1), wherein R¹ is a C3-C11 fluoroalkynyl group, R³ is a methyl group and R⁴ is a C1-C6 alkyl group optionally having one or more halogens;
an amidine compound represented by the formula (1), wherein R¹ is a C3-C11 fluoroalkynyl group, R³ is a methyl group and R⁴ is a C3-C6 cycloalkyl group;
an amidine compound represented by the formula (1), wherein R¹ is a C1-C6 fluoroalkyl group, R³ is a methyl group and R⁴ is a C1-C6 alkyl group optionally having one or more halogens;
an amidine compound represented by the formula (1), wherein R¹ is a C1-C6 fluoroalkyl group, R³ is a methyl group and R⁴ is a C3-C6 cycloalkyl group;
an amidine compound represented by the formula (1), wherein R¹ is a C3-C6 fluoroalkenyl group, R³ is a methyl group and R⁴ is a C1-C6 alkyl group optionally having one or more halogens;
an amidine compound represented by the formula (1), wherein R¹ is a C3-C6 fluoroalkenyl group, R³ is a methyl group and R⁴ is a C3-C6 cycloalkyl group;
an amidine compound represented by the formula (1), wherein R¹ is a C3-C6 fluoroalkynyl group, R³ is a methyl group and R⁴ is a C1-C6 alkyl group optionally having one or more halogens;
an amidine compound represented by the formula (1), wherein R¹ is a C3-C6 fluoroalkynyl group, R³ is a methyl group and R⁴ is a C3-C6 cycloalkyl group;
an amidine compound represented by the formula (1), wherein R¹ is a C7-C11 fluoroalkyl group, R³ is a methyl group and R⁴ is a C1-C6 alkyl group optionally having one or more halogens;
an amidine compound represented by the formula (1), wherein R¹ is a C7-C11 fluoroalkyl group, R³ is a methyl group and R⁴ is a C3-C6 cycloalkyl group;
an amidine compound represented by the formula (1), wherein R¹ is a C7-C11 fluoroalkenyl group, R³ is a methyl group and R⁴ is a C1-C6 alkyl group optionally having one or more halogens;
an amidine compound represented by the formula (1), wherein R¹ is a C7-C11 fluoroalkenyl group, R³ is a methyl group and R⁴ is a C3-C6 cycloalkyl group;
an amidine compound represented by the formula (1), wherein R¹ is a C3-C6 fluoroalkynyl group, R³ is a methyl group and R⁴ is a C1-C6 alkyl group optionally having one or more halogens;
an amidine compound represented by the formula (1), wherein R¹ is a C3-C6 fluoroalkynyl group, R³ is a methyl group and R⁴ is a C3-C6 cycloalkyl group;
an amidine compound represented by the formula (1), wherein R¹ is a C1-C11 fluoroalkyl group, R³ is a methyl group and R⁵ is an ethyl group;
an amidine compound represented by the formula (1), wherein R¹ is a C3-C11 fluoroalkenyl group, R³ is a methyl group and R⁵ is an ethyl group;
an amidine compound represented by the formula (1), wherein R¹ is a C3-C11 fluoroalkynyl group, R³ is a methyl group and R⁵ is an ethyl group;
an amidine compound represented by the formula (1), wherein R¹ is a C1-C6 fluoroalkyl group, R³ is a methyl group and R⁵ is an ethyl group;
an amidine compound represented by the formula (1), wherein R¹ is a C3-C6 fluoroalkenyl group, R³ is a methyl group and R⁵ is an ethyl group;
an amidine compound represented by the formula (1), wherein R¹ is a C3-C6 fluoroalkynyl group, R³ is a methyl group and R⁵ is an ethyl group;
an amidine compound represented by the formula (1), wherein R¹ is a C7-C11 fluoroalkyl group, R³ is a methyl group and R⁵ is an ethyl group;
an amidine compound represented by the formula (1), wherein R¹ is a C7-C11 fluoroalkenyl group, R³ is a methyl group and R⁵ is an ethyl group;
an amidine compound represented by the formula (1), wherein R¹ is a C7-C11 fluoroalkynyl group, R³ is a methyl group and R⁵ is an ethyl group;
an amidine compound represented by the formula (1), wherein R¹ is a C1-C11 fluoroalkyl group, R⁴ is a C1-C6 alkyl group optionally having one or more halogens and R⁵ is a C1-C6 alkyl group optionally having one or more halogens;
an amidine compound represented by the formula (1), wherein R¹ is a C3-C11 fluoroalkenyl group, R⁴ is a C1-C6 alkyl group optionally having one or more halogens and R⁵ is a C1-C6 alkyl group optionally having one or more halogens;
an amidine compound represented by the formula (1), wherein R¹ is a C3-C11 fluoroalkynyl group, R⁴ is a C1-C6 alkyl group optionally having one or more halogens and R⁵ is a C1-C6 alkyl group optionally having one or more halogens;
an amidine compound represented by the formula (1), wherein R¹ is a C1-C11 fluoroalkyl group, R⁴ is a C1-C6 alkyl group optionally having one or more halogens and R⁵ is a C3-C6 cycloalkyl group;
an amidine compound represented by the formula (1), wherein R¹ is a C3-C11 fluoroalkenyl group, R⁴ is a C1-C6 alkyl group optionally having one or more halogens and R⁵ is a C3-C6 cycloalkyl group;
an amidine compound represented by the formula (1), wherein R¹ is a C3-C11 fluoroalkynyl group, R⁴ is a C1-C6 alkyl group optionally having one or more halogens and R⁵ is a C3-C6 cycloalkyl group;
an amidine compound represented by the formula (1), wherein R¹ is a C1-C11 fluoroalkyl group, R⁴ is a C3-C6 cycloalkyl group and R⁵ is a C3-C6 cycloalkyl group;
an amidine compound represented by the formula (1), wherein R¹ is a C3-C11 fluoroalkenyl group, R⁴ is a C3-C6 cycloalkyl group and R⁵ is a C3-C6 cycloalkyl group;
an amidine compound represented by the formula (1), wherein R¹ is a C3-C11 fluoroalkynyl group, R⁴ is a C3-C6 cycloalkyl group and R⁵ is a C3-C6 cycloalkyl group;
an amidine compound represented by the formula (1), wherein R¹ is a C1-C11 fluoroalkyl group, R⁴ is a C1-C6 alkyl group optionally having one or more halogens and R⁵ is a methyl group;
an amidine compound represented by the formula (1), wherein R¹ is a C1-C11 fluoroalkyl group, R⁴ is a C1-C6 alkyl group optionally having one or more halogens and R⁵ is an ethyl group;
an amidine compound represented by the formula (1), wherein R¹ is a C3-C11 fluoroalkenyl group, R⁴ is a C1-C6 alkyl group optionally having one or more halogens and R⁵ is a methyl group;
an amidine compound represented by the formula (1), wherein R¹ is a C3-C11 fluoroalkenyl group, R⁴ is a C1-C6 alkyl group optionally having one or more halogens and R⁵ is an ethyl group;
an amidine compound represented by the formula (1), wherein R¹ is a C3-C11 fluoroalkynyl group, R⁴ is a C1-C6 alkyl group optionally having one or more halogens and R⁵ is a methyl group;
an amidine compound represented by the formula (1), wherein R¹ is a C3-C11 fluoroalkynyl group, R⁴ is a C1-C6 alkyl group optionally having one or more halogens and R⁵ is an ethyl group;
an amidine compound represented by the formula (1), wherein R¹ is a C1-C11 fluoroalkyl group, R⁴ is a C3-C6 cycloalkyl group and R⁵ is a methyl group;
an amidine compound represented by the formula (1), wherein R¹ is a C1-C11 fluoroalkyl group, R⁴ is a C3-C6 cycloalkyl group and R⁵ is an ethyl group;
an amidine compound represented by the formula (1), wherein R¹ is a C3-C11 fluoroalkenyl group, R⁴ is a C3-C6 cycloalkyl group and R⁵ is a methyl group;
an amidine compound represented by the formula (1), wherein R¹ is a C3-C11 fluoroalkenyl group, R⁴ is a C3-C6 cycloalkyl group and R⁵ is an ethyl group;
an amidine compound represented by the formula (1), wherein R¹ is a C3-C11 fluoroalkynyl group, R⁴ is a C3-C6 cycloalkyl group and R⁵ is a methyl group;
an amidine compound represented by the formula (1), wherein R¹ is a C3-C11 fluoroalkynyl group, R⁴ is a C3-C6 cycloalkyl group and R⁵ is an ethyl group;
an amidine compound represented by the formula (1), wherein R¹ is a C1-C6 fluoroalkyl group, R⁴ is a C1-C6 alkyl group optionally having one or more halogens and R⁵ is a C1-C6 alkyl group optionally having one or more halogens;
an amidine compound represented by the formula (1), wherein R¹ is a C7-C11 fluoroalkyl group, R⁴ is a C1-C6 alkyl group optionally having one or more halogens and R⁵ is a C1-C6 alkyl group optionally having one or more halogens;
an amidine compound represented by the formula (1), wherein R¹ is a C3-C6 fluoroalkenyl group, R⁴ is a C1-C6 alkyl group optionally having one or more halogens and R⁵ is a C1-C6 alkyl group optionally having one or more halogens;
an amidine compound represented by the formula (1), wherein R¹ is a C7-C11 fluoroalkenyl group, R⁴ is a C1-C6 alkyl group optionally having one or more halogens and R⁵ is a C1-C6 alkyl group optionally having one or more halogens;
an amidine compound represented by the formula (1), wherein R¹ is a C3-C6 fluoroalkynyl group, R⁴ is a C1-C6 alkyl group optionally having one or more halogens and R⁵ is a C1-C6 alkyl group optionally having one or more halogens;
an amidine compound represented by the formula (1), wherein R¹ is a C7-C11 fluoroalkynyl group, R⁴ is a C1-C6 alkyl group optionally having one or more halogens and R⁵ is a C1-C6 alkyl group optionally having one or more halogens;
an amidine compound represented by the formula (1), wherein R¹ is a C1-C6 fluoroalkyl group, R⁴ is a C1-C6 alkyl group optionally having one or more halogens and R⁵ is a C3-C6 cycloalkyl group;
an amidine compound represented by the formula (1), wherein R¹ is a C7-C11 fluoroalkyl group, R⁴ is a C1-C6 alkyl group optionally having one or more halogens and R⁵ is a C3-C6 cycloalkyl group;
an amidine compound represented by the formula (1), wherein R¹ is a C3-C6 fluoroalkenyl group, R⁴ is a C1-C6 alkyl group optionally having one or more halogens and R⁵ is a C3-C6 cycloalkyl group;
an amidine compound represented by the formula (1), wherein R¹ is a C7-C11 fluoroalkenyl group, R⁴ is a C1-C6 alkyl group optionally having one or more halogens and R⁵ is a C3-C6 cycloalkyl group;
an amidine compound represented by the formula (1), wherein R¹ is a C3-C6 fluoroalkynyl group, R⁴ is a C1-C6 alkyl group optionally having one or more halogens and R⁵ is a C3-C6 cycloalkyl group;
an amidine compound represented by the formula (1), wherein R¹ is a C7-C11 fluoroalkynyl group, R⁴ is a C1-C6 alkyl group optionally having one or more halogens and R⁵ is a C3-C6 cycloalkyl group;
an amidine compound represented by the formula (1), wherein R¹ is a C1-C6 fluoroalkyl group, R⁴ is a C3-C6 cycloalkyl group and R⁵ is a C3-C6 cycloalkyl group;
an amidine compound represented by the formula (1), wherein R¹ is a C7-C11 fluoroalkyl group, R⁴ is a C3-C6 cycloalkyl group and R⁵ is a C3-C6 cycloalkyl group;
an amidine compound represented by the formula (1), wherein R¹ is a C3-C6 fluoroalkenyl group, R⁴ is a C3-C6 cycloalkyl group and R⁵ is a C3-C6 cycloalkyl group;
an amidine compound represented by the formula (1), wherein R¹ is a C7-C11 fluoroalkenyl group, R⁴ is a C3-C6 cycloalkyl group and R⁵ is a C3-C6 cycloalkyl group;
an amidine compound represented by the formula (1), wherein R¹ is a C3-C6 fluoroalkynyl group, R⁴ is a C3-C6 cycloalkyl group and R⁵ is a C3-C6 cycloalkyl group;
an amidine compound represented by the formula (1), wherein R¹ is a C7-C11 fluoroalkynyl group, R⁴ is a C3-C6 cycloalkyl group and R⁵ is a C3-C6 cycloalkyl group;
an amidine compound represented by the formula (1), wherein R¹ is a C1-C6 fluoroalkyl group, R⁴ is a C1-C6 alkyl group optionally having one or more halogens and R⁵ is a methyl group;
an amidine compound represented by the formula (1), wherein R¹ is a C7-C11 fluoroalkyl group, R⁴ is a C1-C6 alkyl group optionally having one or more halogens and R⁵ is a methyl group;
an amidine compound represented by the formula (1), wherein R¹ is a C3-C6 fluoroalkenyl group, R⁴ is a C1-C6 alkyl group optionally having one or more halogens and R⁵ is a methyl group;
an amidine compound represented by the formula (1), wherein R¹ is a C7-C11 fluoroalkenyl group, R⁴ is a C1-C6 alkyl group optionally having one or more halogens and R⁵ is a methyl group;
an amidine compound represented by the formula (1), wherein R¹ is a C3-C6 fluoroalkynyl group, R⁴ is a C1-C6 alkyl group optionally having one or more halogens, R⁵ is a methyl group;
an amidine compound represented by the formula (1), wherein R¹ is a C7-C11 fluoroalkynyl group, R⁴ is a C1-C6 alkyl group optionally having one or more halogens and R⁵ is a methyl group;
an amidine compound represented by the formula (1), wherein R¹ is a C1-C6 fluoroalkyl group, R⁴ is a C1-C6 alkyl group optionally having one or more halogens and R⁵ is an ethyl group;
an amidine compound represented by the formula (1), wherein R¹ is a C7-C11 fluoroalkyl group, R⁴ is a C1-C6 alkyl group optionally having one or more halogens and R⁵ is an ethyl group;
an amidine compound represented by the formula (1), wherein R¹ is a C3-C6 fluoroalkenyl group, R⁴ is a C1-C6 alkyl group optionally having one or more halogens and R⁵ is an ethyl group;
an amidine compound represented by the formula (1), wherein R¹ is a C7-C11 fluoroalkenyl group, R⁴ is a C1-C6 alkyl group optionally having one or more halogens and R⁵ is an ethyl group;
an amidine compound represented by the formula (1), wherein R¹ is a C3-C6 fluoroalkynyl group, R⁴ is a C1-C6 alkyl group optionally having one or more halogens and R⁵ is an ethyl group;
an amidine compound represented by the formula (1), wherein R¹ is a C7-C11 fluoroalkynyl group, R⁴ is a C1-C6 alkyl group optionally having one or more halogens and R⁵ is an ethyl group;
an amidine compound represented by the formula (1), wherein R² is a methyl group, R³ is a methyl group and R⁴ is a methyl group;
an amidine compound represented by the formula (1), wherein R² is a methyl group, R³ is a methyl group and R⁵ is an ethyl group;
an amidine compound represented by the formula (1), wherein R² is a methyl group, R⁴ is a methyl group and R⁵ is a C1-C6 alkyl group optionally having one or more halogens;
an amidine compound represented by the formula (1), wherein R² is a methyl group, R⁴ is a methyl group and R⁵ is a C3-C6 cycloalkyl group;
an amidine compound represented by the formula (1), wherein R² is a methyl group, R⁴ is a C1-C6 alkyl group optionally having one or more halogens and R⁵ is an ethyl group;
an amidine compound represented by the formula (1), wherein R² is a methyl group, R⁴ is C3-C6 cycloalkyl group and R⁵ is an ethyl group;
an amidine compound represented by the formula (1), wherein R² is a methyl group, R⁴ is a methyl group and R⁵ is a methyl group;
an amidine compound represented by the formula (1), wherein R² is a methyl group, R⁴ is a methyl group and R⁵ is an ethyl group;
an amidine compound represented by the formula (1), wherein R³ is a methyl group, R⁴ is a methyl group and R⁵ is a C1-C6 alkyl group optionally having one or more halogens;
an amidine compound represented by the formula (1), wherein R³ is a methyl group, R⁴ is a methyl group and R⁵ is a C3-C6 cycloalkyl group;
an amidine compound represented by the formula (1), wherein R³ is a methyl group, R⁴ is a C1-C6 alkyl group optionally having one or more halogens and R⁵ is an ethyl group;
an amidine compound represented by the formula (1), wherein R³ is a methyl group, R⁴ is a C3-C6 cycloalkyl group and R⁵ is an ethyl group;
an amidine compound represented by the formula (1), wherein R³ is a methyl group, R⁴ is a methyl group and R⁵ is a methyl group;
an amidine compound represented by the formula (1), wherein R³ is a methyl group, R⁴ is a methyl group and R⁵ is an ethyl group;
an amidine compound represented by the formula (1), wherein R¹ is a C1-C11 fluoroalkyl group, R² is a methyl group, R³ is a methyl group and R⁴ is a methyl group;
an amidine compound represented by the formula (1), wherein R¹ is a C3-C11 fluoroalkenyl group, R² is a methyl group, R³ is a methyl group and R⁴ is a methyl group;
an amidine compound represented by the formula (1), wherein R¹ is a C3-C11 fluoroalkynyl group, R² is a methyl group, R³ is a methyl group and R⁴ is a methyl group;
an amidine compound represented by the formula (1), wherein R¹ is a C1-C6 fluoroalkyl group, R² is a methyl group, R³ is a methyl group and R⁴ is a methyl group;
an amidine compound represented by the formula (1), wherein R¹ is a C3-C6 fluoroalkenyl group, R² is a methyl group, R³ is a methyl group and R⁴ is a methyl group;
an amidine compound represented by the formula (1), wherein R¹ is a C3-C6 fluoroalkynyl group, R² is a methyl group, R³ is a methyl group and R⁴ is a methyl group;
an amidine compound represented by the formula (1), wherein R¹ is a C7-C11 fluoroalkyl group, R² is a methyl group, R³ is a methyl group and R⁴ is a methyl group;
an amidine compound represented by the formula (1), wherein R¹ is a C7-C11 fluoroalkenyl group, R² is a methyl group, R³ is a methyl group and R⁴ is a methyl group;
an amidine compound represented by the formula (1), wherein R¹ is a C7-C11 fluoroalkynyl group, R² is a methyl group, R³ is a methyl group and R⁴ is a methyl group;
an amidine compound represented by the formula (1), wherein R¹ is a C1-C11 fluoroalkyl group, R² is a methyl group, R³ is a methyl group and R⁴ is a C1-C6 alkyl group optionally having one or more halogens;
an amidine compound represented by the formula (1), wherein R¹ is a C1-C11 fluoroalkyl group, R² is a methyl group, R³ is a methyl group and R⁴ is a C3-C6 cycloalkyl group;
an amidine compound represented by the formula (1), wherein R¹ is a C3-C11 fluoroalkenyl group, R² is a methyl group, R³ is a methyl group and R⁴ is a C1-C6 alkyl group optionally having one or more halogens;
an amidine compound represented by the formula (1), wherein R¹ is a C3-C11 fluoroalkenyl group, R² is a methyl group, R³ is a methyl group and R⁴ is C3-C6 a cycloalkyl group;
an amidine compound represented by the formula (1), wherein R¹ is a C3-C11 fluoroalkynyl group, R² is a methyl group, R³ is a methyl group and R⁴ is a C1-C6 alkyl group optionally having one or more halogens;
an amidine compound represented by the formula (1), wherein R¹ is a C3-C11 fluoroalkynyl group, R² is a methyl group, R³ is a methyl group and R⁴ is a C3-C6 cycloalkyl group;
an amidine compound represented by the formula (1), wherein R¹ is a C1-C6 fluoroalkyl group, R² is a methyl group, R³ is a methyl group and R⁴ is a C1-C6 alkyl group optionally having one or more halogens;
an amidine compound represented by the formula (1), wherein R¹ is a C1-C6 fluoroalkyl group, R² is a methyl group, R³ is a methyl group and R⁴ is a C3-C6 cycloalkyl group;
an amidine compound represented by the formula (1), wherein R¹ is a C3-C6 fluoroalkenyl group, R² is a methyl group, R³ is a methyl group and R⁴ is a C1-C6 alkyl group optionally having one or more halogens;
an amidine compound represented by the formula (1), wherein R¹ is a C3-C6 fluoroalkenyl group, R² is a methyl group, R³ is a methyl group and R⁴ is a C3-C6 cycloalkyl group;
an amidine compound represented by the formula (1), wherein R¹ is a C3-C6 fluoroalkynyl group, R² is a methyl group, R³ is a methyl group and R⁴ is a C1-C6 alkyl group optionally having one or more halogens;
an amidine compound represented by the formula (1), wherein R¹ is a C3-C6 fluoroalkynyl group, R² is a methyl group, R³ is a methyl group and R⁴ is a C3-C6 cycloalkyl group;
an amidine compound represented by the formula (1), wherein R¹ is a C7-C11 fluoroalkyl group, R² is a methyl group, R³ is a methyl group and R⁴ is a C1-C6 alkyl group optionally having one or more halogens;
an amidine compound represented by the formula (1), wherein R¹ is a C7-C11 fluoroalkyl group, R² is a methyl group, R³ is a methyl group and R⁴ is a C3-C6 cycloalkyl group;
an amidine compound represented by the formula (1), wherein R¹ is a C7-C11 fluoroalkenyl group, R² is a methyl group, R³ is a methyl group and R⁴ is a C1-C6 alkyl group optionally having one or more halogens;
an amidine compound represented by the formula (1), wherein R¹ is a C7-C11 fluoroalkenyl group, R² is a methyl group, R³ is a methyl group and R⁴ is a C3-C6 cycloalkyl group;
an amidine compound represented by the formula (1), wherein R¹ is a C3-C6 fluoroalkynyl group, R² is a methyl group, R³ is a methyl group and R⁴ is a C1-C6 alkyl group optionally having one or more halogens;
an amidine compound represented by the formula (1), wherein R¹ is a C3-C6 fluoroalkynyl group, R² is a methyl group, R³ is a methyl group and R⁴ is a C3-C6 cycloalkyl group;
an amidine compound represented by the formula (1), wherein R¹ is a C1-C11 fluoroalkyl group, R² is a methyl group, R³ is a methyl group and R⁵ is an ethyl group;
an amidine compound represented by the formula (1), wherein R¹ is a C3-C11 fluoroalkenyl group, R² is a methyl group, R³ is a methyl group and R⁵ is an ethyl group;
an amidine compound represented by the formula (1), wherein R¹ is a C3-C11 fluoroalkynyl group, R² is a methyl group, R³ is a methyl group and R⁵ is an ethyl group;
an amidine compound represented by the formula (1), wherein R¹ is a C1-C6 fluoroalkyl group, R² is a methyl group, R³ is a methyl group and R⁵ is an ethyl group;
an amidine compound represented by the formula (1), wherein R¹ is a C3-C6 fluoroalkenyl group, R² is a methyl group, R³ is a methyl group and R⁵ is an ethyl group;
an amidine compound represented by the formula (1), wherein R¹ is a C3-C6 fluoroalkynyl group, R² is a methyl group, R³ is a methyl group and R⁵ is an ethyl group;
an amidine compound represented by the formula (1), wherein R¹ is a C7-C11 fluoroalkyl group, R² is a methyl group, R³ is a methyl group and R⁵ is an ethyl group;
an amidine compound represented by the formula (1), wherein R¹ is a C7-C11 fluoroalkenyl group, R² is a methyl group, R³ is a methyl group and R⁵ is an ethyl group;
an amidine compound represented by the formula (1), wherein R¹ is a C7-C11 fluoroalkynyl group, R² is a methyl group, R³ is a methyl group and R⁵ is an ethyl group;
an amidine compound represented by the formula (1), wherein R¹ is a C1-C11 fluoroalkyl group, R² is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C3-C11 fluoroalkenyl group, R² is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C3-C11 fluoroalkynyl group, R² is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C1-C11 fluoroalkyl group, R² is a methyl group, R⁴ is a C1-C6 alkyl group optionally having one or more halogens and R⁵ is a C3-C6 cycloalkyl group;
an amidine compound represented by the formula (1), wherein R¹ is a C3-C11 fluoroalkenyl group, R² is a methyl group, R⁴ is a C1-C6 alkyl group optionally having one or more halogens and R⁵ is a C3-C6 cycloalkyl group;
an amidine compound represented by the formula (1), wherein R¹ is a C3-C11 fluoroalkynyl group, R² is a methyl group, R⁴ is a C1-C6 alkyl group optionally having one or more halogens and R⁵ is a C3-C6 cycloalkyl group;
an amidine compound represented by the formula (1), wherein R¹ is a C1-C11 fluoroalkyl group, R² is a methyl group, R⁴ is a C3-C6 cycloalkyl group and R⁵ is a C3-C6 cycloalkyl group;
an amidine compound represented by the formula (1), wherein R¹ is a C3-C11 fluoroalkenyl group, R² is a methyl group, R⁴ is a C3-C6 cycloalkyl group and R⁵ is a C3-C6 cycloalkyl group;
an amidine compound represented by the formula (1), wherein R¹ is a C3-C11 fluoroalkynyl group, R² is a methyl group, R⁴ is a C3-C6 cycloalkyl group and R⁵ is a C3-C6 cycloalkyl group;
an amidine compound represented by the formula (1), wherein R¹ is a C1-C11 fluoroalkyl group, R² is a methyl group, R⁴ is a C1-C6 alkyl group optionally having one or more halogens and R⁵ is a methyl group;
an amidine compound represented by the formula (1), wherein R¹ is a C1-C11 fluoroalkyl group, R² is a methyl group, R⁴ is a C1-C6 alkyl group optionally having one or more halogens and R⁵ is an ethyl group;
an amidine compound represented by the formula (1), wherein R¹ is a C3-C11 fluoroalkenyl group, R² is a methyl group, R⁴ is a C1-C6 alkyl group optionally having one or more halogens and R⁵ is a methyl group;
an amidine compound represented by the formula (1), wherein R¹ is a C3-C11 fluoroalkenyl group, R² is a methyl group, R⁴ is a C1-C6 alkyl group optionally having one or more halogens and R⁵ is an ethyl group;
an amidine compound represented by the formula (1), wherein R¹ is a C3-C11 fluoroalkynyl group, R² is a methyl group, R⁴ is a C1-C6 alkyl group optionally having one or more halogens and R⁵ is a methyl group;
an amidine compound represented by the formula (1), wherein R¹ is a C3-C11 fluoroalkynyl group, R² is a methyl group, R⁴ is a C1-C6 alkyl group optionally having one or more halogens and R⁵ is an ethyl group;
an amidine compound represented by the formula (1), wherein R¹ is a C1-C11 fluoroalkyl group, R² is a methyl group, R⁴ is a C3-C6 cycloalkyl group and R⁵ is a methyl group;
an amidine compound represented by the formula (1), wherein R¹ is a C1-C11 fluoroalkyl group, R² is a methyl group, R⁴ is a C3-C6 cycloalkyl group and R⁵ is an ethyl group;
an amidine compound represented by the formula (1), wherein R¹ is a C3-C11 fluoroalkenyl group, R² is a methyl group, R⁴ is a C3-C6 cycloalkyl group and R⁵ is a methyl group;
an amidine compound represented by the formula (1), wherein R¹ is a C3-C11 fluoroalkenyl group, R² is a methyl group, R⁴ is a C3-C6 cycloalkyl group and R⁵ is an ethyl group;
an amidine compound represented by the formula (1), wherein R¹ is a C3-C11 fluoroalkynyl group, R² is a methyl group, R⁴ is a C3-C6 cycloalkyl group and R⁵ is a methyl group;
an amidine compound represented by the formula (1), wherein R¹ is a C3-C11 fluoroalkynyl group, R² is a methyl group, R⁴ is a C3-C6 cycloalkyl group and R⁵ is an ethyl group;
an amidine compound represented by the formula (1), wherein R¹ is a C1-C6 fluoroalkyl group, R² is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C7-C11 fluoroalkyl group, R² is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C3-C6 fluoroalkenyl group, R² is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C7-C11 fluoroalkenyl group, R² is methyl group, R⁴ is a C1-C6 alkyl group optionally having one or more halogens and R⁵ is a C1-C6 alkyl group optionally having one or more halogens;
an amidine compound represented by the formula (1), wherein R¹ is a C3-C6 fluoroalkynyl group, R² is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C7-C11 fluoroalkynyl group, R² is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C1-C6 fluoroalkyl group, R² is a methyl group, R⁴ is a C1-C6 alkyl group optionally having one or more halogens and R⁵ is a C3-C6 cycloalkyl group;
an amidine compound represented by the formula (1), wherein R¹ is a C7-C11 fluoroalkyl group, R² is a methyl group, R⁴ is a C1-C6 alkyl group optionally having one or more halogens and R⁵ is a C3-C6 cycloalkyl group;
an amidine compound represented by the formula (1), wherein R¹ is a C3-C6 fluoroalkenyl group, R² is a methyl group, R⁴ is a C1-C6 alkyl group optionally having one or more halogens and R⁵ is a C3-C6 cycloalkyl group;
an amidine compound represented by the formula (1), wherein R¹ is a C7-C11 fluoroalkenyl group, R² is a methyl group, R⁴ is a C1-C6 alkyl group optionally having one or more halogens and R⁵ is a C3-C6 cycloalkyl group;
an amidine compound represented by the formula (1), wherein R¹ is a C3-C6 fluoroalkynyl group, R² is a methyl group, R⁴ is a C1-C6 alkyl group optionally having one or more halogens and R⁵ is a C3-C6 cycloalkyl group;
an amidine compound represented by the formula (1), wherein R¹ is a C7-C11 fluoroalkynyl group, R² is a methyl group, R⁴ is a C1-C6 alkyl group optionally having one or more halogens and R⁵ is a C3-C6 cycloalkyl group;
an amidine compound represented by the formula (1), wherein R¹ is a C1-C6 fluoroalkyl group, R² is a methyl group, R⁴ is a C3-C6 cycloalkyl group and R⁵ is a C3-C6 cycloalkyl group;
an amidine compound represented by the formula (1), wherein R¹ is a C7-C11 fluoroalkyl group, R² is a methyl group, R⁴ is a C3-C6 cycloalkyl group and R⁵ is a C3-C6 cycloalkyl group;
an amidine compound represented by the formula (1), wherein R¹ is a C3-C6 fluoroalkenyl group, R² is a methyl group, R⁴ is a C3-C6 cycloalkyl group and R⁵ is a C3-C6 cycloalkyl group;
an amidine compound represented by the formula (1), wherein R¹ is a C7-C11 fluoroalkenyl group, R² is a methyl group, R⁴ is a C3-C6 cycloalkyl group and R⁵ is a C3-C6 cycloalkyl group;
an amidine compound represented by the formula (1), wherein R¹ is a C3-C6 fluoroalkynyl group, R² is a methyl group, R⁴ is a C3-C6 cycloalkyl group and R⁵ is a C3-C6 cycloalkyl group;
an amidine compound represented by the formula (1), wherein R¹ is a C7-C11 fluoroalkynyl group, R² is a methyl group, R⁴ is a C3-C6 cycloalkyl group and R⁵ is a C3-C6 cycloalkyl group;
an amidine compound represented by the formula (1), wherein R¹ is a C1-C6 fluoroalkyl group, R² is a methyl group, R⁴ is a C1-C6 alkyl group optionally having one or more halogens and R⁵ is a methyl group;
an amidine compound represented by the formula (1), wherein R¹ is a C7-C11 fluoroalkyl group, R² is a methyl group, R⁴ is a C1-C6 alkyl group optionally having one or more halogens and R⁵ is a methyl group;
an amidine compound represented by the formula (1), wherein R¹ is a C3-C6 fluoroalkenyl group, R² is a methyl group, R⁴ is a C1-C6 alkyl group optionally having one or more halogens and R⁵ is a methyl group;
an amidine compound represented by the formula (1), wherein R¹ is a C7-C11 fluoroalkenyl group, R² is a methyl group, R⁴ is a C1-C6 alkyl group optionally having one or more halogens and R⁵ is a methyl group;
an amidine compound represented by the formula (1), wherein R¹ is a C3-C6 fluoroalkynyl group, R² is a methyl group, R⁴ is a C1-C6 alkyl group optionally having one or more halogens and R⁵ is a methyl group;
an amidine compound represented by the formula (1), wherein R¹ is a C7-C11 fluoroalkynyl group, R² is a methyl group, R⁴ is a C1-C6 alkyl group optionally having one or more halogens and R⁵ is a methyl group;
an amidine compound represented by the formula (1), wherein R¹ is a C1-C6 fluoroalkyl group, R² is a methyl group, R⁴ is a C1-C6 alkyl group optionally having one or more halogens and R⁵ is an ethyl group;
an amidine compound represented by the formula (1), wherein R¹ is a C7-C11 fluoroalkyl group, R² is a methyl group, R⁴ is a C1-C6 alkyl group optionally having one or more halogens and R⁵ is an ethyl group;
an amidine compound represented by the formula (1), wherein R¹ is a C3-C6 fluoroalkenyl group, R² is a methyl group, R⁴ is a C1-C6 alkyl group optionally having one or more halogens and R⁵ is an ethyl group;
an amidine compound represented by the formula (1), wherein R¹ is a C7-C11 fluoroalkenyl group, R² is a methyl group, R⁴ is a C1-C6 alkyl group optionally having one or more halogens and R⁵ is an ethyl group;
an amidine compound represented by the formula (1), wherein R¹ is a C3-C6 fluoroalkynyl group, R² is a methyl group, R⁴ is a C1-C6 alkyl group optionally having one or more halogens and R⁵ is an ethyl group;
an amidine compound represented by the formula (1), wherein R¹ is a C7-C11 fluoroalkynyl group, R² is a methyl group, R⁴ is a C1-C6 alkyl group optionally having one or more halogens and R⁵ is an ethyl group;
an amidine compound represented by the formula (1), wherein R¹ is a C1-C11 fluoroalkyl group, R³ is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C3-C11 fluoroalkenyl group, R³ is methyl group, R⁴ is a C1-C6 alkyl group optionally having one or more halogens and R⁵ is a C1-C6 alkyl group optionally having one or more halogens;
an amidine compound represented by the formula (1), wherein R¹ is a C3-C11 fluoroalkynyl group, R³ is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C1-C11 fluoroalkyl group, R³ is a methyl group, R⁴ is a C1-C6 alkyl group optionally having one or more halogens and R⁵ is a C3-C6 cycloalkyl group;
an amidine compound represented by the formula (1), wherein R¹ is a C3-C11 fluoroalkenyl group, R³ is a methyl group, R⁴ is a C1-C6 alkyl group optionally having one or more halogens and R⁵ is a C3-C6 cycloalkyl group;
an amidine compound represented by the formula (1), wherein R¹ is a C3-C11 fluoroalkynyl group, R³ is a methyl group, R⁴ is a C1-C6 alkyl group optionally having one or more halogens and R⁵ is a C3-C6 cycloalkyl group;
an amidine compound represented by the formula (1), wherein R¹ is a C1-C11 fluoroalkyl group, R³ is a methyl group, R⁴ is a C3-C6 cycloalkyl group and R⁵ is a C3-C6 cycloalkyl group;
an amidine compound represented by the formula (1), wherein R¹ is a C3-C11 fluoroalkenyl group, R³ is a methyl group, R⁴ is a C3-C6 cycloalkyl group and R⁵ is C3-C6 a cycloalkyl group;
an amidine compound represented by the formula (1), wherein R¹ is a C3-C11 fluoroalkynyl group, R³ is a methyl group, R⁴ is a C3-C6 cycloalkyl group and R⁵ is a C3-C6 cycloalkyl group;
an amidine compound represented by the formula (1), wherein R¹ is a C1-C11 fluoroalkyl group, R³ is a methyl group, R⁴ is C1-C6 a alkyl group optionally having one or more halogens and R⁵ is a methyl group;
an amidine compound represented by the formula (1), wherein R¹ is a C1-C11 fluoroalkyl group, R³ is a methyl group, R⁴ is a C1-C6 alkyl group optionally having one or more halogens and R⁵ is an ethyl group;
an amidine compound represented by the formula (1), wherein R¹ is a C3-C11 fluoroalkenyl group, R³ is a methyl group, R⁴ is a C1-C6 alkyl group optionally having one or more halogens and R⁵ is a methyl group;
an amidine compound represented by the formula (1), wherein R¹ is a C3-C11 fluoroalkenyl group, R³ is a methyl group, R⁴ is a C1-C6 alkyl group optionally having one or more halogens and R⁵ is an ethyl group;
an amidine compound represented by the formula (1), wherein R¹ is a C3-C11 fluoroalkynyl group, R³ is a methyl group, R⁴ is a C1-C6 alkyl group optionally having one or more halogens and R⁵ is a methyl group;
an amidine compound represented by the formula (1), wherein R¹ is a C3-C11 fluoroalkynyl group, R³ is a methyl group, R⁴ is a C1-C6 alkyl group optionally having one or more halogens and R⁵ is an ethyl group;
an amidine compound represented by the formula (1), wherein R¹ is a C1-C11 fluoroalkyl group, R³ is a methyl group, R⁴ is C3-C6 a cycloalkyl group and R⁵ is a methyl group;
an amidine compound represented by the formula (1), wherein R¹ is a C1-C11 fluoroalkyl group, R³ is a methyl group, R⁴ is a C3-C6 cycloalkyl group and R⁵ is an ethyl group;
an amidine compound represented by the formula (1), wherein R¹ is a C3-C11 fluoroalkenyl group, R³ is a methyl group, R⁴ is a C3-C6 cycloalkyl group and R⁵ is a methyl group;
an amidine compound represented by the formula (1), wherein R¹ is a C3-C11 fluoroalkenyl group, R³ is a methyl group, R⁴ is a C3-C6 cycloalkyl group and R⁵ is an ethyl group;
an amidine compound represented by the formula (1), wherein R¹ is a C3-C11 fluoroalkynyl group, R³ is a methyl group, R⁴ is a C3-C6 cycloalkyl group and R⁵ is a methyl group;
an amidine compound represented by the formula (1), wherein R¹ is a C3-C11 fluoroalkynyl group, R³ is a methyl group, R⁴ is a C3-C6 cycloalkyl group and R⁵ is an ethyl group;
an amidine compound represented by the formula (1), wherein R¹ is a C1-C6 fluoroalkyl group, R³ is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C7-C11 fluoroalkyl group, R³ is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C3-C6 fluoroalkenyl group, R³ is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C7-C11 fluoroalkenyl group, R³ is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C3-C6 fluoroalkynyl group, R³ is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C7-C11 fluoroalkynyl group, R³ is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C1-C6 fluoroalkyl group, R³ is a methyl group, R⁴ is a C1-C6 alkyl group optionally having one or more halogens and R⁵ is a C3-C6 cycloalkyl group;
an amidine compound represented by the formula (1), wherein R¹ is a C7-C11 fluoroalkyl group, R³ is a methyl group, R⁴ is a C1-C6 alkyl group optionally having one or more halogens and R⁵ is a C3-C6 cycloalkyl group;
an amidine compound represented by the formula (1), wherein R¹ is a C3-C6 fluoroalkenyl group, R³ is a methyl group, R⁴ is a C1-C6 alkyl group optionally having one or more halogens and R⁵ is a C3-C6 cycloalkyl group;
an amidine compound represented by the formula (1), wherein R¹ is a C7-C11 fluoroalkenyl group, R³ is a methyl group, R⁴ is a C1-C6 alkyl group optionally having one or more halogens and R⁵ is a C3-C6 cycloalkyl group;
an amidine compound represented by the formula (1), wherein R¹ is a C3-C6 fluoroalkynyl group, R³ is a methyl group, R⁴ is a C1-C6 alkyl group optionally having one or more halogens and R⁵ is a C3-C6 cycloalkyl group;
an amidine compound represented by the formula (1), wherein R¹ is a C7-C11 fluoroalkynyl group, R³ is a methyl group, R⁴ is a C1-C6 alkyl group optionally having one or more halogens and R⁵ is a C3-C6 cycloalkyl group;
an amidine compound represented by the formula (1), wherein R¹ is a C1-C6 fluoroalkyl group, R³ is a methyl group, R⁴ is a C3-C6 cycloalkyl group and R⁵ is a C3-C6 cycloalkyl group;
an amidine compound represented by the formula (1), wherein R¹ is a C7-C11 fluoroalkyl group, R³ is a methyl group, R⁴ is a C3-C6 cycloalkyl group and R⁵ is a C3-C6 cycloalkyl group;
an amidine compound represented by the formula (1), wherein R¹ is a C3-C6 fluoroalkenyl group, R³ is a methyl group, R⁴ is a C3-C6 cycloalkyl group and R⁵ is a C3-C6 cycloalkyl group;
an amidine compound represented by the formula (1), wherein R¹ is a C7-C11 fluoroalkenyl group, R³ is a methyl group, R⁴ is a C3-C6 cycloalkyl group and R⁵ is a C3-C6 cycloalkyl group;
an amidine compound represented by the formula (1), wherein R¹ is a C3-C6 fluoroalkynyl group, R³ is a methyl group, R⁴ is a C3-C6 cycloalkyl group and R⁵ is a C3-C6 cycloalkyl group;
an amidine compound represented by the formula (1), wherein R¹ is a C7-C11 fluoroalkynyl group, R³ is a methyl group, R⁴ is a C3-C6 cycloalkyl group and R⁵ is a C3-C6 cycloalkyl group;
an amidine compound represented by the formula (1), wherein R¹ is a C1-C6 fluoroalkyl group, R³ is a methyl group, R⁴ is a C1-C6 alkyl group optionally having one or more halogens and R⁵ is a methyl group;
an amidine compound represented by the formula (1), wherein R¹ is a C7-C11 fluoroalkyl group, R³ is a methyl group, R⁴ is a C1-C6 alkyl group optionally having one or more halogens and R⁵ is a methyl group;
an amidine compound represented by the formula (1), wherein R¹ is a C3-C6 fluoroalkenyl group, R³ is a methyl group, R⁴ is a C1-C6 alkyl group optionally having one or more halogens and R⁵ is a methyl group;
an amidine compound represented by the formula (1), wherein R¹ is a C7-C11 fluoroalkenyl group, R³ is a methyl group, R⁴ is a C1-C6 alkyl group optionally having one or more halogens and R⁵ is a methyl group;
an amidine compound represented by the formula (1), wherein R¹ is a C3-C6 fluoroalkynyl group, R³ is a methyl group, R⁴ is a C1-C6 alkyl group optionally having one or more halogens and R⁵ is a methyl group;
an amidine compound represented by the formula (1), wherein R¹ is a C7-C11 fluoroalkynyl group, R³ is a methyl group, R⁴ is a C1-C6 alkyl group optionally having one or more halogens and R⁵ is a methyl group;
an amidine compound represented by the formula (1), wherein R¹ is a C1-C6 fluoroalkyl group, R³ is a methyl group, R⁴ is a C1-C6 alkyl group optionally having one or more halogens and R⁵ is an ethyl group;
an amidine compound represented by the formula (1), wherein R¹ is a C7-C11 fluoroalkyl group, R³ is a methyl group, R⁴ is a C1-C6 alkyl group optionally having one or more halogens and R⁵ is an ethyl group;
an amidine compound represented by the formula (1), wherein R¹ is a C3-C6 fluoroalkenyl group, R³ is a methyl group, R⁴ is a C1-C6 alkyl group optionally having one or more halogens and R⁵ is an ethyl group;
an amidine compound represented by the formula (1), wherein R¹ is a C7-C11 fluoroalkenyl group, R³ is a methyl group, R⁴ is a C1-C6 alkyl group optionally having one or more halogens and R⁵ is an ethyl group;
an amidine compound represented by the formula (1), wherein R¹ is a C3-C6 fluoroalkynyl group, R³ is a methyl group, R⁴ is a C1-C6 alkyl group optionally having one or more halogens, R⁵ is an ethyl group;
an amidine compound represented by the formula (1), wherein R¹ is a C7-C11 fluoroalkynyl group, R³ is a methyl group, R⁴ is a C1-C6 alkyl group optionally having one or more halogens and R⁵ is an ethyl group;
an amidine compound represented by the formula (1), wherein R² is a methyl group, R³ is a methyl group, R⁴ is a methyl group and R⁵ is a C1-C6 alkyl group optionally having one or more halogens;
an amidine compound represented by the formula (1), wherein R² is a methyl group, R³ is a methyl group, R⁴ is a methyl group and R⁵ is a C3-C6 cycloalkyl group;
an amidine compound represented by the formula (1), wherein R² is a methyl group, R³ is a methyl group, R⁴ is a C1-C6 alkyl group optionally having one or more halogens and R⁵ is an ethyl group;
an amidine compound represented by the formula (1), wherein R² is a methyl group, R³ is a methyl group, R⁴ is a C3-C6 cycloalkyl group and R⁵ is an ethyl group;
an amidine compound represented by the formula (1), wherein R² is a methyl group, R³ is a methyl group, R⁴ is a methyl group and R⁵ is a methyl group;
an amidine compound represented by the formula (1), wherein R² is a methyl group, R³ is a methyl group, R⁴ is a methyl group and R⁵ is an ethyl group;
an amidine compound represented by the formula (1), wherein R¹ is a C1-C11 fluoroalkyl group, R² is a methyl group, R³ is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C3-C11 fluoroalkenyl group, R² is a methyl group, R³ is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C3-C11 fluoroalkynyl group, R² is a methyl group, R³ is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C1-C11 fluoroalkyl group, R² is a methyl group, R³ is a methyl group, R⁴ is a C1-C6 alkyl group optionally having one or more halogens and R⁵ is a C3-C6 cycloalkyl group;
an amidine compound represented by the formula (1), wherein R¹ is a C3-C11 fluoroalkenyl group, R² is a methyl group, R³ is a methyl group, R⁴ is a C1-C6 alkyl group optionally having one or more halogens and R⁵ is a C3-C6 cycloalkyl group;
an amidine compound represented by the formula (1), wherein R¹ is a C3-C11 fluoroalkynyl group, R² is a methyl group, R³ is a methyl group, R⁴ is a C1-C6 alkyl group optionally having one or more halogens and R⁵ is a C3-C6 cycloalkyl group;
an amidine compound represented by the formula (1), wherein R¹ is a C1-C11 fluoroalkyl group, R² is a methyl group, R³ is a methyl group, R⁴ is a C3-C6 cycloalkyl group and R⁵ is a C3-C6 cycloalkyl group;
an amidine compound represented by the formula (1), wherein R¹ is a C3-C11 fluoroalkenyl group, R² is a methyl group, R³ is a methyl group, R⁴ is a C3-C6 cycloalkyl group and R⁵ is a C3-C6 cycloalkyl group;
an amidine compound represented by the formula (1), wherein R¹ is a C3-C11 fluoroalkynyl group, R² is a methyl group, R³ is a methyl group, R⁴ is a C3-C6 cycloalkyl group and R⁵ is a C3-C6 cycloalkyl group;
an amidine compound represented by the formula (1), wherein R¹ is a C1-C11 fluoroalkyl group, R² is a methyl group, R³ is a methyl group, R⁴ is a C1-C6 alkyl group optionally having one or more halogens and R⁵ is a methyl group;
an amidine compound represented by the formula (1), wherein R¹ is a C1-C11 fluoroalkyl group, R² is a methyl group, R³ is a methyl group, R⁴ is a C1-C6 alkyl group optionally having one or more halogens and R⁵ is an ethyl group;
an amidine compound represented by the formula (1), wherein R¹ is a C3-C11 fluoroalkenyl group, R² is a methyl group, R³ is a methyl group, R⁴ is a C1-C6 alkyl group optionally having one or more halogens and R⁵ is a methyl group;
an amidine compound represented by the formula (1), wherein R¹ is a C3-C11 fluoroalkenyl group, R² is a methyl group, R³ is a methyl group, R⁴ is a C1-C6 alkyl group optionally having one or more halogens and R⁵ is an ethyl group;
an amidine compound represented by the formula (1), wherein R¹ is a C3-C11 fluoroalkynyl group, R² is a methyl group, R³ is a methyl group, R⁴ is a C1-C6 alkyl group optionally having one or more halogens and R⁵ is a methyl group;
an amidine compound represented by the formula (1), wherein R¹ is a C3-C11 fluoroalkynyl group, R² is a methyl group, R³ is a methyl group, R⁴ is a C1-C6 alkyl group optionally having one or more halogens and R⁵ is an ethyl group;
an amidine compound represented by the formula (1), wherein R¹ is a C1-C11 fluoroalkyl group, R² is a methyl group, R³ is a methyl group, R⁴ is a C3-C6 cycloalkyl group and R⁵ is a methyl group;
an amidine compound represented by the formula (1), wherein R¹ is a C1-C11 fluoroalkyl group, R² is a methyl group, R³ is a methyl group, R⁴ is a C3-C6 cycloalkyl group and R⁵ is an ethyl group;
an amidine compound represented by the formula (1), wherein R¹ is a C3-C11 fluoroalkenyl group, R² is a methyl group, R³ is a methyl group, R⁴ is a C3-C6 cycloalkyl group and R⁵ is a methyl group;
an amidine compound represented by the formula (1), wherein R¹ is a C3-C11 fluoroalkenyl group, R² is a methyl group, R³ is a methyl group, R⁴ is a C3-C6 cycloalkyl group and R⁵ is an ethyl group;
an amidine compound represented by the formula (1), wherein R¹ is a C3-C11 fluoroalkynyl group, R² is a methyl group, R³ is a methyl group, R⁴ is a C3-C6 cycloalkyl group and R⁵ is a methyl group;
an amidine compound represented by the formula (1), wherein R¹ is a C3-C11 fluoroalkynyl group, R² is a methyl group, R³ is a methyl group, R⁴ is a C3-C6 cycloalkyl group and R⁵ is an ethyl group;
an amidine compound represented by the formula (1), wherein R¹ is a C1-C6 fluoroalkyl group, R² is a methyl group, R³ is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C7-C11 fluoroalkyl group, R² is a methyl group, R³ is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C3-C6 fluoroalkenyl group, R² is a methyl group, R³ is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C7-C11 fluoroalkenyl group, R² is a methyl group, R³ is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C3-C6 fluoroalkynyl group, R² is a methyl group, R³ is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C7-C11 fluoroalkynyl group, R² is a methyl group, R³ is a methyl group, R⁴ is a C1-C6 alkyl group optionally having one or more halogens and R⁵ is a C1-C6 alkyl group optionally having one or more halogens;
an amidine compound represented by the formula (1), wherein R¹ is a C1-C6 fluoroalkyl group, R² is a methyl group, R³ is a methyl group, R⁴ is a C1-C6 alkyl group optionally having one or more halogens and R⁵ is a C3-C6 cycloalkyl group;
an amidine compound represented by the formula (1), wherein R¹ is a C7-C11 fluoroalkyl group, R² is a methyl group, R³ is a methyl group, R⁴ is a C1-C6 alkyl group optionally having one or more halogens and R⁵ is a C3-C6 cycloalkyl group;
an amidine compound represented by the formula (1), wherein R¹ is a C3-C6 fluoroalkenyl group, R² is a methyl group, R³ is a methyl group, R⁴ is a C1-C6 alkyl group optionally having one or more halogens and R⁵ is a C3-C6 cycloalkyl group;
an amidine compound represented by the formula (1), wherein R¹ is a C7-C11 fluoroalkenyl group, R² is a methyl group, R³ is a methyl group, R⁴ is a C1-C6 alkyl group optionally having one or more halogens and R⁵ is a C3-C6 cycloalkyl group;
an amidine compound represented by the formula (1), wherein R¹ is a C3-C6 fluoroalkynyl group, R² is a methyl group, R³ is a methyl group, R⁴ is a C1-C6 alkyl group optionally having one or more halogens and R⁵ is a C3-C6 cycloalkyl group;
an amidine compound represented by the formula (1), wherein R¹ is a C7-C11 fluoroalkynyl group, R² is a methyl group, R³ is a methyl group, R⁴ is a C1-C6 alkyl group optionally having one or more halogens and R⁵ is a C3-C6 cycloalkyl group;
an amidine compound represented by the formula (1), wherein R¹ is a C1-C6 fluoroalkyl group, R² is a methyl group, R³ is a methyl group, R⁴ is a C3-C6 cycloalkyl group and R⁵ is a C3-C6 cycloalkyl group;
an amidine compound represented by the formula (1), wherein R¹ is a C7-C11 fluoroalkyl group, R² is a methyl group, R³ is a methyl group, R⁴ is a C3-C6 cycloalkyl group and R⁵ is a C3-C6 cycloalkyl group;
an amidine compound represented by the formula (1), wherein R¹ is a C3-C6 fluoroalkenyl group, R² is a methyl group, R³ is a methyl group, R⁴ is a C3-C6 cycloalkyl group and R⁵ is a C3-C6 cycloalkyl group;
an amidine compound represented by the formula (1), wherein R¹ is a C7-C11 fluoroalkenyl group, R² is a methyl group, R³ is a methyl group, R⁴ is a C3-C6 cycloalkyl group and R⁵ is a C3-C6 cycloalkyl group;
an amidine compound represented by the formula (1), wherein R¹ is a C3-C6 fluoroalkynyl group, R² is a methyl group, R³ is a methyl group, R⁴ is a C3-C6 cycloalkyl group and R⁵ is a C3-C6 cycloalkyl group;
an amidine compound represented by the formula (1), wherein R¹ is a C7-C11 fluoroalkynyl group, R² is a methyl group, R³ is a methyl group, R⁴ is a C3-C6 cycloalkyl group and R⁵ is a C3-C6 cycloalkyl group;
an amidine compound represented by the formula (1), wherein R¹ is a C1-C6 fluoroalkyl group, R² is a methyl group, R³ is a methyl group, R⁴ is a C1-C6 alkyl group optionally having one or more halogens and R⁵ is a methyl group;
an amidine compound represented by the formula (1), wherein R¹ is a C7-C11 fluoroalkyl group, R² is a methyl group, R³ is a methyl group, R⁴ is a C1-C6 alkyl group optionally having one or more halogens and R⁵ is a methyl group;
an amidine compound represented by the formula (1), wherein R¹ is a C3-C6 fluoroalkenyl group, R² is a methyl group, R³ is a methyl group, R⁴ is a C1-C6 alkyl group optionally having one or more halogens and R⁵ is a methyl group;
an amidine compound represented by the formula (1), wherein R¹ is a C7-C11 fluoroalkenyl group, R² is a methyl group, R³ is a methyl group, R⁴ is a C1-C6 alkyl group optionally having one or more halogens and R⁵ is a methyl group;
an amidine compound represented by the formula (1), wherein R¹ is a C3-C6 fluoroalkynyl group, R² is a methyl group, R³ is a methyl group, R⁴ is a C1-C6 alkyl group optionally having one or more halogens and R⁵ is a methyl group;
an amidine compound represented by the formula (1), wherein R¹ is a C7-C11 fluoroalkynyl group, R² is a methyl group, R³ is a methyl group, R⁴ is a C1-C6 alkyl group optionally having one or more halogens and R⁵ is a methyl group;
an amidine compound represented by the formula (1), wherein R¹ is a C1-C6 fluoroalkyl group, R² is a methyl group, R³ is a methyl group, R⁴ is a C1-C6 alkyl group optionally having one or more halogens and R⁵ is an ethyl group;
an amidine compound represented by the formula (1), wherein R¹ is a C7-C11 fluoroalkyl group, R² is a methyl group, R³ is a methyl group, R⁴ is a C1-C6 alkyl group optionally having one or more halogens and R⁵ is an ethyl group;
an amidine compound represented by the formula (1), wherein R¹ is a C3-C6 fluoroalkenyl group, R² is a methyl group, R³ is a methyl group, R⁴ is a C1-C6 alkyl group optionally having one or more halogens and R⁵ is an ethyl group;
an amidine compound represented by the formula (1), wherein R¹ is a C7-C11 fluoroalkenyl group, R² is a methyl group, R³ is a methyl group, R⁴ is a C1-C6 alkyl group optionally having one or more halogens and R⁵ is an ethyl group;
an amidine compound represented by the formula (1), wherein R¹ is a C3-C6 fluoroalkynyl group, R² is a methyl group, R³ is a methyl group, R⁴ is a C1-C6 alkyl group optionally having one or more halogens and R⁵ is an ethyl group;
and
an amidine compound represented by the formula (1), wherein R¹ is a C7-C11 fluoroalkynyl group, R² is a methyl group, R³ is a methyl group, R⁴ is a C1-C6 alkyl group optionally having one or more halogens and R⁵ is an ethyl group.

### (Production Method 1)

The present compound can be produced by reacting a compound represented formula (2) as follows (hereinafter referred to as Compound (2)) and a compound represented formula (3) as follows (hereinafter referred to as Compound (3)) in the presence of a base.

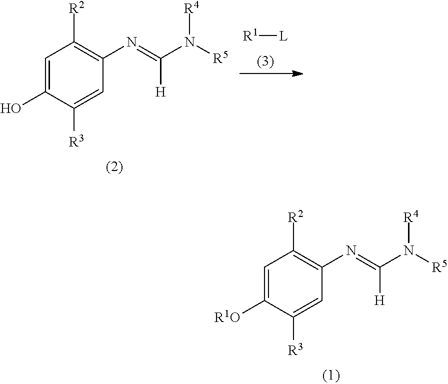

wherein R¹, R², R³, R⁴ and R⁵ are defined above, L represents chlorine, bromine, iodine, a methansulfonyloxy group, a trifluoromethanesulfonyloxy group or a p-toluenesulfonyloxy group.

The reaction is usually performed in the presence of a solvent.

Examples of the solvent to be used in the reaction include ethers such as tetrahydrofuran, ethyleneglycol dimethyl ether and tert-butyl methyl ether (hereinafter referred to as MTBE); aromatic hydrocarbons such as toluene and xylene; halogenated hydrocarbon such as chlorobenzene; nitriles such as acetonitrile; acid amides such as N,N-dimethylformamide (hereinafter referred to as DMF), 1,3-dimethyl-2-imidazolidinone and N-methylpyrrolidone; sulfoxides such as dimethylsulfoxide; ketones such as acetone, methyl ethyl ketone and methyl isobutyl ketone; water and mixture thereof.

Examples of the base to be used in the reaction include alkali metal carbonates such as sodium carbonate, potassium carbonate and cesium carbonate; alkali metal hydroxydes such as sodium hydroxyde and potassium hydroxide and alkali metal hydride such as sodium hydride.

The amount of Compound (3) to be used in the reaction is usually 1 to 10 moles based on 1 mole of Compound (2). The amount of base to be used in the reaction is usually 1 to 5 moles based on 1 mole of Compound (2).

The reaction temperature of the reaction is usually within a range of −20 to 150° C. The reaction time of the reaction is usually within a range of 0.1 to 24 hours.

This reaction carried out in presence of sodium iodide and/or tetrabutylammonium iodide, if necessary. The amount of sodium iodide and/or tetrabutylammonium iodide to be used is usually 0.05 to 0.2 moles based on 1 mole of Compound (2).

After the completion of the reaction, the present compound can be isolated by carrying out post treatment operation such as extraction of the reaction mixture with an organic solvent drying of the organic layer and concentrate thereof. The present compound thus isolated can also be further purified by chromatography, re-crystallization and the like.

### (Production Method 2)

The present compound can also be produced by the following method.

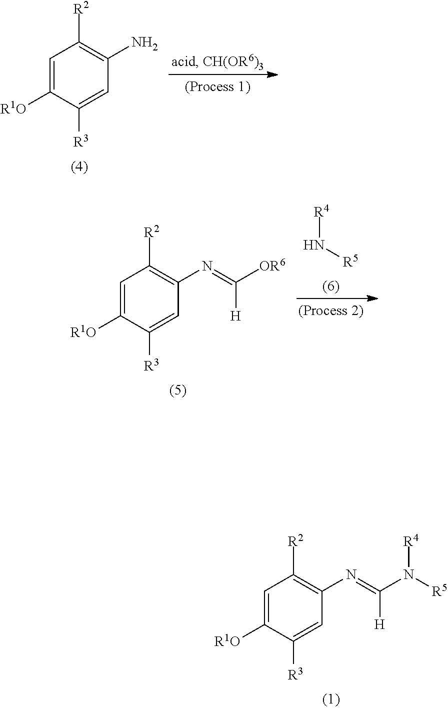

wherein R¹, R², R³, R⁴ and R⁵ are as defined above, and R⁶ represents a methyl group or an ethyl group.

### (Process 1)

A compound represented formula (5) as below (hereinafter referred to as Compound (5)) can be produced by reacting a compound represented formula (4) as below (hereinafter referred to as Compound (4)); and trimethyl orthoformate or triethyl orthoformate in the presence of acid.

The reaction is usually carried out in the absence of a solvent.

Examples of the acid to be used in the reaction include sulfonic acids such as camphorsulfonic acid and p-toluenesulfonic acid; and inorganic acids such as hydrochloric acid and sulfuric acid.

The amount of trimethyl orthoformate or triethyl orthoformate to be used in the reaction is usually 1 mole to large excess amount based on 1 mole of Compound (4). The amount of the acid to be used in the reaction is usually 0.05 to 1 mole based on 1 mole of Compound (4).

The reaction temperature of the reaction is usually within a range of 80 to 150° C. The reaction time of the reaction is usually within a range of 0.5 to 2 hours.

After the completion of the reaction, Compound (5) can be isolated by concentrating the reaction mixture; or by carrying out post treatment operation such as extraction of the reaction mixture with an organic solvent, drying of the organic layer and concentrate thereof.

### (Process 2)

The present compound can be produced by reacting Compound (5) and a compound represented formula (6) as below (hereinafter referred to as Compound (6)).

The reaction usually carried out in the presence of solvent.

Examples of the solvent to be used in the reaction include ethers such as tetrahydrofuran, ethyleneglycol dimethyl ether and MTBE; aromatic hydrocarbons such as toluene and xylene; halogenated hydrocarbon such as chlorobenzene; nitriles such as acetonitrile; acid amides such as DMF, 1,3-dimethyl-2-imidazolidinone and N-methylpyrrolidone; sulfoxides such as dimethylsulfoxide; ketones such as acetone, methyl ethyl ketone and methyl isobutyl ketone and mixture thereof.

The amount of compound (6) to be used in the reaction is usually 1 to 2 moles based on 1 mole of Compound (5).

The reaction temperature of the reaction is usually within a range of 80 to 150° C. The reaction time of the reaction is usually within a range of 0.5 to 3 hours.

After the completion of the reaction, the present compound can be isolated by concentrating the reaction mixture. The present compound thus isolated can also be further purified by chromatography.

### (Production Method 3)

The present compound also can be produced by reacting Compound (4) and a compound represented formula (7) as follows (hereinafter referred to as Compound (7)).

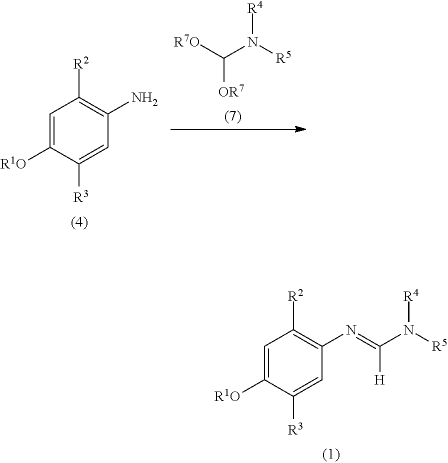

wherein R¹, R², R³, R⁴ and R⁵ are as defined above, and R⁷ represents a methyl group or an ethyl group.

The reaction usually carried out in the presence of solvent.

Examples of the solvent to be used in the reaction include ethers such as tetrahydrofuran, ethyleneglycol dimethyl ether and MTBE; aromatic hydrocarbons such as toluene and xylene; halogenated hydrocarbon such as chlorobenzene; nitriles such as acetonitrile; acid amides such as DMF, 1,3-dimethyl-2-imidazolidinone and N-methylpyrrolidone; sulfoxides such as dimethylsulfoxide; ketones such as acetone, methyl ethyl ketone and methyl isobutyl ketone and mixture thereof.

The amount of compound (7) to be used in the reaction is usually 1 mole to large excess amount based on 1 mole of Compound (4).

The reaction temperature of the reaction is usually within a range of 80 to 150° C. The reaction time of the reaction is usually within a range of 0.5 to 2 hours.

After the completion of the reaction, the present compound can be isolated by concentrating the reaction mixture. The present compound thus isolated can also be further purified by chromatography.

In some cases, the present compound has cis-trans isomers, i.e., a cis isomer and a trans isomer, relative to the carbon atom bonded to the carbon atom of the double bond, and in the present invention, a compound containing one of such active isomers or both of them in any ratio can be used as the present compound.

Examples of the present compound are shown bellow with the number of the present compound.

A compound of the formula (1-A):

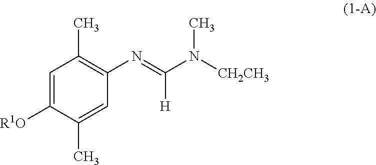

wherein R¹ represents a substituent shown in Tables 1-4:

TABLE 1

| No. | R¹ |
|---|---|
| 1 | 2,2,3,4,4,4-hexafluorobutyl |
| 2 | 2,2,3,3-tetrafluoropropyl |
| 3 | 2,2,2-trifluoroethyl |
| 4 | 2,2,3,3,3-pentafluoropropyl |
| 5 | 2,2,3,3,4,4,4-heptafluorobutyl |
| 6 | 2,2,3,3,4,4,5,5,5-nonafluoropentyl |
| 7 | 2,2,3,3,4,4,5,5,6,6,6-undecafluorohexyl |
| 8 | 2,2,3,3,4,4,5,5,6,6,7,7,7-tridecafluoroheptyl |
| 9 | 2,2,3,3,4,4,5,5,6,6,7,7,8,8,8-pentadecafluorooctyl |
| 10 | 2,2,3,3,4,4,5,5,6,6,7,7,8,8,9,9,9-heptadecafluorononyl |
| 11 | 2,2,3,3,4,4,5,5,6,6,7,7,8,8,9,9,10,10,10-nonadecafluorodecyl |
| 12 | 2,2,3,3,4,4,5,5,6,6,7,7,8,8,9,9,10,10,11,11,11- |
| | henicosafluoroundecyl |
| 13 | monofluoromethyl |
| 14 | difluoromethyl |
| 15 | trifluoromethyl |
| 16 | pentafluoroethyl |
| 17 | 3,3,3-trifluoropropyl |
| 18 | heptafluoropropyl |
| 19 | 3,3,3-trifluoro-2-trifluoromethylpropyl |
| 20 | 4,4,4-trifluorobutyl |
| 21 | nonafluorobutyl |
| 22 | 4,4,4-trifluoro-3-trifluoromethylbutyl |
| 23 | 2,2,4,4,4-pentafluorobutyl |
| 24 | 5,5,5-trifluoropentyl |
| 25 | undecafluoropentyl |
| 26 | 5,5,5-trifluoro-4-trifluoromethylpentyl |

TABLE 2

| No. | R¹ |
|---|---|
| 27 | 6,6,6-trifluorohexyl |
| 28 | tridecafluorohexyl |
| 29 | 6,6,6-trifluoro-5-trifluoromethylhexyl |
| 30 | 7,7,7-trifluoroheptyl |
| 31 | pentadecafluoroheptyl |
| 32 | 7,7,7-trifluoro-6-trifluoromethylheptyl |
| 33 | 8,8,8-trifluorooctyl |
| 34 | heptadecafluorooctyl |
| 35 | 8,8,8-trifluoro-7-trifluoromethyloctyl |
| 36 | 9,9,9-trifluorononyl |
| 37 | nonadecafluorononyl |
| 38 | 9,9,9-trifluoro-8-trifluoromethylnonyl |
| 39 | 10,10,10-trifluorodecyl |
| 40 | henicosafluorodecyl |
| 41 | 10,10,10-trifluoro-9-trifluoromethyldecyl |
| 42 | 11,11,11-trifluoroundecyl |
| 43 | tricosafluoroundecyl |
| 44 | 2,3-difluoro-2-propenyl |
| 45 | 4,4-difluoro-3-butenyl |
| 46 | 5,5,5-trifluoro-4-trifluoromethyl-2-pentenyl |
| 47 | 6,6,6-trifluoro-3-hexenyl |
| 48 | 4,5-difluoro-4-heptenyl |
| 49 | 8,8,8-trifluoro-4-octenyl |
| 50 | 9,9,9-trifluoro-2-nonenyl |
| 51 | 10,10,10-trifluoro-6-decenyl |

TABLE 3

| No. | R¹ |
|---|---|
| 52 | 11,11,11-trifluoro-7-undecenyl |
| 53 | 1-fluoro-2-propynyl |
| 54 | 4,4,4-trifluoro-2-butynyl |
| 55 | 2,2,3,3-tetrafluoro-4-pentynyl |
| 56 | 5,5,6,6,6-pentafluoro-2-hexynyl |
| 57 | 7,7,7-trifluoro-3-heptynyl |
| 58 | 8,8,8-trifluoro-5-octynyl |
| 59 | 9,9,9-trifluoro-8-trifluoromethyl-2-nonynyl |
| 60 | 10,10,10-trifluoro-4-decynyl |
| 61 | 11,11,11-trifluoro-7-undecenyl |
| 200 | 2-fluorobutyl |
| 201 | 4-fluorobutyl |
| 202 | 2,2-difluorobutyl |
| 203 | 2,4-difluorobutyl |
| 204 | 2,2,4-trifluorobutyl |
| 205 | 2,4,4-trifluorobutyl |
| 206 | 2,2,4,4-tetrafluorobutyl |
| 207 | 2,4,4,4-tetrafluorobutyl |
| 208 | 2,2,4,4,4-pentafluorobutyl |
| 209 | 2-fluoropentyl |
| 210 | 2,2-difluoropentyl |

TABLE 4

| No. | R¹ |
|---|---|
| 211 | (2-fluoro-4-methyl)pentyl |
| 212 | (2,2-difluoro-4-methyl)pentyl |
| 213 | (2-fluoro-4,4-dimethyl)pentyl |
| 214 | (2,2-difluoro-4,4-dimethyl)pentyl |
| 215 | 2-fluoro-2-pentenyl |
| 216 | 2-fluoro-4-methyl-2-pentenyl |
| 217 | 2-fluoro-4,4-dimethyl-2-pentenyl |
| 218 | 2-fluoro-2-butenyl |
| 219 | 4-fluoro-2-butenyl |
| 220 | 2,4-difluoro-2-butenyl |
| 221 | 4,4-difluoro-2-butenyl |
| 222 | 2,4,4-trifluoro-2-butenyl |
| 223 | 2,4,4,4-tetrafluoro-2-butenyl |

A compound of the formula (1-B):

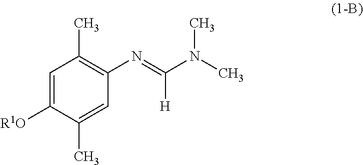

wherein R¹ represents a substituent shown in Tables 5-8:

TABLE 5

| No. | R¹ |
|---|---|
| 62 | 2,2,3,4,4,4-hexafluorobutyl |
| 63 | 2,2,3,3-tetrafluoropropyl |
| 64 | 2,2,2-trifluoroethyl |
| 65 | 2,2,3,3,3-pentafluoropropyl |
| 66 | 2,2,3,3,4,4,4-heptafluorobutyl |
| 67 | 2,2,3,3,4,4,5,5,5-nonafluoropentyl |
| 68 | 2,2,3,3,4,4,5,5,6,6,6-undecafluorohexyl |
| 69 | 2,2,3,3,4,4,5,5,6,6,7,7,7-tridecafluoroheptyl |
| 70 | 2,2,3,3,4,4,5,5,6,6,7,7,8,8,8-pentadecafluorooctyl |
| 71 | 2,2,3,3,4,4,5,5,6,6,7,7,8,8,9,9,9-heptadecafluorononyl |
| 72 | 2,2,3,3,4,4,5,5,6,6,7,7,8,8,9,9,10,10,10-nonadecafluorodecyl |
| 73 | 2,2,3,3,4,4,5,5,6,6,7,7,8,8,9,9,10,10,11,11,11- |
| | henicosafluoroundecyl |
| 74 | monofluoromethyl |
| 75 | difluoromethyl |
| 76 | trifluoromethyl |
| 77 | pentafluoroethyl |
| 78 | 3,3,3-trifluoropropyl |
| 79 | heptafluoropropyl |
| 80 | 3,3,3-trifluoro-2-trifluoromethylpropyl |
| 81 | 4,4,4-trifluorobutyl |
| 82 | nonafluorobutyl |
| 83 | 4,4,4-trifluoro-3-trifluoromethylbutyl |
| 84 | 2,2,4,4,4-pentafluorobutyl |
| 85 | 5,5,5-trifluoropentyl |
| 86 | undecafluoropentyl |
| 87 | 5,5,5-trifluoro-4-trifluoromethylpentyl |

TABLE 6

| No. | R¹ |
|---|---|
| 224 | 2-fluorobutyl |
| 225 | 4-fluorobutyl |
| 226 | 2,2-difluorobutyl |
| 227 | 2,4-difluorobutyl |
| 228 | 2,2,4-trifluorobutyl |
| 229 | 2,4,4-trifluorobutyl |
| 230 | 2,2,4,4-tetrafluorobutyl |
| 231 | 2,4,4,4-tetrafluorobutyl |
| 232 | 2,2,4,4,4-pentafluorobutyl |
| 233 | 2-fluoropentyl |
| 234 | 2,2-difluoropentyl |
| 235 | (2-fluoro-4-methyl)pentyl |
| 236 | (2,2-difluoro-4-methyl)pentyl |
| 237 | (2-fluoro-4,4-dimethyl)pentyl |
| 238 | (2,2-difluoro-4,4-dimethyl)pentyl |
| 239 | 2-fluoro-2-pentenyl |
| 240 | 2-fluoro-4-methyl-2-pentenyl |
| 241 | 2-fluoro-4,4-dimethyl-2-pentenyl |
| 242 | 2-fluoro-2-butenyl |
| 243 | 4-fluoro-2-butenyl |
| 244 | 2,4-difluoro-2-butenyl |
| 245 | 4,4-difluoro-2-butenyl |
| 246 | 2,4,4-trifluoro-2-butenyl |
| 247 | 2,4,4,4-tetrafluoro-2-butenyl |

TABLE 7

| No. | R¹ |
|---|---|
| 88 | 6,6,6-trifluorohexyl |
| 89 | tridecafluorohexyl |
| 90 | 6,6,6-trifluoro-5-trifluoromethylhexyl |
| 91 | 7,7,7-trifluoroheptyl |
| 92 | pentadecafluoroheptyl |
| 93 | 7,7,7-trifluoro-6-trifluoromethylheptyl |
| 94 | 8,8,8-trifluorooctyl |
| 95 | heptafluorooctyl |
| 96 | 8,8,8-trifluoro-7-trifluoromethyloctyl |
| 97 | 9,9,9-trifluorononyl |
| 98 | nonadecafluorononyl |
| 99 | 9,9,9-trifluoro-8-trifluoromethylnonyl |
| 100 | 10,10,10-trifluorodecyl |
| 101 | henicosafluorodecyl |
| 102 | 10,10,10-trifluoro-9-trifluoromethyldecyl |
| 103 | 11,11,11-trifluoroundecyl |
| 104 | tricosafluoroundecyl |
| 105 | 2,3-difluoro-2-propenyl |
| 106 | 4,4-difluoro-3-butenyl |
| 107 | 5,5,5-trifluoro-4-trifluoromethyl-2-pentenyl |
| 108 | 6,6,6-trifluoro-3-hexenyl |
| 109 | 4,5-difluoro-4-heptenyl |
| 110 | 8,8,8-trifluoro-4-octenyl |
| 111 | 9,9,9-trifluoro-2-nonenyl |
| 112 | 10,10,10-trifluoro-6-decenyl |

TABLE 8

| No. | R¹ |
|---|---|
| 113 | 11,11,11-trifluoro-7-undecenyl |
| 114 | 1-fluoro-2-propynyl |
| 115 | 4,4,4-trifluoro-2-butynyl |
| 116 | 2,2,3,3-tetrafluoro-4-pentynyl |
| 117 | 5,5,6,6,6-pentafluoro-2-hexynyl |
| 118 | 7,7,7-trifluoro-3-heptynyl |
| 119 | 8,8,8-trifluoro-5-octynyl |
| 120 | 9,9,9-trifluoro-8-trifluoromethyl-2-nonyl |
| 121 | 10,10,10-trifluoro-4-decynyl |
| 122 | 11,11,11-trifluoro-7-undecenyl |

A compound of the formula (1-C):

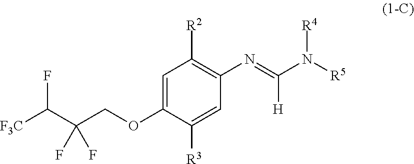

wherein R², R³, R⁴ and R⁵ represent a combination shown in Tables 9-12:

TABLE 9

| No. | R² | R³ | R⁴ | R⁵ |
|---|---|---|---|---|
| 123 | methyl | methyl | methyl | propyl |
| 124 | methyl | methyl | methyl | 1-methylethyl |
| 125 | methyl | methyl | methyl | butyl |
| 126 | methyl | methyl | methyl | 1-methylpropyl |
| 127 | methyl | methyl | methyl | 2-methylpropyl |
| 128 | methyl | methyl | methyl | 1,1-dimethylethyl |
| 129 | methyl | methyl | methyl | pentyl |
| 130 | methyl | methyl | methyl | 1-methylpentyl |
| 131 | methyl | methyl | methyl | 2-methylpentyl |
| 132 | methyl | methyl | methyl | 3-methylpentyl |
| 133 | methyl | methyl | methyl | 4-methylpentyl |
| 134 | methyl | methyl | methyl | hexyl |
| 135 | methyl | methyl | methyl | cyclopropyl |
| 136 | methyl | methyl | methyl | cyclobutyl |
| 137 | methyl | methyl | methyl | cyclopentyl |
| 138 | methyl | methyl | methyl | cyclohexyl |
| 139 | methyl | methyl | methyl | monofluoromethyl |
| 140 | methyl | methyl | methyl | difluoromethyl |
| 141 | methyl | methyl | methyl | trifluoromethyl |
| 142 | methyl | methyl | methyl | 2,2,2-trifluoroethyl |
| 143 | methyl | methyl | methyl | 3,3,3-trifluoropropyl |
| 144 | methyl | methyl | methyl | 4,4,4-trifluorobutyl |
| 145 | methyl | methyl | methyl | 5,5,5-trifluoropentyl |
| 146 | methyl | methyl | methyl | 6,6,6-trifluorohexyl |

TABLE 10

| No. | R² | R³ | R⁴ | R⁵ |
|---|---|---|---|---|
| 147 | methyl | methyl | monofluoromethyl | trifluoromethyl |
| 148 | methyl | methyl | difluoromethyl | trifluoromethyl |
| 149 | methyl | methyl | trifluoromethyl | trifluoromethyl |
| 150 | methyl | methyl | 2,2,2-trifluoroethyl | trifluoromethyl |
| 151 | methyl | methyl | 3,3,3-trifluoropropyl | trifluoromethyl |
| 152 | methyl | methyl | 4,4,4-trifluorobutyl | trifluoromethyl |
| 153 | methyl | methyl | 5,5,5-trifluoropentyl | trifluoromethyl |
| 154 | methyl | methyl | 6,6,6-triflorohexyl | trifluoromethyl |
| 155 | methyl | methyl | cyclopropyl | trifluoromethyl |
| 156 | methyl | methyl | cyclobutyl | trifluoromethyl |
| 157 | methyl | methyl | cyclopentyl | trifluoromethyl |
| 158 | methyl | methyl | cyclohexyl | trifluoromethyl |
| 159 | methyl | methyl | cyclopropyl | cyclopropyl |
| 160 | methyl | methyl | cyclobutyl | cyclopropyl |
| 161 | methyl | methyl | cyclopentyl | cyclopropyl |
| 162 | methyl | methyl | cyclohexyl | cyclopropyl |
| 163 | methyl | methyl | cyclobutyl | cyclobutyl |
| 164 | methyl | methyl | cyclopentyl | cyclobutyl |
| 165 | methyl | methyl | cyclohexyl | cyclobutyl |
| 166 | methyl | methyl | cyclopentyl | cyclopentyl |
| 167 | methyl | methyl | cyclohexyl | cyclopentyl |
| 168 | methyl | methyl | cyclohexyl | cyclohexyl |
| 169 | methyl | ethyl | methyl | ethyl |
| 170 | methyl | propyl | methyl | ethyl |

TABLE 11

| No. | R² | R³ | R⁴ | R⁵ |
|---|---|---|---|---|
| 171 | methyl | 1-methylethyl | methyl | ethyl |
| 172 | ethyl | methyl | methyl | ethyl |
| 173 | ethyl | ethyl | methyl | ethyl |
| 174 | ethyl | propyl | methyl | ethyl |
| 175 | ethyl | 1-methylethyl | methyl | ethyl |
| 176 | propyl | methyl | methyl | ethyl |
| 177 | propyl | ethyl | methyl | ethyl |
| 178 | propyl | propyl | methyl | ethyl |
| 179 | propyl | 1-methylethyl | methyl | ethyl |
| 180 | 1-methylethyl | methyl | methyl | ethyl |
| 181 | 1-methylethyl | ethyl | methyl | ethyl |
| 182 | 1-methylethyl | propyl | methyl | ethyl |
| 183 | 1-methylethyl | 1-methylethyl | methyl | ethyl |
| 184 | methyl | methyl | methyl | methyl |
| 185 | methyl | ethyl | methyl | methyl |
| 186 | methyl | propyl | methyl | methyl |
| 187 | methyl | 1-methylethyl | methyl | methyl |
| 188 | ethyl | methyl | methyl | methyl |
| 189 | ethyl | ethyl | methyl | methyl |
| 190 | ethyl | propyl | methyl | methyl |
| 191 | ethyl | 1-methylethyl | methyl | methyl |
| 192 | propyl | methyl | methyl | methyl |
| 193 | propyl | ethyl | methyl | methyl |
| 194 | propyl | propyl | methyl | methyl |

TABLE 12

| No. | R² | R³ | R⁴ | R⁵ |
|---|---|---|---|---|
| 195 | propyl | 1-methylethyl | methyl | methyl |
| 196 | 1-methylethyl | methyl | methyl | methyl |
| 197 | 1-methylethyl | ethyl | methyl | methyl |
| 198 | 1-methylethyl | propyl | methyl | methyl |
| 199 | 1-methylethyl | 1-methylethyl | methyl | methyl |
| 248 | methyl | methyl | ethyl | ethyl |

A compound of the formula (1-D):

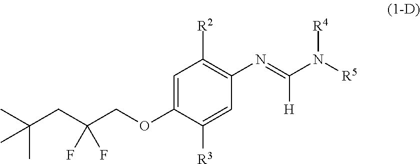

wherein R², R³, R⁴ and R⁵ represent a combination shown in Tables 13-17:

TABLE 13

| No. | R² | R³ | R⁴ | R⁵ |
|---|---|---|---|---|
| 249 | methyl | methyl | methyl | propyl |
| 250 | methyl | methyl | methyl | 1-methylethyl |
| 251 | methyl | methyl | methyl | butyl |
| 252 | methyl | methyl | methyl | 1-methylpropyl |
| 253 | methyl | methyl | methyl | 2-methylpropyl |
| 254 | methyl | methyl | methyl | 1,1-dimethylethyl |
| 255 | methyl | methyl | methyl | pentyl |
| 256 | methyl | methyl | methyl | 1-methylpentyl |
| 257 | methyl | methyl | methyl | 2-methylpentyl |
| 258 | methyl | methyl | methyl | 3-methylpentyl |
| 259 | methyl | methyl | methyl | 4-methylpentyl |
| 260 | methyl | methyl | methyl | hexyl |

TABLES 14

| No. | R² | R³ | R⁴ | R⁵ |
|---|---|---|---|---|
| 261 | methyl | methyl | methyl | cyclopropyl |
| 262 | methyl | methyl | methyl | cyclobutyl |
| 263 | methyl | methyl | methyl | cyclopentyl |
| 264 | methyl | methyl | methyl | cyclohexyl |
| 265 | methyl | methyl | methyl | monofluoromethyl |
| 266 | methyl | methyl | methyl | difluoromethyl |
| 267 | methyl | methyl | methyl | trifluoromethyl |
| 268 | methyl | methyl | methyl | 2,2,2-trifluoroethyl |
| 269 | methyl | methyl | methyl | 3,3,3-trifluoropropyl |
| 270 | methyl | methyl | methyl | 4,4,4-trifluorobutyl |
| 271 | methyl | methyl | methyl | 5,5,5-trifluoropentyl |
| 272 | methyl | methyl | methyl | 6,6,6-triflluorohexyl |
| 273 | methyl | methyl | monofluoromethyl | trifluoromethyl |
| 274 | methyl | methyl | difluoromethyl | trifluoromethyl |
| 275 | methyl | methyl | trifluoromethyl | trifluoromethyl |
| 276 | methyl | methyl | 2,2,2-trifluoroethyl | trifluoromethyl |
| 277 | methyl | methyl | 3,3,3-trifluoropropyl | trifluoromethyl |
| 278 | methyl | methyl | 4,4,4-trifluorobutyl | trifluoromethyl |
| 279 | methyl | methyl | 5,5,5-trifluoropentyl | trifluoromethyl |
| 280 | methyl | methyl | 6,6,6-trifluorohexyl | trifluoromethyl |

TABLE 15

| No. | R² | R³ | R⁴ | R⁵ |
|---|---|---|---|---|
| 281 | methyl | methyl | cyclopropyl | trifluoromethyl |
| 282 | methyl | methyl | cyclobutyl | trifluoromethyl |
| 283 | methyl | methyl | cyclopentyl | trifluoromethyl |
| 284 | methyl | methyl | cyclohexyl | trifluoromethyl |
| 285 | methyl | methyl | cyclopropyl | cyclopropyl |
| 286 | methyl | methyl | cyclobutyl | cyclopropyl |
| 287 | methyl | methyl | cyclopentyl | cyclopropyl |
| 288 | methyl | methyl | cyclohexyl | cyclopropyl |
| 289 | methyl | methyl | cyclobutyl | cyclobutyl |
| 290 | methyl | methyl | cyclopentyl | cyclobutyl |
| 291 | methyl | methyl | cyclohexyl | cyclobutyl |
| 292 | methyl | methyl | cyclopentyl | cyclopentyl |
| 293 | methyl | methyl | cyclohexyl | cyclopentyl |
| 294 | methyl | methyl | cyclohexyl | cyclohexyl |
| 295 | methyl | ethyl | methyl | ethyl |
| 296 | methyl | propyl | methyl | ethyl |
| 297 | methyl | 1-methylethyl | methyl | ethyl |
| 298 | ethyl | methyl | methyl | ethyl |
| 299 | ethyl | ethyl | methyl | ethyl |
| 300 | ethyl | propyl | methyl | ethyl |

TABLE 16

| No. | R² | R³ | R⁴ | R⁵ |
|---|---|---|---|---|
| 301 | ethyl | 1-methylethyl | methyl | ethyl |
| 302 | propyl | methyl | methyl | ethyl |
| 303 | propyl | ethyl | methyl | ethyl |
| 304 | propyl | propyl | methyl | ethyl |
| 305 | propyl | 1-methylethyl | methyl | ethyl |
| 306 | 1-methylethyl | methyl | methyl | ethyl |
| 307 | 1-methylethyl | ethyl | methyl | ethyl |
| 308 | 1-methylethyl | propyl | methyl | ethyl |
| 309 | 1-methylethyl | 1-methylethyl | methyl | ethyl |
| 310 | methyl | methyl | methyl | methyl |
| 311 | methyl | ethyl | methyl | methyl |
| 312 | methyl | propyl | methyl | methyl |
| 313 | methyl | 1-methylethyl | methyl | methyl |

TABLE 17

| No. | R² | R³ | R⁴ | R⁵ |
|---|---|---|---|---|
| 314 | ethyl | methyl | methyl | methyl |
| 315 | ethyl | ethyl | methyl | methyl |
| 316 | ethyl | propyl | methyl | methyl |
| 317 | ethyl | 1-methylethyl | methyl | methyl |
| 318 | propyl | methyl | methyl | methyl |
| 319 | propyl | ethyl | methyl | methyl |
| 320 | propyl | propyl | methyl | methyl |
| 321 | propyl | 1-methylethyl | methyl | methyl |
| 322 | 1-methylethyl | methyl | methyl | methyl |
| 323 | 1-methylethyl | ethyl | methyl | methyl |
| 324 | 1-methylethyl | propyl | methyl | methyl |
| 325 | 1-methylethyl | 1-methylethyl | methyl | methyl |
| 326 | methyl | methyl | ethyl | ethyl |

A compound of the formula (1-E):

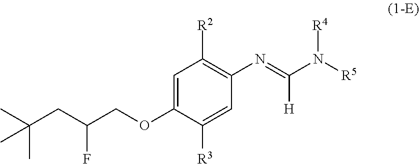

wherein R², R³, R⁴ and R⁵ represent a combination shown in Tables 18-21:

TABLE 18

| No. | R² | R³ | R⁴ | R⁵ |
|---|---|---|---|---|
| 327 | methyl | methyl | methyl | propyl |
| 328 | methyl | methyl | methyl | 1-methylethyl |
| 329 | methyl | methyl | methyl | butyl |
| 330 | methyl | methyl | methyl | 1-methylpropyl |
| 331 | methyl | methyl | methyl | 2-methylpropyl |
| 332 | methyl | methyl | methyl | 1,1-dimethylethyl |
| 333 | methyl | methyl | methyl | pentyl |
| 334 | methyl | methyl | methyl | 1-methylpentyl |
| 335 | methyl | methyl | methyl | 2-methylpentyl |
| 336 | methyl | methyl | methyl | 3-methylpentyl |
| 337 | methyl | methyl | methyl | 4-methylpentyl |
| 338 | methyl | methyl | methyl | hexyl |
| 339 | methyl | methyl | methyl | cyclopropyl |
| 340 | methyl | methyl | methyl | cyclobutyl |
| 341 | methyl | methyl | methyl | cyclopentyl |
| 342 | methyl | methyl | methyl | cyclohexyl |
| 343 | methyl | methyl | methyl | monofluoromethyl |
| 344 | methyl | methyl | methyl | difluoromethyl |
| 345 | methyl | methyl | methyl | trifluoromethyl |

TABLE 19

| No. | R² | R³ | R⁴ | R⁵ |
|---|---|---|---|---|
| 346 | methyl | methyl | methyl | 2,2,2-trifluoroethyl |
| 347 | methyl | methyl | methyl | 3,3,3-trifluoropropyl |
| 348 | methyl | methyl | methyl | 4,4,4-trifluorobutyl |
| 349 | methyl | methyl | methyl | 5,5,5-trifluoropentyl |
| 350 | methyl | methyl | methyl | 6,6,6-triflluorohexyl |
| 351 | methyl | methyl | monofluoromethyl | trifluoromethyl |
| 352 | methyl | methyl | difluoromethyl | trifluoromethyl |
| 353 | methyl | methyl | trifluoromethyl | trifluoromethyl |
| 354 | methyl | methyl | 2,2,2-trifluoroethyl | trifluoromethyl |
| 355 | methyl | methyl | 3,3,3-trifluoropropyl | trifluoromethyl |
| 356 | methyl | methyl | 4,4,4-trifluorobutyl | trifluoromethyl |
| 357 | methyl | methyl | 5,5,5-trifluoropentyl | trifluoromethyl |
| 358 | methyl | methyl | 6,6,6-trifluorohexyl | trifluoromethyl |
| 359 | methyl | methyl | cyclopropyl | trifluoromethyl |
| 360 | methyl | methyl | cyclobutyl | trifluoromethyl |
| 361 | methyl | methyl | cyclopentyl | trifluoromethyl |
| 362 | methyl | methyl | cyclohexyl | trifluoromethyl |
| 363 | methyl | methyl | cyclopropyl | cyclopropyl |
| 364 | methyl | methyl | cyclobutyl | cyclopropyl |
| 365 | methyl | methyl | cyclopentyl | cyclopropyl |
| 366 | methyl | methyl | cyclohexyl | cyclopropyl |
| 367 | methyl | methyl | cyclobutyl | cyclobutyl |
| 368 | methyl | methyl | cyclopentyl | cyclobutyl |

TABLE 20

| No. | R² | R³ | R⁴ | R⁵ |
|---|---|---|---|---|
| 369 | methyl | methyl | cyclohexyl | cyclobutyl |
| 370 | methyl | methyl | cyclopentyl | cyclopentyl |
| 371 | methyl | methyl | cyclohexyl | cyclopentyl |
| 372 | methyl | methyl | cyclohexyl | cyclohexyl |
| 373 | methyl | ethyl | methyl | ethyl |
| 374 | methyl | propyl | methyl | ethyl |
| 375 | methyl | 1-methylethyl | methyl | ethyl |
| 376 | ethyl | methyl | methyl | ethyl |
| 377 | ethyl | ethyl | methyl | ethyl |
| 378 | ethyl | propyl | methyl | ethyl |
| 379 | ethyl | 1-methylethyl | methyl | ethyl |
| 380 | propyl | methyl | methyl | ethyl |
| 381 | propyl | ethyl | methyl | ethyl |
| 382 | propyl | propyl | methyl | ethyl |
| 383 | propyl | 1-methylethyl | methyl | ethyl |
| 384 | 1-methylethyl | methyl | methyl | ethyl |
| 385 | 1-methylethyl | ethyl | methyl | ethyl |
| 386 | 1-methylethyl | propyl | methyl | ethyl |

TABLE 21

| No. | R² | R³ | R⁴ | R⁵ |
|---|---|---|---|---|
| 387 | 1-methylethyl | 1-methylethyl | methyl | ethyl |
| 388 | methyl | methyl | methyl | methyl |
| 389 | methyl | ethyl | methyl | methyl |
| 390 | methyl | propyl | methyl | methyl |
| 391 | methyl | 1-methylethyl | methyl | methyl |
| 392 | ethyl | methyl | methyl | methyl |
| 393 | ethyl | ethyl | methyl | methyl |
| 394 | ethyl | propyl | methyl | methyl |
| 395 | ethyl | 1-methylethyl | methyl | methyl |
| 396 | propyl | methyl | methyl | methyl |
| 397 | propyl | ethyl | methyl | methyl |
| 398 | propyl | propyl | methyl | methyl |
| 399 | propyl | 1-methylethyl | methyl | methyl |
| 400 | 1-methylethyl | methyl | methyl | methyl |
| 401 | 1-methylethyl | ethyl | methyl | methyl |
| 402 | 1-methylethyl | propyl | methyl | methyl |
| 403 | 1-methylethyl | 1-methylethyl | methyl | methyl |
| 404 | methyl | methyl | ethyl | ethyl |

A compound of the formula (1-F):

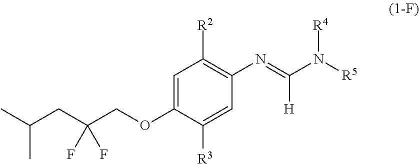

wherein R², R³, R⁴ and R⁵ represent a combination shown in Tables 22-25:

TABLE 22

| No. | R² | R³ | R⁴ | R⁵ |
|---|---|---|---|---|
| 405 | methyl | methyl | methyl | propyl |
| 406 | methyl | methyl | methyl | 1-methylethyl |
| 407 | methyl | methyl | methyl | butyl |

TABLES 23

| No. | R² | R³ | R⁴ | R⁵ |
|---|---|---|---|---|
| 408 | methyl | methyl | methyl | 1-methylpropyl |
| 409 | methyl | methyl | methyl | 2-methylpropyl |
| 410 | methyl | methyl | methyl | 1,1-dimethylethyl |
| 411 | methyl | methyl | methyl | pentyl |
| 412 | methyl | methyl | methyl | 1-methylpentyl |
| 413 | methyl | methyl | methyl | 2-methylpentyl |
| 414 | methyl | methyl | methyl | 3-methylpentyl |
| 415 | methyl | methyl | methyl | 4-methylpentyl |
| 416 | methyl | methyl | methyl | hexyl |
| 417 | methyl | methyl | methyl | cyclopropyl |
| 418 | methyl | methyl | methyl | cyclobutyl |
| 419 | methyl | methyl | methyl | cyclopentyl |
| 420 | methyl | methyl | methyl | cyclohexyl |
| 421 | methyl | methyl | methyl | monofluoromethyl |
| 422 | methyl | methyl | methyl | difluoromethyl |
| 423 | methyl | methyl | methyl | trifluoromethyl |
| 424 | methyl | methyl | methyl | 2,2,2-trifluoroethyl |
| 425 | methyl | methyl | methyl | 3,3,3-trifluoropropyl |
| 426 | methyl | methyl | methyl | 4,4,4-trifluorobutyl |
| 427 | methyl | methyl | methyl | 5,5,5-trifluoropentyl |
| 428 | methyl | methyl | methyl | 6,6,6-triflluorohexyl |
| 429 | methyl | methyl | monofluoromethyl | trifluoromethyl |
| 430 | methyl | methyl | difluoromethyl | trifluoromethyl |
| 431 | methyl | methyl | trifluoromethyl | trifluoromethyl |
| 432 | methyl | methyl | 2,2,2-trifluoroethyl | trifluoromethyl |

TABLE 24

| No. | R² | R³ | R⁴ | R⁵ |
|---|---|---|---|---|
| 433 | methyl | methyl | 3,3,3-trifluoropropyl | trifluoromethyl |
| 434 | methyl | methyl | 4,4,4-trifluorobutyl | trifluoromethyl |
| 435 | methyl | methyl | 5,5,5-trifluoropentyl | trifluoromethyl |
| 436 | methyl | methyl | 6,6,6-trifluorohexyl | trifluoromethyl |
| 437 | methyl | methyl | cyclopropyl | trifluoromethyl |
| 438 | methyl | methyl | cyclobutyl | trifluoromethyl |
| 439 | methyl | methyl | cyclopentyl | trifluoromethyl |
| 440 | methyl | methyl | cyclohexyl | trifluoromethyl |
| 441 | methyl | methyl | cyclopropyl | cyclopropyl |
| 442 | methyl | methyl | cyclobutyl | cyclopropyl |
| 443 | methyl | methyl | cyclopentyl | cyclopropyl |
| 444 | methyl | methyl | cyclohexyl | cyclopropyl |
| 445 | methyl | methyl | cyclobutyl | cyclobutyl |
| 446 | methyl | methyl | cyclopentyl | cyclobutyl |
| 447 | methyl | methyl | cyclohexyl | cyclobutyl |
| 448 | methyl | methyl | cyclopentyl | cyclopentyl |
| 449 | methyl | methyl | cyclohexyl | cyclopentyl |
| 450 | methyl | methyl | cyclohexyl | cyclohexyl |
| 451 | methyl | ethyl | methyl | ethyl |
| 452 | methyl | propyl | methyl | ethyl |
| 453 | methyl | 1-methylethyl | methyl | ethyl |
| 454 | ethyl | methyl | methyl | ethyl |
| 455 | ethyl | ethyl | methyl | ethyl |

TABLE 25

| No. | R² | R³ | R⁴ | R⁵ |
|---|---|---|---|---|
| 456 | ethyl | propyl | methyl | ethyl |
| 457 | ethyl | 1-methylethyl | methyl | ethyl |
| 458 | propyl | methyl | methyl | ethyl |
| 459 | propyl | ethyl | methyl | ethyl |
| 460 | propyl | propyl | methyl | ethyl |
| 461 | propyl | 1-methylethyl | methyl | ethyl |
| 462 | 1-methylethyl | methyl | methyl | ethyl |
| 463 | 1-methylethyl | ethyl | methyl | ethyl |
| 464 | 1-methylethyl | propyl | methyl | ethyl |
| 465 | 1-methylethyl | 1-methylethyl | methyl | ethyl |
| 466 | methyl | methyl | methyl | methyl |
| 467 | methyl | ethyl | methyl | methyl |
| 468 | methyl | propyl | methyl | methyl |
| 469 | methyl | 1-methylethyl | methyl | methyl |
| 470 | ethyl | methyl | methyl | methyl |
| 471 | ethyl | ethyl | methyl | methyl |
| 472 | ethyl | propyl | methyl | methyl |
| 473 | ethyl | 1-methylethyl | methyl | methyl |
| 474 | propyl | methyl | methyl | methyl |
| 475 | propyl | ethyl | methyl | methyl |
| 476 | propyl | propyl | methyl | methyl |
| 477 | propyl | 1-methylethyl | methyl | methyl |
| 478 | 1-methylethyl | methyl | methyl | methyl |
| 479 | 1-methylethyl | ethyl | methyl | methyl |
| 480 | 1-methylethyl | propyl | methyl | methyl |
| 481 | 1-methylethyl | 1-methylethyl | methyl | methyl |
| 482 | methyl | methyl | ethyl | ethyl |

A compound of the formula (1-G):

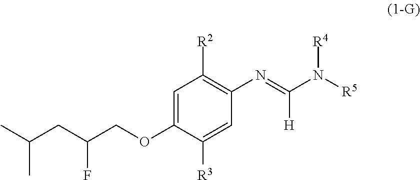

wherein R², R³, R⁴ and R⁵ represent a combination shown in Tables 26-28:

TABLE 26

| No. | R² | R³ | R⁴ | R⁵ |
|---|---|---|---|---|
| 483 | methyl | methyl | methyl | propyl |
| 484 | methyl | methyl | methyl | 1-methylethyl |
| 485 | methyl | methyl | methyl | butyl |
| 486 | methyl | methyl | methyl | 1-methylpropyl |
| 487 | methyl | methyl | methyl | 2-methylpropyl |
| 488 | methyl | methyl | methyl | 1,1-dimethylethyl |
| 489 | methyl | methyl | methyl | pentyl |
| 490 | methyl | methyl | methyl | 1-methylpentyl |
| 491 | methyl | methyl | methyl | 2-methylpentyl |
| 492 | methyl | methyl | methyl | 3-methylpentyl |
| 493 | methyl | methyl | methyl | 4-methylpentyl |
| 494 | methyl | methyl | methyl | hexyl |
| 495 | methyl | methyl | methyl | cyclopropyl |
| 496 | methyl | methyl | methyl | cyclobutyl |
| 497 | methyl | methyl | methyl | cyclopentyl |
| 498 | methyl | methyl | methyl | cyclohexyl |
| 499 | methyl | methyl | methyl | monofluoromethyl |
| 500 | methyl | methyl | methyl | difluoromethyl |
| 501 | methyl | methyl | methyl | trifluoromethyl |
| 502 | methyl | methyl | methyl | 2,2,2-trifluoroethyl |

TABLE 27

| No. | R² | R³ | R⁴ | R⁵ |
|---|---|---|---|---|
| 503 | methyl | methyl | methyl | 3,3,3-trifluoropropyl |
| 504 | methyl | methyl | methyl | 4,4,4-trifluorobutyl |
| 505 | methyl | methyl | methyl | 5,5,5-trifluoropentyl |
| 506 | methyl | methyl | methyl | 6,6,6-triflluorohexyl |
| 507 | methyl | methyl | monofluoromethyl | trifluoromethyl |
| 508 | methyl | methyl | difluoromethyl | trifluoromethyl |
| 509 | methyl | methyl | trifluoromethyl | trifluoromethyl |
| 510 | methyl | methyl | 2,2,2-trifluoroethyl | trifluoromethyl |
| 511 | methyl | methyl | 3,3,3-trifluoropropyl | trifluoromethyl |
| 512 | methyl | methyl | 4,4,4-trifluorobutyl | trifluoromethyl |
| 513 | methyl | methyl | 5,5,5-trifluoropentyl | trifluoromethyl |
| 514 | methyl | methyl | 6,6,6-trifluorohexyl | trifluoromethyl |
| 515 | methyl | methyl | cyclopropyl | trifluoromethyl |
| 516 | methyl | methyl | cyclobutyl | trifluoromethyl |
| 517 | methyl | methyl | cyclopentyl | trifluoromethyl |
| 518 | methyl | methyl | cyclohexyl | trifluoromethyl |
| 519 | methyl | methyl | cyclopropyl | cyclopropyl |
| 520 | methyl | methyl | cyclobutyl | cyclopropyl |
| 521 | methyl | methyl | cyclopentyl | cyclopropyl |
| 522 | methyl | methyl | cyclohexyl | cyclopropyl |
| 523 | methyl | methyl | cyclobutyl | cyclobutyl |
| 524 | methyl | methyl | cyclopentyl | cyclobutyl |
| 525 | methyl | methyl | cyclohexyl | cyclobutyl |

TABLE 28

| No. | R² | R³ | R⁴ | R⁵ |
|---|---|---|---|---|
| 526 | methyl | methyl | cyclopentyl | cyclopentyl |
| 527 | methyl | methyl | cyclohexyl | cyclopentyl |
| 528 | methyl | methyl | cyclohexyl | cyclohexyl |
| 529 | methyl | ethyl | methyl | ethyl |
| 530 | methyl | propyl | methyl | ethyl |
| 531 | methyl | 1-methylethyl | methyl | ethyl |
| 532 | ethyl | methyl | methyl | ethyl |
| 533 | ethyl | ethyl | methyl | ethyl |
| 534 | ethyl | propyl | methyl | ethyl |
| 535 | ethyl | 1-methylethyl | methyl | ethyl |
| 536 | propyl | methyl | methyl | ethyl |
| 537 | propyl | ethyl | methyl | ethyl |
| 538 | propyl | propyl | methyl | ethyl |
| 539 | propyl | 1-methylethyl | methyl | ethyl |
| 540 | 1-methylethyl | methyl | methyl | ethyl |
| 541 | 1-methylethyl | ethyl | methyl | ethyl |
| 542 | 1-methylethyl | propyl | methyl | ethyl |
| 543 | 1-methylethyl | 1-methylethyl | methyl | ethyl |
| 544 | methyl | methyl | methyl | methyl |
| 545 | methyl | ethyl | methyl | methyl |
| 546 | methyl | propyl | methyl | methyl |
| 547 | methyl | 1-methylethyl | methyl | methyl |
| 548 | ethyl | methyl | methyl | methyl |
| 549 | ethyl | ethyl | methyl | methyl |

TABLE 29

| No. | R² | R³ | R⁴ | R⁵ |
|---|---|---|---|---|
| 550 | ethyl | propyl | methyl | methyl |
| 551 | ethyl | 1-methylethyl | methyl | methyl |
| 552 | propyl | methyl | methyl | methyl |
| 553 | propyl | ethyl | methyl | methyl |
| 554 | propyl | propyl | methyl | methyl |
| 555 | propyl | 1-methylethyl | methyl | methyl |
| 556 | 1-methylethyl | methyl | methyl | methyl |
| 557 | 1-methylethyl | ethyl | methyl | methyl |
| 558 | 1-methylethyl | propyl | methyl | methyl |
| 559 | 1-methylethyl | 1-methylethyl | methyl | methyl |
| 560 | methyl | methyl | ethyl | ethyl |

While the present controlling composition can be composed only of the present compound, it is usually used in a formulation form such as wettable powders, water dispersible granules, flowable concentrates, granules, dry flowable concentrates, emulsifiable concentrates, aqueous liquid formulations, oil formulations, smoking formulations, aerosols, microcapsules or the like, by mixing the present compound with a carrier (e.g., a solid, liquid or gaseous carrier), surfactants and auxiliary agents for formulation such as binders, dispersants and stabilizers. Such formulations usually contain the present compound in an amount of 0.1 to 99% by weight, preferably 0.2 to 90% by weight.

Examples of the solid carrier used for the formulation procedure include fine powders or particles of clays (e.g., kaolin, diatomaceous earth, synthetic hydrous silicon oxide fubasami clay, bentonite and acid clay), talc and other inorganic minerals (e.g., sericite, quartz powder, sulfur powder, activated carbon, calcium carbonate and hydrated silica); and examples of the liquid carrier include such as water, alcohols (e.g., methanol and ethanol), ketones (e.g., acetone and methyl ethyl ketone), aromatic hydrocarbons (e.g., benzene, toluene, xylene, ethylbenzene and methylnaphthalene), aliphatic or alicyclic hydrocarbons (e.g., n-hexane, cyclohexanone and kerosene), esters (e.g., ethyl acetate and butyl acetate), nitriles (e.g., acetonitrile and isobutyronitrile), ethers (e.g., dioxane and diisopropyl ether), acid amides (e.g., dimethylformamide and dimethylacetoamide) and halogenated hydrocarbons (e.g., dichloroethane, trichloroethylene and carbon tetrachloride).

Examples of the surfactant include such as alkyl sulfates, alkylsulfonates, alkylarylsulfonates, alkylaryl ethers and polyoxyethylenated products thereof, polyoxyethylene glycol ethers, polyhydric alcohol esters and sugar alcohol derivatives.

Examples of the other auxiliary agents for formulation include such as binders and dispersants. Specific example thereof include such as casein, gelatin, polysaccharides (e.g., starch, gum arabic, cellulose derivatives and alginic acid), lignin derivatives, bentonite, saccharides, synthetic water-soluble polymers (e.g., polyvinyl alcohols, polyvinylpyrrolidones and polyacrylic acids), PAP (acidic isopropyl phosphate), BHT (2,6-di-tert-butyl-4-methylphenol), BHA (a mixture of 2-tert-butyl-4-methoxyphenol and 3-tert-butyl-4-methoxyphenol), vegetable oils, mineral oils, and fatty acids and esters thereof.

Although there is no particular limitation on a method for applying the present controlling agent in order to control plant diseases, the method is exemplified by treatment of plants such as foliar application, treatment of planting sites such as soil treatment, and treatment of seeds such as seed disinfection.

The present controlling agent can also be used in a mixture form with other fungicides, insecticides, acaricides or nematicides. It is also possible to use the present controlling agent simultaneously with such other chemicals without mixing with them.

Examples of the fungicides used with the present controlling agent include as follows.

### (1) Azole Fungicides:

propiconazole, prothioconazole, triadimenol, prochloraz, penconazole, tebuconazole, flusilazole, diniconazole, bromuconazole, epoxiconazole, difenoconazole cyproconazole, metconazole, triflumizole, tetraconazole, microbutanil, fenbuconazole, hexaconazole, fluquinconazole, triticonazole, bitertanol, imazalil, flutriafol, simeconazole, ipconazole, and the like;

### (2) Amine Fungicides:

fenpropimorph, tridemorph, fenpropidin, spiroxamine, and the like;

### (3) Benzimidazole Fungicides:

carbendazim, benomyl, thiabendazole, thiophanate-methyl, and the like;

### (4) Dicarboxyimide Fungicides:

procymidone, iprodione, vinclozolin, and the like;

### (5) Anilino Pyrimidine Fungicides:

cyprodinil, pyrimethanil, mepanipyrim, and the like;

### (6) Phenylpyrrole Fungicides:

fenpiclonil, fludioxonil, and the like;

### (7) Strobilurin Fungicides:

kresoxim-methyl, azoxystrobin, trifloxystrobin, fluoxastrobin, picoxystrobin, pyraclostrobin, dimoxystrobin, pyribencarb, metominostrobin, orysastrobin, enestrobin, and the like;

### (8) Phenyl Amide Fungicides:

metalaxyl, metalaxyl-M or mefenoxam, benalaxyl, benalaxyl-M or kiralaxyl, and the like;

### (9) Carboxylic Acid Amide Fungicides:

dimethomorph, iprovalicarb, benthiavalicarb-isopropyl, mandipropamid, valiphenal;

### (10) Carboxamide Fungicides:

carboxin, mepronil, flutolanil, thifluzamide, furametpyr, boscalid, penthiopyrad, fluopyram, bixafen, penflufen, sedaxane, fluxapyroxad and isopyrazam;

### (11) Other Fungicides:

diethofencarb; thiuram; fluazinam; mancozeb; chlorothalonil; captan; dichlofluanid; folpet; quinoxyfen; fenhexamid; famoxadone; fenamidone; zoxamide; ethaboxam; amisulbrom; cyazofamid; metrafenone; cyflufenamid; proquinazid; flusulfamide; fluopicolide; fosetyl; cymoxanil; pencycuron; tolclofos-methyl; carpropamid; diclocymet; fenoxanil; tricyclazole; pyroquilon; probenazole; isotianil; tiadinil; tebufloquin; diclomezine; kasugamycin; ferimzone; fthalide; validamycin; hydroxyisoxazole; iminoctadine acetate; isoprothiolane; oxolinic acid; oxytetracycline; streptomycin; basic copper chloride; copper (II) hydroxide; basic copper sulfate; organic copper; sulfur; ametoctradin; fenpyrazamine, and the like;
an α-alkoxyphenylacetic acid compound represented by the formula (12):

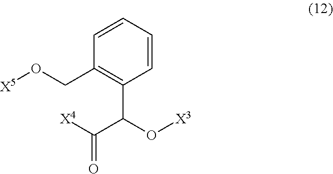

wherein X³ represents a methyl group, a difluoromethyl group or an ethyl group; X⁴ represents a methoxy group or a methylamino group; and X⁵ represents a phenyl group, a 2-methylphenyl group or a 2,5-dimethylphenyl group.

Examples of the insecticides used with the present controlling agent include as follows.

### (1) Organic Phosphorus Compounds:

acephate, Aluminium phosphide, butathiofos, cadusafos, chlorethoxyfos, chlorfenvinphos, chlorpyrifos, chlorpyrifos-methyl, cyanophos:CYAP, diazinon, DCIP (dichlorodiisopropyl ether), dichlofenthion:ECP, dichlorvos:DDVP, dimethoate, dimethylvinphos, disulfoton, EPN, ethion, ethoprophos, etrimfos, fenthion:MPP, fenitrothion:MEP, fosthiazate, formothion, Hydrogen phosphide, isofenphos, isoxathion, malathion, mesulfenfos, methidathion:DMTP, monocrotophos, naled:BRP, oxydeprofos:ESP, parathion, phosalone, phosmet:PMP, pirimiphos-methyl, pyridafenthion, quinalphos, phenthoate:PAP, profenofos, propaphos, prothiofos, pyraclorfos, salithion, sulprofos, tebupirimfos, temephos, tetrachlorvinphos, terbufos, thiometon, trichlorphon:DEP, vamidothion, phorate, cadusafos, and the like;

### (2) Carbamate Compounds:

alanycarb, bendiocarb, benfuracarb, BPMC, carbaryl, carbofuran, carbosulfan, cloethocarb, ethiofencarb, fenobucarb, fenothiocarb, fenoxycarb, furathiocarb, isoprocarb:MIPC, metolcarb, methomyl, methiocarb, NAC, oxamyl, pirimicarb, propoxur:PHC, XMC, thiodicarb, xylylcarb, aldicarb, and the like;

### (3) Synthetic Pyrethroid Compounds:

acrinathrin, allethrin, benfluthrin, beta-cyfluthrin, bifenthrin, cycloprothrin, cyfluthrin, cyhalothrin, cypermethrin, deltamethrin, esfenvalerate, ethofenprox, fenpropathrin, fenvalerate, flucythrinate, flufenoprox, flumethrin, fluvalinate, halfenprox, imiprothrin, permethrin, prallethrin, pyrethrins, resmethrin, sigma-cypermethrin, silafluofen, tefluthrin, tralomethrin, transfluthrin, tetramethrin, phenothrin, cyphenothrin, alpha-cypermethrin, zeta-cypermethrin, lambda-cyhalothrin, furamethrin, tau-fluvalinate, 2,3,5,6-tetrafluoro-4-(methoxymethyl)benzyl(EZ)-(1RS,3RS;1RS,3SR)-2,2-dimethyl-3-prop-1-enylcyclopropanecarboxylate, 2,3,5,6-tetrafluoro-4-methylbenzyl(EZ)-(1RS,3RS;1RS,3SR)-2,2-dimethyl-3-prop-1-enylcyclopropanecarboxylate, 2,3,5,6-tetrafluoro-4-(methoxymethyl)benzyl(1RS,3RS;1RS,3SR)-2,2-dimethyl-3-(2-methyl-1-propenyl)cyclopropanecarboxylate, and the like;

### (4) Nereistoxin Compounds:

cartap, bensultap, thiocyclam, monosultap, bisultap, and the like;

### (5) Neonicotinoid Compounds:

imidacloprid, nitenpyram, acetamiprid, thiamethoxam, thiacloprid, dinotefuran, clothianidin, and the like;

### (6) Benzoyl Urea Compounds:

chlorfluazuron, bistrifluoron, diafenthiuron, diflubenzuron, fluazuron, flucycloxuron, flufenoxuron, hexaflumuron, lufenuron, novaluron, noviflumuron, teflubenzuron, triflumuron, triazuron, and the like;

### (7) Phenylpyrazole-Based Compounds:

acetoprole, ethiprole, fipronil, vaniliprole, pyriprole, pyrafluprole, and the like;

### (8) Bt Toxin Insecticides:

Living spores, produced crystalline toxins and the mixtures thereof derived form Baccilus thuringiensis;

### (9) Hydrazine Compounds:

chromafenozide, halofenozide, methoxyfenozide, tebufenozide, and the like;

### (10) Organic Chlorine Compounds:

aldrin, dieldrin, dienochlor, endosulfan, methoxychlor, and the like;

### (11) Natural Insecticides:

machine oil and nicotine-sulfate;

### (12) Other Insecticides:

avermectin-B, bromopropylate, buprofezin, chlorphenapyr, cyromazine, D-D(1,3-Dichloropropene), emamectin-benzoate, fenazaquin, flupyrazofos, hydroprene, methoprene, indoxacarb, metoxadiazone, milbemycin-A, pymetrozine, pyridalyl, pyriproxyfen, spinosad, sulfluramid, tolfenpyrad, triazamate, flubendiamide, lepimectin, Arsenic acid, benclothiaz, Calcium cyanamide, Calcium polysulfide, chlordane, DDT, DSP, flufenerim, flonicamid, flurimfen, formetanate, metam-ammonium, metam-sodium, Methyl bromide, nidinotefuran, Potassium oleate, protrifenbute, spiromesifen, Sulfur, metaflumizone, spirotetramat, pyrifluquinazone, spinetoram, chlorantraniliprole and cyantrannileprole.

Examples of the acaricides (acaricidal active ingredients) used with the present controlling agent include such as acequinocyl, amitraz, benzoximate, bifenazate, bromopropylate, chinomethionate, chlorobenzilate, CPCBS (chlorfenson), clofentezine, cyflumetofen, dicofol, etoxazole, fenbutatin oxide, fenothiocarb, fenpyroximate, fluacrypyrim, fluproxyfen, hexythiazox, propargite:BPPS, polynactins, pyridaben, Pyrimidifen, tebufenpyrad, tetradifon, spirodiclofen, spiromesifen, spirotetramat, amidoflumet and cyenopyrafen.

Examples of the acaricides (acaricidal active ingredients) used with the present controlling agent include such as acequinocyl, amitraz, benzoximate, bifenazate, bromopropylate, chinomethionate, chlorobenzilate, CPCBS(chlorfenson), clofentezine, cyflumetofen, dicofol, etoxazole, fenbutatin oxide, fenothiocarb, fenpyroximate, fluacrypyrim, fluproxyfen, hexythiazox, propargite:BPPS, polynactins, pyridaben, Pyrimidifen, tebufenpyrad, tetradifon, spirodiclofen, spiromesifen, spirotetramat, amidoflumet and cyenopyrafen.

Examples of the nematocides (nematocidal active ingredients) used with the present controlling agent include such as DCIP, fosthiazate, levamisol, methylsothiocyanate, morantel tartarate and imicyafos.

Although the applying dosage of the present controlling agent is varied depending on weather conditions, formulation forms, when, how and where the present controlling agent is applied, target diseases, target crops and the like, it is usually 1 to 500 g, preferably 2 to 200g, per 1000 m² in terms of the present compound in the present controlling agent. When the present controlling agent takes a form of emulsifiers, wettable powders, suspensions or the like, it is usually applied after diluted with water. In this case, the concentration of the present compound after dilution is usually 0.0005 to 2% by weight, preferably 0.005 to 1% by weight. When the present controlling agent takes a form of powders, granules or the like, it is applied as it is without dilution. In an application to seeds, the applying dosage is usually in a range from 0.001 to 100 g, preferably 0.01 to 50 g, per kilogram of seed in terms of the present compound in the present controlling agent.

The present controlling agent can be used as a controlling composition for plant diseases in crop lands such as upland field, paddy field, lawn and turf, orchard and the like. The present controlling agent is able to control plant diseases in the crop lands or the like where the following “crops” and the like are cultivated.

Field crops: corn, rice, wheat, barley, rye, oat, sorghum, cotton, soybean, peanut, buckwheat, sugar beet, rape, sunflower, sugarcane, tobacco, etc.

Vegetables: solanaceae (e.g. eggplant, tomato, green pepper, chili pepper and potato), Cucurbitaceae (e.g. cucumber, pumpkin, zucchini, watermelon and melon), Cruciferae (e.g. Japanese radish, turnip, horseradish, kohlrabi, Chinese cabbage, cabbage, leaf mustard, broccoli and cauliflower), Compositae (e.g. edible burdock, garland chrysanthemum, globe artichoke and lettuce), Liliacede (e.g., Welsh onion, onion, garlic and asparagus), Umbelliferae (e.g. carrot, parsley, celery and parsnip), Chenopodiaceae (e.g. spinach and chard), Lamiaceae (e.g. perilla, mint and basil), strawberry, sweet potato, Chinese yam, taro, jatropha, etc.

Flowers and ornament plants.

Ornamental foliage plants.

Fruit trees: pomaceous fruits (e.g. apple, pear, Japanese pear, Chinese quince and quince), stone fruits (e.g. peach, plum, nectarine, Japanese apricot, yellow peach, apricot and prune), citrus fruits (e.g. satsuma mandarin, orange, lemon, lime and grapefruit), nut trees (e.g. chestnut, walnut, hazel, almond, pistachio, cashew nut and macadamia nut), berries (blueberry, cranberry, blackberry and raspberry), grape, Japanese persimmon, olive, loquat, banana, coffee, date palm, coconut, etc.

Trees other than fruit trees: tea, mulberry, flowering trees and shrubs, street trees (e.g. Japanese ash, birch, flowering dogwood, blue gum, ginkgo, lilac, maple, oak, poplar, Chinese redbud, Formosa sweet gum, plane tree, zelkova, Japanese arborvitae, fir, Japanese hemlock, needle juniper, pine, Japanese spruce and Japanese yew), etc.

The above-mentioned “crops” also include those imparted with resistance to herbicides, such as HPPD inhibitors (e.g., isoxaflutole), ALS inhibitors (e.g., imazethapyr and thifensulfuron-methyl), EPSP synthetase inhibitors, glutamine synthetase inhibitors, bromoxynil and dicamba, by way of a classic breeding method or genetic recombination technology.

Examples of the “crops” imparted with resistance by the classic breeding method include Clearfield® canola resistant to imidazolinone-based herbicides (e.g., imazethapyr), STS soybean resistant to sulfonylurea-based ALS inhibition type herbicides such as thifensulfuron-methyl, or the like. Further, examples of the crops imparted with resistance by the genetic recombination technology include corn cultivars resistant to glyphosate and gluphosinate, which have been already on the market under the trade name of RoundupReady®, RoundupReady 2® and LibertyLink®.

The above-mentioned “crops” also include plants in which the genetic recombination technology has enabled to synthesize, for example, a selective toxin known as genus Bacillus.

Examples of toxins produced in such genetically modified plants include insecticidal proteins derived from Bacillus cereus and Bacillus popilliae; insecticidal proteins such as δ-endotoxins (e.g. Cry1Ab, Cry1Ac, Cry1F, Cry1Fa2, Cry2Ab, Cry3A, Cry3Bb1 and Cry9C), VIP1, VIP2, VIP3 and VIP3A, which are derived from Bacillus thuringiensis; toxins derived from nematodes; toxins produced by animals, such as scorpion toxin, spider toxin, bee toxin and insect-specific neurotoxins; filamentous fungi toxins; plant lectins; agglutinin; protease inhibitors such as trypsin inhibitors, serine protease inhibitor, patatin, cystatin and papain inhibitors; ribosome-inactivating proteins (RIP) such as ricin, corn-RIP, abrin, rufin, sapolin and priodin; steroid metabolic enzymes such as 3-hydroxysteroid oxidase, ecdysteroid-UDP-glucosyltransferase and cholesterol oxidase; ecdysone inhibitors; HMG-COA reductase; ion channel inhibitors such as a sodium channel inhibitors and calcium channel inhibitors; juvenile hormone esterase; diuretic hormone acceptors; stilbene synthetase; bibenzyl synthetase; chitinase; and glucanase.

The toxins produced in such genetically modified crops also include hybrid toxins, partially deficient toxins and modified toxins of insecticidal proteins, such as 5-endotoxin proteins (e.g. Cry1Ab, Cry1Ac, Cry1F, Cry1Fa2, Cry2Ab, Cry3A, Cry3Bb1 and Cry9C), VIP1, VIP2, VIP3 and VIP3A. The hybrid toxins are produced by a novel combination of the different domains of such a protein by adopting recombination technology. The known partially deficient toxin is Cry1Ab, in which a part of amino acid sequence is deficient. In the modified toxins, one or a plurality of amino acids of a natural toxin are replaced.

Examples of such toxins and genetically modified plants capable of synthesizing such toxins are described in EP-A-0 374 753, WO 93/07278, WO 95/34656, EP-A-0 427 529, EP-A-451 878, WO 03/052073, etc.

The toxins contained in such genetically modified plants impart resistance to insect pests of Coleoptera, insect pests of Diptera and insect pests of Lepidoptera to the plants.

Further, it has already been known that there are genetically modified plants containing one or a plurality of insecticidal pest-resistant genes and capable of producing one or a plurality of toxins. Some of them are commercially available. Examples of such genetically modified plants include such as YieldGard® (a corn cultivar capable of producing a Cry1Ab toxin), YieldGard Rootworm® (a corn cultivar capable of producing a Cry3Bb1 toxin), YieldGard Plus® (a corn cultivar capable of producing Cry1Ab and Cry3Bb1 toxins), Herculex I® (a corn cultivar capable of producing phosphinotrysin N-acetyltransferase (PAT) for imparting resistance to a Cry1Fa2 toxin and Glufosinate), NuCOTN33B (a cotton cultivar capable of producing a Cry1Ac toxin), Bollgard I® (a cotton cultivar capable of producing a Cry1Ac toxin), Bollgard II® (a cotton cultivar capable of producing Cry1Ab and Cry2Ab toxins), VIPCOT® (a cotton cultivar capable of producing a VIP toxin), NewLeaf® (a potato cultivar capable of producing a Cry3A toxin), NatureGard® Agrisure® GT Advantage (GA21 Glyphosate resistant trait), Agrisure® CB Advantage (Bt11 corn borer (CB) trait), and Protecta®.

The above-mentioned “crops” also include those imparted with an ability of producing an anti-pathogenic substance having selective action, by way of genetic recombination technology.

As examples of the anti-pathogenic substance, PR proteins and the like are known (PRPs, EP-A-0 392 225). Such anti-pathogenic substances and genetically modified plants capable of producing them are described in EP-A-0 392 225, WO 95/33818, EP-A-0 353 191, etc.

Examples of such anti-pathogenic substances produced by the genetically modified plants include ion channel inhibitors, such as sodium channel inhibitors and calcium channel inhibitors (for example, KP1, KP4 and KP6 toxins produced by viruses are known); stilbene synthases; bibenzyl synthases; chitinase; glucanase; PR proteins; and anti-pathogenic substances produced by microorganisms, such as peptide antibiotics, antibiotics having a heterocyclic ring and protein factors involved in plant disease resistance (which are called as plant-disease-resistant genes and are described in WO 03/000906), etc.

Examples of plant diseases controllable by the present invention include such as fungal diseases. More specifically, the following plant diseases are listed, but the diseases are not limited thereto.

The present controlling method is usually practiced in the method, wherein the present controlling agent is applied in the above-mentioned manner.

Blast (Magnaporthe grisea), Brown spot (Cochliobolus miyabeanus), sheath blight (Rhizoctonia solani) and “Bakanae” disease (Gibberella fujikuroi) of rice;

powdery mildew (Erysiphe graminis), scab (Fusarium graminearum, F. avenacerum, F. culmorum, Microdochium nivale), rust (Puccinia striiformis, P. graminis, P. recondita), Snow mold (Micronectriella nivale), Typhula snow blight (Typhula sp.), loose smut (Ustilago tritici), bunt (Tilletia caries), eyespot (Pseudocercosporella herpotrichoides), leaf blotch (Septoria tritici), glume blotch (Stagonospora nodorum) and tan spot (Pyrenophora tritici-repentis) of wheat;

powdery mildew (Erysiphe graminis), scab (Fusarium graminearum, F. avenacerum, F. culmorum, Microdochium nivale), rust (Puccinia striiformis, P. graminis, P. hordei), loose smut (Ustilago nuda), scald (Rhynchosporium secalis), net blotch (Pyrenophora teres), spot blotch (Cochliobolus sativus), leaf stripe (Pyrenophora graminea) and seedling damping-off by Rhizoctonia genus (Rhizoctonia solani) of barley;

melanose (Diaporthe citri), scab (Elsinoe fawcetti) and Penicillium rot (Penicillium digitatum, P. italicum) of citrus;

blossom blight (Monilinia mali), canker (Valsa ceratosperma), powdery mildew (Podosphaera leucotricha), Alternaria leaf spot (Alternaria alternata apple pathotype),

scab (Venturia inaequalis) and anthracnose (Glomerella cingulata) of apple;

scab (Venturia nashicola, V. pirina), black spot (Alternaria alternata Japanese pear pathotype) and rust (Gymnosporangium haraeanum) of pear;

brown rot (Monilinia fructicola), scab (Cladosporium carpophilum) and Phomopsis rot (Phomopsis sp.) of peach;

anthracnose (Elsinoe ampelina), ripe rot (Glomerella cingulata), powdery mildew (Uncinula necator), rust (Phakopsora ampelopsidis), black rot (Guignardia bidwellii) and downy mildew (Plasmopara viticola) of grape;

anthracnose (Gloeosporium kaki) and leaf spot (Cercospora kaki, Mycosphaerella nawae) of Japanese persimmon;

anthracnose (Colletotrichum lagenarium), powdery mildew (Sphaerotheca fuliginea), gummy stem blight (Mycosphaerella melonis), stem rot (Fusarium oxysporum), downy mildew (Pseudoperonospora cubensis), Phytophthora rot (Phytophthora sp.) and seedling blight (Pythium sp.) of melons and cucumber;

early blight (Alternaria solani), leaf mold (Cladosporium fulvum) and leaf blight (Phytophthora infestans) of tomato;

brown spot (Phomopsis vexans) and powdery mildew (Erysiphe cichoracearum) of eggplant;

Alternaria leaf spot (Alternaria japonica), white spot (Cercosporella brassicae), clubroot (Plasmodiophora brassicae) and downy mildew (peronospora parasitica) of vegetables of Crusiferae;

Welsh onion rust (Puccinia allii);

purple stain (Cercospora kikuchii), Sphaceloma scab (Elsinoe glycines), pod and stem blight (Diaporthe phaseolorum var. sojae) and rust (Phakopsora pachyrhizi) of soybean;

kidney bean anthracnose (Colletotrichum lindemthianum);

leaf spot (Cercospora personata), leaf spot (Cercospora arachidicola) and southern blight (Sclerotium rolfsii) of peanut;

pea powdery mildew (Erysiphe pisi);

early blight (Alternaria solani), late blight (Phytophthora infestans) and Verticillium wilt (Verticillium albo-atrum, V. dahliae, V. nigrescens) of potato;

strawberry powdery mildew (Sphaerotheca humuli);

net blister blight (Exobasidium reticulatum);

white scab (Elsinoe leucospila), zonate leaf spot (Pestalotiopsis sp.) and anthracnose (Colletotrichum theae-sinensis) of tea plant;

brown spot (Alternaria longipes), powdery mildew (Erysiphe cichoracearum), anthracnose (Colletotrichum tabacum), downy mildew (Peronospora tabacina) and Phytophthora rot (Phytophthora nicotianae) of tobacco;

leaf spot (Cercospora beticola), foliage blight (Thanatephorus cucumeris), root rot (Thanatephorus cucumeris) and black root rot (Aphanomyces cochlioides) of beet;

black spot (Diplocarpon rosae) and powdery mildew (Sphaerotheca pannosa) of rose;

leaf blight (Septoria chrysanthemi-indici) and white rust (Puccinia horiana) of chrysanthemum;

Botrytis diseases (Botrytis cinerea, B. byssoidea, B. squamosa), gray mold neck rot (Botrytis alli) and Small sclerotial neck rot (Botrytis squamosa) of onion;

gray mold (Botrytis cinerea) and stem rot (Sclerotinia sclerotiorum) of various crops;

Alternaria leaf spot (Alternaria brassicicola) of Japanese radish;

dollar spot (Sclerotinia homeocarpa), brown patch and large patch (Rhizoctonia solani) of turf grass; and

Sigatoka diseases (Mycosphaerella fijiensis, Mycosphaerella musicola, Pseudocercospora musae) of banana.

### EXAMPLES

The present invention will be explained in more detail by way of Preparation Examples, Formulation Examples and Test Examples, which should not be construed as limiting the present invention. All the “parts” are by weight. Preparation Example 1 of the present compound

To 40 ml of chloroform, 5.6 g of 2,2,3,4,4,4-hexafluorobutanol was added at room temperature, and to the mixture, 3.0 ml of pyridine and 6.2 ml of trifluoromethanesulfonic anhydride were added at 0° C., and the mixture was stirred at room temperature for 1 hour and 30 minutes. To the reaction mixture, 1N of hydrochloric acid was added, and extracted with diethyl ether. The organic layer was washed successively with an aqueous saturated sodium hydrogen carbonate and saturated brine, and dried over magnesium sulfate, and concentrated under reduced pressure. The resultant residue gave 4.15 g of crude of 2,2,3,4,4,4-hexafluorobutyl trifluoromethanesulfonate.

To 10 ml of DMF, 0.50 g of N-ethyl-N′-(4-hydroxy-2,5-dimethylphenyl)-N-methylformamidine was added at room temperature, then, to the mixture, 0.11 g of 60% sodium hydride (oil dispersion) was added, and the mixture was stirred at room temperature for 20 minutes. Then, to the mixture, 0.92 g of crude of 2,2,3,4,4,4-hexafluorobutyl trifluoromethanesulfonate obtained above was added at room temperature, and the mixture was stirred at room temperature for 2 hours and 30 minutes. To the reaction mixture, an aqueous saturated ammonium chloride solution was added, and extract with ethyl acetate. The organic layer was washed with saturated brine, then dried over sodium sulfate, and concentrated under reduced pressure.

The resultant residue was subjected to silica gel column chromatography to obtain 0.5 g of the formula:

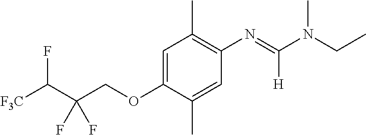 [SMILES: CCN(C)/C=N/c1cc(C)c(OCC(F)(F)C(F)C(F)(F)F)cc1C]

(hereinafter referred to as “the present compound 1”).

¹H-NMR (CDCl₃) δ: 1.20 (3H, t, J=7.2 Hz), 2.17 (3H, s), 2.23 (3H, s), 2.98 (3H, s), 3.35 (2H, br s), 4.18-4.38 (2H, m), 5.11-5.28 (1H, m), 6.56 (1H, s), 6.63 (1H, s), 7.38 (1H, s).

### Preparation Example 2 of the Present Compound

To 3 ml of DMF, 0.20 g of N-ethyl-N′-(4-hydroxy-2,5-dimethylphenyl)-N-methylformamidine was added at room temperature, then, to the mixture, 0.26 g of 2,2,3,3-tetrafluoropropyl trifluoromethanesulfonate and 0.11 g of 60% sodium hydride (oil dispersion) were added successively at room temperature, and the mixture was stirred overnight. To the reaction mixture, an aqueous saturated ammonium chloride solution was added, and extracted with ethyl acetate. The organic layer was washed with saturated brine, then dried over sodium sulfate, and concentrated under reduced pressure. The resultant residue was subjected to silica gel column chromatography to obtain 0.20 g of the formula:

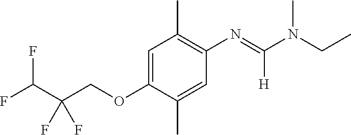 [SMILES: CCN(C)/C=N/c1cc(C)c(OCC(F)(F)C(F)F)cc1C]

(hereinafter referred to as “the present compound 2”).

¹H-NMR (CDCl₃) δ: 1.20 (3H, t, J=7.1 Hz), 2.16 (3H, s), 2.23 (3H, s), 2.98 (3H, s), 3.35 (2H, br s), 4.28 (2H, t, J=11.8 Hz), 6.08 (1H, tt, J=53.0, 5.2 Hz), 6.56 (1H, s), 6.62 (1H, s), 7.38 (1H, s).

### Preparation Example 3 of the Present Compound

To 20 ml of diethyl ether, 0.70 g of 2,2,2-trifluoroethanol was added at room temperature and to the mixture, 1.4 ml of trifluoromethanesulfonic anhydride and 1.0 ml of triethylamine were added at −50° C., and the mixture was stirred at 0° C. for 30 minutes. To the reaction mixture, 1N hydrochloric acid was added, and extracted with diethyl ether. The organic layer was washed successively with an aqueous saturated sodium hydrogen carbonate solution and saturated brine, then dried over magnesium sulfate, and concentrated under reduced pressure. The resultant residue gave crude of 0.46 g of 2,2,2-trifluoroethyl trifluoromethanesulfonate.

To the 4 ml of DMF, 0.22 g of N-ethyl-N′-(4-hydroxy-2,5-dimethylphenyl)-N-methylformamidine was added at room temperature, and to the mixture, 0.047 g of 60% sodium hydride (oil dispersion) was added at room temperature, and the mixture was stirred at room temperature for 15 minutes. Then, to the mixture, 0.30 g of crude of 2,2,2-trifluoroethyl trifluoromethanesulfonate obtained above was added at room temperature, and stirred at room temperature for 2 hours. To the reaction mixture, an aqueous saturated ammonium chloride solution was added, and extracted with ethyl acetate. The organic layer was washed with saturated brine, then dried over sodium sulfate, and concentrated under reduced pressure. The resultant residue was subjected to silica gel column chromatography to obtain 0.15 g of formula:

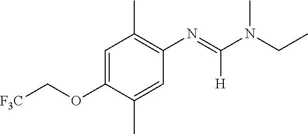 [SMILES: CCN(C)/C=N/c1cc(C)c(OCC(F)(F)F)cc1C]

(hereinafter referred to as “the present compound 3”).

¹H-NMR (CDCl₃) δ: 1.20 (3H, t, J=7.2 Hz), 2.19 (3H, s), 2.22 (3H, s), 2.98 (3H, s), 3.35 (2H, br s), 4.29 (2H, q, J=8.3 Hz), 6.56 (1H, s), 6.62 (1H, s), 7.39 (1H, s).

### Preparation Example 4 of the Present Compound

To 40 ml of diethyl ether, 1.5 g of 2,2,3,3,3-pentafluoropropanol was added at room temperature. To the mixture, 2.0 ml of trifluoromethanesulfonic anhydride and 1.5 ml of triethylamine were successively added at −50° C., and the mixture was stirred at 0° C. for 20 minutes. To the reaction mixture, 1N hydrochloric acid was added, and extracted with diethyl ether. The organic layer was washed successively with an aqueous saturated sodium hydrogen carbonate solution and saturated brine, then dried over magnesium sulfate, and concentrated under reduced pressure. The resultant residue gave crude of 2,2,3,3,3-pentafluoropropyl trifluoromethanesulfonate.

To 10 ml of DMF, 0.53 g of N-ethyl-N′-(4-hydroxy-2,5-dimethylphenyl)-N-methylformamidine was added at room temperature, and to the mixture, 0.15 g of 60% sodium hydride (oil dispersion) was added at room temperature, then the mixture was stirred at room temperature for 20 minutes. Then to the mixture, whole amount of crude of 2,2,3,3,3-pentafluoropropyl trifluoromethanesulfonate obtained above was added at room temperature, and stirred at room temperature for 30 minutes. To the reaction mixture, an aqueous saturated ammonium chloride solution was added, and extracted with ethyl acetate. The organic layer was washed with saturated brine, then dried over sodium sulfate, and concentrated under reduced pressure. The resultant residue was subjected to silica gel column chromatography to obtain 0.094 g of formula:

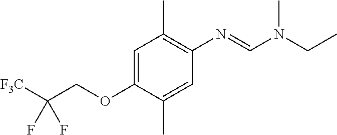 [SMILES: CCN(C)/C=N/c1cc(C)c(OCC(F)(F)C(F)(F)F)cc1C]

(hereinafter referred to as “the present compound 4”).

¹H-NMR (CDCl₃) δ: 1.20 (3H, t, J=7.2 Hz), 2.17 (3H, s), 2.23 (3H, s), 2.98 (3H, s), 3.34 (2H, br s), 4.34-4.37 (2H, m), 6.56 (1H, s), 6.60 (1H, s), 7.38 (1H, s).

### Preparation Example 5 of the Present Compound

To 30 ml of diethyl ether, 1.6 g of 2,2,3,3,4,4,4-heptafluorobutanol was added at room temperature, and to the mixture, 1.6 ml of trifluoromethanesulfonic anhydride and 1.1 ml of triethylamine were successively added at −50° C., and the mixture was stirred at 0° C. for 30 minutes. To the reaction mixture, 1N hydrochloric acid was added, and extracted with diethyl ether. The organic layer was washed successively with saturated aqueous sodium hydrogen carbonate and saturated brine, then dried over magnesium sulfate, and concentrated under reduced pressure. The resultant residue gave a crude of 2,2,3,3,4,4,4-heptafluorobutyl trifluoromethanesulfonate.

To 10 ml of DMF, 0.48 g of N-ethyl-N′-(4-hydroxy-2,5-dimethylphenyl)-N-methylformamidine was added at room temperature, and to the mixture, 0.14 g of 60% sodium hydride (oil dispersion) was added at room temperature, then the mixture was stirred at room temperature for 20 minutes. To the mixture, whole amount of crude of 2,2,3,3,4,4,4-heptafluorobutyl trifluoromethanesulfonate obtained above was added at room temperature, and stirred at room temperature for 20 minutes. To the reaction mixture, an aqueous saturated ammonium chloride solution was added, and extracted with ethyl acetate. The organic layer was washed with saturated brine, then dried over sodium sulfate, and concentrated under reduced pressure. The resultant residue was subjected to silica gel column chromatography to obtain 0.059 g of formula:

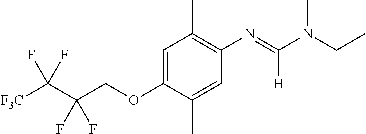 [SMILES: CCN(C)/C=N/c1cc(C)c(OCC(F)(F)C(F)(F)C(F)(F)F)cc1C]

(hereinafter referred to as “the present compound 5”).

¹H-NMR (CDCl₃) δ: 1.20 (3H, t, J=7.2 Hz), 2.17 (3H, s), 2.23 (3H, s), 2.98 (3H, s), 3.35 (2H, br s), 4.39 (2H, t, J=12.9 Hz), 6.56 (1H, s), 6.61 (1H, s), 7.38 (1H, s).

### Preparation Example 6 of the Present Compound

To 25 ml of diethyl ether, 1.5 g of 2,2,3,3,4,4,5,5,5-nonafluoropentanol was added at room temperature, and to the mixture, 1.2 ml of trifluoromethanesulfonic anhydride and 0.89 ml of triethylamine were successively added at −50° C., and the mixture was stirred at 0° C. for 20 minutes. To the reaction mixture, 1N hydrochloric acid was added, and extracted with diethyl ether. The organic layer was washed successively with an aqueous saturated sodium hydrogen carbonate solution and saturated brine, then dried over magnesium sulfate, and concentrated under reduced pressure. The resultant residue gave a crude of 2,2,3,3,4,4,5,5,5-nonafluoropentyl trifluoromethanesulfonate.

To 3 ml of DMF, 0.20 g of N-ethyl-N′-(4-hydroxy-2,5-dimethylphenyl)-N-methylformamidine was added at room temperature, and to the mixture, 0.043 g of 60% sodium hydride (oil dispersion) was added at room temperature, then the mixture was stirred at room temperature for 15 minutes. To the mixture, whole amount of crude of 2,2,3,3,4,4,5,5,5-nonafluoropentyl trifluoromethanesulfonate obtained above was added at room temperature, and stirred at room temperature for 1 hour. To the reaction mixture, an aqueous saturated ammonium chloride solution was added, and extracted with ethyl acetate. The organic layer was washed with saturated brine, then dried over sodium sulfate, and concentrated under reduced pressure. The resultant residue was subjected to silica gel column chromatography to obtain 0.045 g of formula:

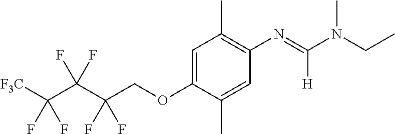 [SMILES: CCN(C)/C=N/c1cc(C)c(OCC(F)(F)C(F)(F)C(F)(F)C(F)(F)F)cc1C]

(hereinafter referred to as “the present compound 6”).

¹H-NMR (CDCl₃) δ: 1.20 (3H, t, J=7.2 Hz), 2.17 (3H, s), 2.23 (3H, s), 2.98 (3H, s), 3.35 (2H, br s), 4.40 (2H, t, J=12.9 Hz), 6.57 (1H, s), 6.61 (1H, s), 7.38 (1H, s).

### Preparation Example 7 of the Present Compound

To 20 ml of diethyl ether, 1.9 g of 2,2,3,3,4,4,5,5,6,6,6-undecafluorohexanol was added at room temperature, and to the mixture, 1.2 ml of trifluoromethanesulfonic anhydride and 0.91 ml of triethylamine were successively added at −50° C., and the mixture was stirred at 0° C. for 30 minutes. To the reaction mixture, 1N hydrochloric acid was added, and extracted with diethyl ether. The organic layer was washed successively with an aqueous saturated sodium hydrogen carbonate solution and saturated brine, then dried over magnesium sulfate, and concentrated under reduced pressure. The resultant residue gave a crude of 2,2,3,3,4,4,5,5,6,6,6-undecafluorohexyl trifluoromethanesulfonate.

To 3 ml of DMF, 0.20 g of N-ethyl-N′-(4-hydroxy-2,5-dimethylphenyl)-N-methylformamidine was added at room temperature, and to the mixture, 0.078 g of 60% sodium hydride (oil dispersion) was added at room temperature, then, the mixture was stirred at room temperature for 30 minutes. To the mixture, whole amount of crude of 2,2,3,3,4,4,5,5,6,6,6-undecafluorohexyl trifluoromethanesulfonate obtained above was added at room temperature, and stirred at room temperature for 2 hours. To the reaction mixture, an aqueous saturated ammonium chloride solution was added, and extracted with ethyl acetate. The organic layer was washed with saturated brine, then dried over sodium sulfate, and concentrated under reduced pressure. The resultant residue was subjected to silica gel column chromatography to obtain 0.083 g of formula:

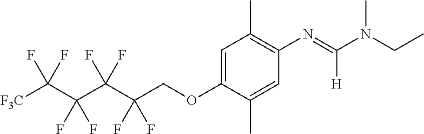 [SMILES: CCN(C)/C=N/c1cc(C)c(OCC(F)(F)C(F)(F)C(F)(F)C(F)(F)C(F)(F)F)cc1C]

(hereinafter referred to as “the present compound 7”).

¹H-NMR (CDCl₃) δ: 1.20 (3H, t, J=7.2 Hz), 2.18 (3H, s), 2.23 (3H, s), 2.98 (3H, s), 3.35 (2H, br s), 4.40 (2H, t, J=12.9 Hz), 6.56 (1H, s), 6.61 (1H, s), 7.38 (1H, s).

### Preparation Example 8 of the Present Compound

To 20 ml of diethyl ether, 2.1 g of 2,2,3,3,4,4,5,5,6,6,7,7,7-tridecafluoroheptanol was added at room temperature. To the mixture, 1.2 ml of trifluoromethanesulfonic anhydride and 0.89 ml of triethylamine were successively added at −50° C., and the mixture was stirred at 0° C. for 20 minutes. To the reaction mixture, 1N hydrochloric acid was added, and extracted with diethyl ether. The organic layer was washed successively with an aqueous saturated sodium hydrogen carbonate solution and saturated brine, then dried over magnesium sulfate, and concentrated under reduced pressure. The resultant residue gave crude of 2,2,3,3,4,4,5,5,6,6,7,7,7-tridecafluoroheptyl trifluoromethanesulfonate.

To the 3 ml of DMF, 0.20 g of N-ethyl-N′-(4-hydroxy-2,5-dimethylphenyl)-N-methylformamidine was added at room temperature, and to the mixture, 0.078 g of 60% sodium hydride (oil dispersion) was added, then the mixture was stirred at room temperature for 30 minutes. Then to the mixture, whole amount of crude of 2,2,3,3,4,4,5,5,6,6,7,7,7-tridecafluoroheptyl trifluoromethanesulfonate obtained above was added at room temperature, and stirred at room temperature for 2 hours. To the reaction mixture, an aqueous saturated ammonium chloride solution was added, and extracted with ethyl acetate. The organic layer was washed with saturated brine, then dried over sodium sulfate, and concentrated under reduced pressure. The resultant residue was subjected to silica gel column chromatography to obtain 0.065 g of formula:

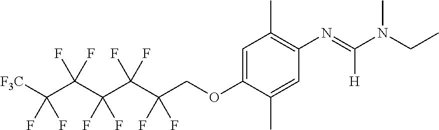 [SMILES: CCN(C)/C=N/c1cc(C)c(OCC(F)(F)C(F)(F)C(F)(F)C(F)(F)C(F)(F)C(F)(F)F)cc1C]

(hereinafter referred to as “the present compound 8”).

¹H-NMR (CDCl₃) δ: 1.20 (3H, t, J=7.2 Hz), 2.17 (3H, s), 2.23 (3H, s), 2.98 (3H, s), 3.35 (2H, br s), 4.40 (2H, t, J=12.9 Hz), 6.57 (1H, s), 6.61 (1H, s), 7.38 (1H, s).

### Preparation Example 9 of the Present Compound

To 30 ml of diethyl ether, 2.5 g of 2,2,3,3,4,4,5,5,6,6,7,7,8,8,8-pentadecafluorooctanol was added at room temperature, and to the mixture, 1.3 ml of trifluoromethanesulfonic anhydride and 0.92 ml of triethylamine were successively added at −50° C., and the mixture was stirred at 0° C. for 20 minutes. To the reaction mixture, 1N hydrochloric acid was added, and extracted with diethyl ether. The organic layer was washed successively with an aqueous saturated sodium hydrogen carbonate solution and saturated brine, then dried over magnesium sulfate, and concentrated under reduced pressure. The resultant residue gave crude of 2,2,3,3,4,4,5,5,6,6,7,7,8,8,8-pentadefluorooctyl trifluoromethanesulfonate.

To the 10 ml of DMF, 0.50 g of N-ethyl-N′-(4-hydroxy-2,5-dimethylphenyl)-N-methylformamidine was added at room temperature, and to the mixture, 0.16 g of 60% sodium hydride (oil dispersion) was added at room temperature, then the mixture was stirred at room temperature for 20 minutes. Then to the mixture, whole amount of crude of 2,2,3,3,4,4,5,5,6,6,7,7,8,8,8-pentadefluorooctyl trifluoromethanesulfonate obtained above was added at room temperature, and stirred at room temperature for 2 hours. To the reaction mixture, an aqueous saturated ammonium chloride solution was added, and extracted with ethyl acetate. The organic layer was washed with saturated brine, then dried over sodium sulfate, and concentrated under reduced pressure. The resultant residue was subjected to silica gel column chromatography to obtain 0.082 g of formula:

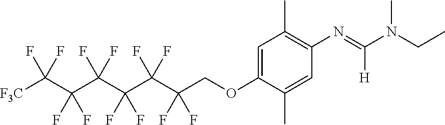 [SMILES: CCN(C)/C=N/c1cc(C)c(OCC(F)(F)C(F)(F)C(F)(F)C(F)(F)C(F)(F)C(F)(F)C(F)(F)F)cc1C]

(hereinafter referred to as “the present compound 9”).

¹H-NMR (CDCl₃) δ: 1.20 (3H, t, J=7.1 Hz), 2.18 (3H, s), 2.23 (3H, s), 2.98 (3H, s), 3.35 (2H, br s), 4.40 (2H, t, J=12.8 Hz), 6.57 (1H, s), 6.61 (1H, s), 7.38 (1H, s).

### Preparation Example 10 of the Present Compound

To 30 ml of diethyl ether, 3.1 g of 2,2,3,3,4,4,5,5,6,6,7,7,8,8,9,9,9-heptadecafluorononanol was added at room temperature, and to the mixture, 1.4 ml of trifluoromethanesulfonic anhydride and 1.0 ml of triethylamine were successively added at −50° C., and the mixture was stirred at 0° C. for 10 minutes. To the reaction mixture, 1N hydrochloric acid was added, and extracted with diethyl ether. The organic layer was washed successively with an aqueous saturated sodium hydrogen carbonate solution and saturated brine, then dried over magnesium sulfate, and concentrated under reduced pressure. The resultant residue gave crude of 2,2,3,3,4,4,5,5,6,6,7,7,8,8,9,9,9-heptafluorononyl trifluoromethanesulfonate.

To the 3 ml of DMF, 0.20 g of N-ethyl-N′-(4-hydroxy-2,5-dimethylphenyl)-N-methylformamidine was added at room temperature, and to the mixture, 0.16 g of 60% sodium hydride (oil dispersion) was added at room temperature, then the mixture was stirred at room temperature for 15 minutes. To the mixture, whole amount of crude of 2,2,3,3,4,4,5,5,6,6,7,7,8,8,9,9,9-heptafluorononyl trifluoromethanesulfonate obtained above was added at room temperature, and stirred at room temperature for 15 hours. To the reaction mixture, an aqueous saturated ammonium chloride solution was added, and extracted with ethyl acetate. The organic layer was washed with saturated brine, then dried over sodium sulfate, and concentrated under reduced pressure. The resultant residue was subjected to silica gel column chromatography to obtain 0.094 g of formula:

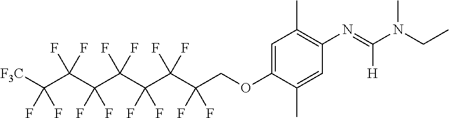 [SMILES: CCN(C)/C=N/c1cc(C)c(OCC(F)(F)C(F)(F)C(F)(F)C(F)(F)C(F)(F)C(F)(F)C(F)(F)C(F)(F)F)cc1C]

(hereinafter referred to as “the present compound 10”).

¹H-NMR (CDCl₃) δ: 1.20 (3H, t, J=7.2 Hz), 2.18 (3H, s), 2.23 (3H, s), 2.98 (3H, s), 3.35 (2H, br s), 4.40 (2H, t, J=12.8 Hz), 6.57 (1H, s), 6.61 (1H, s), 7.38 (1H, s).

### Preparation Example 11 of the Present Compound

To 20 ml of diethyl ether, 2.5 g of 2,2,3,3,4,4,5,5,6,6,7,7,8,8,9,9,10,10,10-nonadecafluorodecanol was added at room temperature, and to the mixture, 1.0 ml of trifluoromethanesulfonic anhydride and 0.74 ml of triethylamine were successively added at −50° C., and the mixture was stirred at 0° C. for 20 minutes. To the reaction mixture, 1N hydrochloric acid was added, and extracted with diethyl ether. The organic layer was washed successively with an aqueous saturated sodium hydrogen carbonate solution and saturated brine, then dried over magnesium sulfate, and concentrated under reduced pressure. The resultant residue gave crude of 2,2,3,3,4,4,5,5,6,6,7,7,8,8,9,9,10,10,10-nonadecafluorodecyl trifluoromethanesulfonate.

To the 10 ml of DMF, 0.51 g of N-ethyl-N′-(4-hydroxy-2,5-dimethylphenyl)-N-methylformamidine was added at room temperature, and to the mixture, 0.20 g of 60% sodium hydride (oil dispersion) was added at room temperature, then the mixture was stirred at room temperature for 15 minutes. Then to the mixture, whole amount of crude of 2,2,3,3,4,4,5,5,6,6,7,7,8,8,9,9,10,10,10-nonadecafluorodecyl trifluoromethanesulfonate obtained above was added at room temperature, and stirred at room temperature for 2 hours and 30 minutes. To the reaction mixture, an aqueous saturated ammonium chloride solution was added, and extracted with ethyl acetate. The organic layer was washed with saturated brine, then dried over sodium sulfate, and concentrated under reduced pressure. The resultant residue was subjected to silica gel column chromatography to obtain 0.12 g of formula:

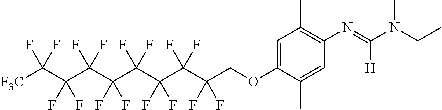 [SMILES: CCN(C)/C=N/c1cc(C)c(OCC(F)(F)C(F)(F)C(F)(F)C(F)(F)C(F)(F)C(F)(F)C(F)(F)C(F)(F)C(F)(F)F)cc1C]

(hereinafter referred to as “the present compound 11”).

¹H-NMR (CDCl₃) δ: 1.20 (3H, t, J=7.2 Hz), 2.18 (3H, s), 2.23 (3H, s), 2.98 (3H, s), 3.36 (2H, br s), 4.40 (2H, t, J=13.0 Hz), 6.57 (1H, s), 6.61 (1H, s), 7.39 (1H, s).

### Preparation Example 12 of the Present Compound

To the 6 ml of DMF, 0.26 g of N-ethyl-N′-(4-hydroxy-2,5-dimethylphenyl)-N-methylformamidine was added at room temperature, and to the mixture, 0.055 g of 60% sodium hydride (oil dispersion) and 0.95 g of 2,2,3,3,4,4,5,5,6,6,7,7,8,8,9,9,10,10,11,11,11-henicosafluoroundecyl trifluoromethanesulfonate were successively added at 0° C., then the mixture was stirred at room temperature for 30 minutes. To the reaction mixture, an aqueous saturated ammonium chloride solution was added, and extracted with ethyl acetate. The organic layer was washed with saturated brine, then dried over sodium sulfate, and concentrated under reduced pressure. The resultant residue was subjected to silica gel column chromatography to obtain 0.059 g of formula:

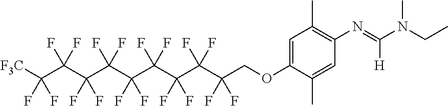 [SMILES: CCN(C)/C=N/c1cc(C)c(OCC(F)(F)C(F)(F)C(F)(F)C(F)(F)C(F)(F)C(F)(F)C(F)(F)C(F)(F)C(F)(F)C(F)(F)F)cc1C]

(hereinafter referred to as “the present compound 12”).

¹H-NMR (CDCl₃) δ: 1.20 (3H, t, J=7.2 Hz), 2.18 (3H, s), 2.23 (3H, s), 2.98 (3H, s), 3.35 (2H, br s), 4.41 (2H, t, J=12.8 Hz), 6.57 (1H, s), 6.61 (1H, s), 7.38 (1H, s).

### Preparation Example 13 of the Present Compound

To 7 ml of DMF, 0.43 g of N-ethyl-N′-(4-hydroxy-2,5-dimethylphenyl)-N-methylformamidine and 0.031 g of sodium iodide were added at room temperature, and to the mixture, 0.055 g of 60% sodium hydride (oil dispersion) was added at room temperature, then stirred at room temperature for 30 minutes. To the mixture, 0.59 g of 1-bromo-4,4,4-trifluorobutane was added at room temperature, then the mixture was stirred at room temperature for 30 minutes. To the reaction mixture, an aqueous saturated ammonium chloride solution was added, and extracted with ethyl acetate. The organic layer was washed with saturated brine, then dried over sodium sulfate, and concentrated under reduced pressure. The resultant residue was subjected to silica gel column chromatography to obtain 0.11 g of formula:

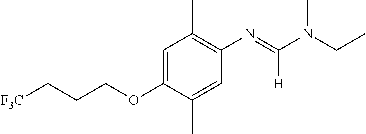 [SMILES: CCN(C)/C=N/c1cc(C)c(OCCCC(F)(F)F)cc1C]

(hereinafter referred to as “the present compound 13”).

¹H-NMR (CDCl₃) δ: 1.20 (3H, t, J=7.0 Hz), 2.02-2.05 (2H, m), 2.15 (3H, s), 2.23 (3H, s), 2.30-2.33 (2H, m), 2.97 (3H, s), 3.35 (2H, br s), 3.97 (2H, t, J=5.9 Hz), 6.55 (1H, s), 6.61 (1H, s), 7.39 (1H, s).

### Preparation Example 14 of the Present Compound

To 7 ml of DMF, 0.44 g of N-ethyl-N′-(4-hydroxy-2,5-dimethylphenyl)-N-methylformamidine and 0.032 g of sodium iodide were added at room temperature, and to the mixture, 0.093 g of 60% sodium hydride (oil dispersion) was added at room temperature, then stirred at room temperature for 30 minutes. To the mixture, 0.59 g of 1-bromo-6,6,6-trifluorohexane was added at room temperature, then the mixture was stirred at room temperature for 30 minutes. To the reaction mixture, an aqueous saturated ammonium chloride solution was added, and extracted with ethyl acetate. The organic layer was washed with saturated brine, then dried over sodium sulfate, and concentrated under reduced pressure. The resultant residue was subjected to silica gel column chromatography to obtain 0.16 g of formula:

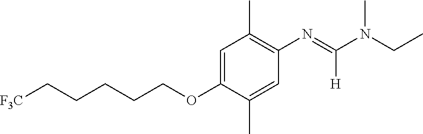 [SMILES: CCN(C)/C=N/c1cc(C)c(OCCCCCC(F)(F)F)cc1C]

(hereinafter referred to as “the present compound 14”).

¹H-NMR (CDCl₃) δ: 1.19 (3H, t, J=7.2 Hz), 1.60-1.64 (4H, m), 1.76-1.83 (2H, m), 2.08-2.11 (2H, m), 2.15 (3H, s), 2.23 (3H, s), 2.97 (3H, s), 3.34 (2H, br s), 3.92 (2H, t, J=6.1 Hz), 6.55 (1H, s), 6.62 (1H, s), 7.39 (1H, s).

### Preparation Example 15 of the Present Compound

To 0.26 g of 2,2-difluoro-4,4-dimethyl-(4-amino-2,5-dimethylphenoxy)pentane, 4 ml of trimethyl orthoformate and 0.018 g of para-toluenesulfonic acid monohydrate were added at room temperature, and the mixture was refluxed for 1 hour. The reaction mixture was allowed to stand and cooled to about room temperature. To the reaction mixture, an aqueous saturated sodium hydrogen carbonate solution was added, and extracted with MTBE. The organic layer was washed with saturated brine, then dried over sodium sulfate, and concentrated under reduced pressure. The resultant residue gave a crude of Methyl N-{4-(2,2-difluoro-4,4-dimethylpentyloxy)-2,5-dimethyl}phenylformimidate.

To 4 ml of 1,4-dioxane, whole amount of crude of Methyl N-{4-(2,2-difluoro-4,4-dimethylpentyloxy)-2,5-dimethyl}phenylformimidate obtained above was added at room temperature. To the mixture, 0.12 ml of ethylmethylamine was added at room temperature, and stirred at 80° for 3 hours. The reaction mixture was allowed to stand and cooled to about room temperature, then, the reaction mixture was concentrated under reduced pressure. The resultant residue was subjected to silica gel column chromatography to obtain 0.22 g of formula:

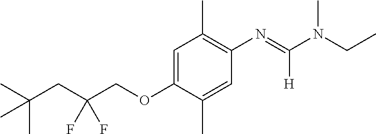 [SMILES: CCN(C)/C=N/c1cc(C)c(OCC(F)(F)CC(C)(C)C)cc1C]

(hereinafter referred to as “the present compound 15”).

¹H-NMR (CDCl₃) δ: 1.09 (9H, s), 1.19 (3H, t, J=7.2 Hz), 2.01 (2H, t, J=20.0 Hz), 2.20 (3H, s), 2.22 (3H, s), 2.97 (3H, s), 3.34 (2H, br s), 4.00 (2H, t, J=12.0 Hz), 6.55 (1H, s), 6.59 (1H, s), 7.38 (1H, s).

### Preparation Example 16 of the Present Compound

To 0.25 g of 2,2-difluoro-(4-amino-2,5-dimethylphenoxy)butane, 4 ml of trimethyl orthoformate and 0.021 g of para-toluenesulfonic acid monohydrate were added at room temperature, and the mixture was refluxed for 1 hour and 40 minutes. The reaction mixture was allowed to stand and cooled to about room temperature. To the reaction mixture, an aqueous saturated sodium hydrogen carbonate solution was added, and extracted with MTBE. The organic layer was washed with saturated brine, then dried over sodium sulfate, and concentrated under reduced pressure. The resultant residue gave a crude of Methyl N-{4-(2,2-difluorobutoxy)-2,5-dimethyl}phenylformimidate.

To 4 ml of 1,4-dioxane, whole amount of crude of Methyl N-{4-(2,2-difluorobutoxy)-2,5-dimethyl}phenylformimidate obtained above was added. To the mixture, 0.14 ml of ethylmethylamine was added at room temperature, and stirred at 80° C. for 40 minutes. The reaction mixture was allowed to stand and cooled to about room temperature, then the reaction mixture was concentrated under reduced pressure. The resultant residue was subjected to silica gel column chromatography to obtain 0.25 g of formula:

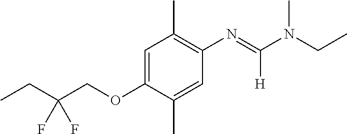 [SMILES: CCN(C)/C=N/c1cc(C)c(OCC(F)(F)CC)cc1C]

(hereinafter referred to as “the present compound 16”).

¹H-NMR (CDCl₃) δ: 1.08 (3H, t, J=7.6 Hz), 1.19 (3H, t, J=7.1 Hz), 2.04-2.15 (2H, m), 2.17 (3H, s), 2.23 (3H, s), 2.98 (3H, s), 3.34 (2H, br s), 4.07 (2H, t, J=11.7 Hz), 6.56 (1H, s), 6.61 (1H, s), 7.38 (1H, s).

### Preparation Example 17 of the Present Compound

To 0.28 g of 2,2-difluoro-4-methyl-(4-amino-2,5-dimethylphenoxy)pentane, 4 ml of trimethyl orthoformate and 0.020 g of para-toluenesulfonic acid monohydrate were added at room temperature, and the mixture was refluxed for 1 hour and 40 minutes. The reaction mixture was allowed to stand and cooled to about room temperature. To the reaction mixture, an aqueous saturated sodium hydrogen carbonate solution was added, and extracted with MTBE. The organic layer was washed with saturated brine, then dried over sodium sulfate, and concentrated under reduced pressure. The resultant residue gave a crude of Methyl N-{4-(2,2-difluoro-4-methylpentyloxy)-2,5-dimethylphenyl}formimidate.

To 4 ml of 1,4-dioxane, whole amount of crude of Methyl N-{4-(2,2-difluoro-4-methylpentyloxy)-2,5-dimethylphenyl}formimidate obtained above was added. To the mixture, 0.14 ml of ethylmethylamine was added at room temperature, and stirred at 80° C. for 40 minutes. The reaction mixture was allowed to stand and cooled to about room temperature, then the reaction mixture was concentrated under reduced pressure. The resultant residue was subjected to silica gel column chromatography to obtain 0.28 g of formula:

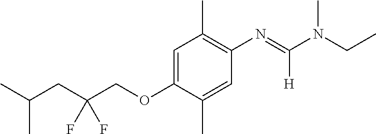 [SMILES: CCN(C)/C=N/c1cc(C)c(OCC(F)(F)CC(C)C)cc1C]

(hereinafter referred to as “the present compound 17”).

¹H-NMR (CDCl₃) δ: 1.01 (6H, d, J=6.3 Hz), 1.19 (3H, t, J=7.0 Hz), 1.95-1.99 (3H, m), 2.18 (3H, s), 2.23 (3H, s), 2.97 (3H, s), 3.34 (2H, br s), 4.05 (2H, t, J=11.8 Hz), 6.56 (1H, s), 6.61 (1H, s), 7.39 (1H, s).

### Preparation Example 18 of the Present Compound

To 0.30 g of 2,2-difluoro-4,4-dimethyl-(4-amino-2,5-dimethylphenoxy)pentane, 5 ml of trimethyl orthoformate and 0.021 g of para-toluenesulfonic acid monohydrate were added at room temperature, and the mixture was refluxed for 1 hour. The reaction mixture was allowed to stand and cooled to about room temperature and concentrated under reduced pressure. To the resultant residue, 5 ml of 1,4-dioxane and 0.23 ml of diethylamine were added at room temperature, then the mixture was stirred at 80° C. for 3 hours. The reaction mixture was allowed to stand and cooled to about room temperature, then the reaction mixture was concentrated under reduced pressure. The resultant residue was subjected to silica gel column chromatography to obtain 0.20 g of formula:

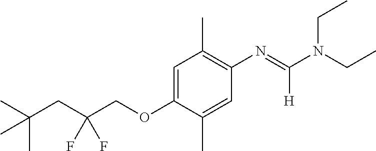 [SMILES: CCN(/C=N/c1cc(C)c(OCC(F)(F)CC(C)(C)C)cc1C)CC]

(hereinafter referred to as “the present compound 18”).

¹H-NMR (CDCl₃) δ: 1.09 (9H, s), 1.20 (6H, t, J=7.1 Hz), 2.01 (2H, t, J=20.2 Hz), 2.19 (3H, s), 2.22 (3H, s), 3.37 (4H, br s), 4.00 (2H, t, J=12.0 Hz), 6.55 (1H, s), 6.59 (1H, s), 7.36 (1H, s).

### Preparation Example 19 of the Present Compound

To 0.30 g of 2,2-difluoro-4,4-dimethyl-(4-amino-2,5-dimethylphenoxy)pentane, 5 ml of N,N-dimethylformamide dimethyl acetal was added at room temperature, and the mixture was stirred at 100° C. for 3 hours. The reaction mixture was allowed to stand and cooled to about room temperature, then the reaction mixture was concentrated under reduced pressure. The resultant residue was subjected to silica gel column chromatography to obtain 0.22 g of formula:

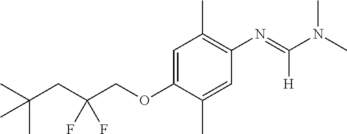 [SMILES: Cc1cc(OCC(F)(F)CC(C)(C)C)c(C)cc1/N=C/N(C)C]

(hereinafter referred to as “the present compound 19”).

¹H-NMR (CDCl₃) δ: 1.09 (9H, s), 2.01 (2H, t, J=20.0 Hz), 2.19 (3H, s), 2.23 (3H, s), 2.99 (6H, s), 4.00 (2H, t, J=12.0 Hz), 6.56 (1H, s), 6.59 (1H, s), 7.37 (1H, s).

### Preparation Example 20 of the Present Compound

To 0.30 g of 2,2-difluoro-4,4-dimethyl-(4-amino-2,5-dimethylphenoxy)pentane, 5 ml of trimethyl orthoformate and 0.021 g of para-toluenesulfonic acid monohydrate were added at room temperature, and the mixture was refluxed for 1 hour. The reaction mixture was allowed to stand and cooled to about room temperature and concentrated under reduced pressure. To the resultant residue, 5 ml of 1,4-dioxane and 0.23 ml of N-methylpropylamine were added at room temperature, then the mixture was stirred at 80° C. for 3 hours. The reaction mixture was allowed to stand and cooled to about room temperature, then the reaction mixture was concentrated under reduced pressure. The resultant residue was subjected to silica gel column chromatography to obtain 0.19 g of formula:

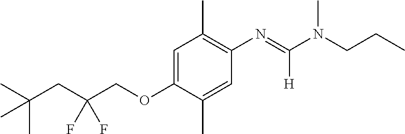 [SMILES: CCCN(C)/C=N/c1cc(C)c(OCC(F)(F)CC(C)(C)C)cc1C]

(hereinafter referred to as “the present compound 20”).

¹H-NMR (CDCl₃) δ: 0.92 (3H, t, J=7.4 Hz), 1.09 (9H, s), 1.62 (2H, m), 2.01 (2H, t, J=20.2 Hz), 2.19 (3H, s), 2.22 (3H, s), 2.97 (3H, s), 3.22 (2H, br s), 4.00 (2H, t, J=12.0 Hz), 6.55 (1H, s), 6.59 (1H, s), 7.39 (1H, s).

### Preparation Example 21 of the Present Compound

To 0.30 g of 2,2-difluoro-4,4-dimethyl-(4-amino-2,5-dimethylphenoxy)pentane, 5 ml of trimethyl orthoformate and 0.021 g of para-toluenesulfonic acid monohydrate were added at room temperature, and the mixture was refluxed for 2 hours. The reaction mixture was allowed to stand and cooled to about room temperature and concentrated under reduced pressure. To the resultant residue, 5 ml of 1,4-dioxane and 0.23 ml of N-methylisopropylamine were added at room temperature, then the mixture was stirred at 80° C. for 3 hours. The reaction mixture was allowed to stand and cooled to about room temperature, then the reaction mixture was concentrated under reduced pressure. The resultant residue was subjected to silica gel column chromatography to obtain 0.17 g of formula:

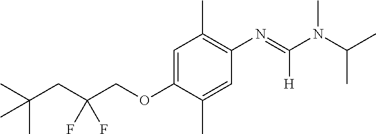 [SMILES: Cc1cc(OCC(F)(F)CC(C)(C)C)c(C)cc1/N=C/N(C)C(C)C]

(hereinafter referred to as “the present compound 21”).

¹H-NMR (CDCl₃) δ: 1.09 (9H, s), 1.22 (6H, d, J=6.8 Hz), 2.01 (2H, t, J=20.0 Hz), 2.19 (3H, s), 2.22 (3H, s), 2.88 (3H, s), 3.36 (1H, br s), 4.00 (2H, t, J=12.0 Hz), 6.56 (1H, s), 6.59 (1H, s), 7.45 (1H, s).

### Preparation Example 22 of the Present Compound

To 0.30 g of 2,2-difluoro-4,4-dimethyl-(4-amino-2,5-dimethylphenoxy)pentane, 5 ml of trimethyl orthoformate and 0.021 g of para-toluenesulfonic acid monohydrate were added at room temperature, and the mixture was refluxed for 2.5 hours. The reaction mixture was allowed to stand and cooled to about room temperature and concentrated under reduced pressure. To the resultant residue, 5 ml of 1,4-dioxane, 0.24 g of N-methylcyclopropylamine hydrochloride and 1 ml of triethylamine were added at room temperature, then, the mixture was stirred at 80° C. for 3 hours. The reaction mixture was allowed to stand and cooled to about room temperature. To the reaction mixture, 5% hydrochloric acid was added, and extracted with ethyl acetate. The organic layer was successively washed with water, an aqueous saturated sodium hydrogen carbonate solution and saturated brine, then dried over sodium sulfate, and concentrated under reduced pressure. The resultant residue was subjected to silica gel column chromatography to obtain 0.16 g of formula:

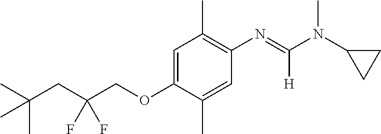 [SMILES: Cc1cc(OCC(F)(F)CC(C)(C)C)c(C)cc1/N=C/N(C)C1CC1]

(hereinafter referred to as “the present compound 22”).

¹H-NMR (CDCl₃) δ: 0.69-0.75 (4H, m), 1.09 (9H, s), 2.01 (2H, t, J=20.0 Hz), 2.19 (3H, s), 2.22 (3H, s), 2.66 (1H, m), 3.01 (3H, s), 4.01 (2H, t, J=12.0 Hz), 6.55 (1H, s), 6.59 (1H, s), 7.57 (1H, s).

### Preparation Example 23 of the Present Compound

To 0.30 g of 2,2-difluoro-4,4-dimethyl-(4-amino-2,5-dimethylphenoxy)pentane, 5 ml of trimethyl orthoformate and 0.021 g of para-toluenesulfonic acid monohydrate were added at room temperature, and the mixture was refluxed for 2 hours. The reaction mixture was allowed to stand and cooled to about room temperature and concentrated under reduced pressure. To the resultant residue, 5 ml of 1,4-dioxane and 0.22 g of N-methylcyclopentylamine were added at room temperature, then the mixture was stirred at 80° C. for 2 hours. The reaction mixture was allowed to stand and cooled to about room temperature, then, the reaction mixture was concentrated under reduced pressure. The resultant residue was subjected to silica gel column chromatography to obtain 0.26 g of formula:

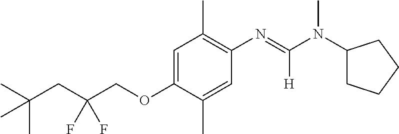 [SMILES: Cc1cc(OCC(F)(F)CC(C)(C)C)c(C)cc1/N=C/N(C)C1CCCC1]

(hereinafter referred to as “the present compound 23”).

¹H-NMR (CDCl₃) δ: 1.09 (9H, s), 1.59-1.74 (6H, m), 1.86-1.90 (2H, m), 2.01 (2H, t, J=20.2 Hz), 2.19 (3H, s), 2.23 (3H, s), 2.90-2.93 (4H, m), 4.00 (2H, t, J=12.0 Hz), 6.56 (1H, s), 6.59 (1H, s), 7.48 (1H, s).

### Preparation Example 24 of the Present Compound

To 0.30 g of 2,2-difluoro-4,4-dimethyl-(4-amino-2,5-dimethylphenoxy)pentane, 5 ml of trimethyl orthoformate and 0.021 g of para-toluenesulfonic acid monohydrate were added at room temperature, and the mixture was refluxed for 2 hours. The reaction mixture was allowed to stand and cooled to about room temperature and concentrated under reduced pressure. To the resultant residue, 5 ml of 1,4-dioxane and 0.25 g of N-methylcyclohexylamine were added at room temperature, then the mixture was stirred at 80° C. for 2 hours. The reaction mixture was allowed to stand and cooled to about room temperature, then, the reaction mixture was concentrated under reduced pressure. The resultant residue was subjected to silica gel column chromatography to obtain 0.26 g of formula:

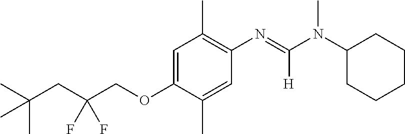 [SMILES: Cc1cc(OCC(F)(F)CC(C)(C)C)c(C)cc1/N=C/N(C)C1CCCCC1]

(hereinafter referred to as “the present compound 24”).

¹H-NMR (CDCl₃) δ: 1.09 (9H, s), 1.23-1.40 (4H, m), 1.44-1.57 (2H, m), 1.83 (4H, m), 2.01 (2H, t, J=20.2 Hz), 2.19 (3H, s), 2.22 (3H, s), 2.92 (3H, s), 3.12 (1H, br s), 4.00 (2H, t, J=12.0 Hz), 6.56 (1H, s), 6.59 (1H, s), 7.47 (1H, s).

### Preparation Example 25 of the Present Compound

To 0.30 g of 2,2-difluoro-4,4-dimethyl-(4-amino-2,5-dimethylphenoxy)pentane, 5 ml of trimethyl orthoformate and 0.021 g of para-toluenesulfonic acid monohydrate were added at room temperature, and the mixture was refluxed for 2 hours. The reaction mixture was allowed to stand and cooled to about room temperature and concentrated under reduced pressure. To the resultant residue, 5 ml of 1,4-dioxane, 1 ml of triethylamine and 0.27 g of N-methylcyclobutylamine were added at room temperature, then the mixture was stirred at 80° C. for 2 hours. The reaction mixture was allowed to stand and cooled to about room temperature, then, the reaction mixture was concentrated under reduced pressure. The resultant residue was subjected to silica gel column chromatography to obtain 0.23 g of formula:

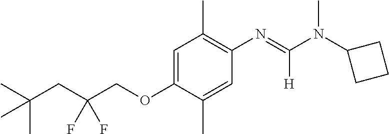 [SMILES: Cc1cc(OCC(F)(F)CC(C)(C)C)c(C)cc1/N=C/N(C)C1CCC1]

(hereinafter referred to as “the present compound 25”).

¹H-NMR (CDCl₃) δ: 1.09 (9H, s), 1.62-1.77 (2H, m), 2.01 (2H, t, J=20.0 Hz), 2.19-2.22 (10H, m), 2.94-2.96 (4H, m), 4.01 (2H, t, J=12.0 Hz), 6.55 (1H, s), 6.59 (1H, s), 7.44 (1H, s).

### Preparation Example 26 of the Present Compound

To 0.51 g of (Z)-2-fluoro-4,4-dimethyl-(4-amino-2,5-dimethylphenoxy)penta-2-ene, 8 ml of trimethyl orthoformate and 0.038 g of para-toluenesulfonic acid monohydrate were added at room temperature, and the mixture was refluxed for hour. The reaction mixture was allowed to stand and cooled to about room temperature. To the reaction mixture, an aqueous saturated sodium hydrogen carbonate was added, then extract with MTBE. The organic layer was washed with saturated brine, and concentrated under reduced pressure. The resultant residue gave a crude of Methyl N—[(Z)-{2-fluoro-4,4-dimethylpent-2-enyloxy}-2,5-dimethyl]phenylformimidate

To 8 ml of 1,4-dioxane, whole amount of the crude of Methyl N—[(Z)-{2-fluoro-4,4-dimethylpent-2-enyloxy}-2,5-dimethyl]phenylformimidate obtained above was added at room temperature. Then, to the mixture, 0.26 ml of ethylmethylamine was added at room temperature, and the mixture was stirred at 80° C. for 2 hours. The reaction mixture was allowed to stand and cooled to about room temperature, then, the reaction mixture was concentrated under reduced pressure. The resultant residue was subjected to silica gel column chromatography to obtain 0.31 g of formula:

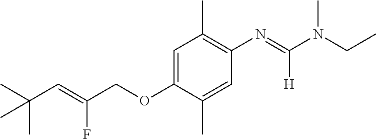 [SMILES: CCN(C)/C=N/c1cc(C)c(OC/C(F)=C/C(C)(C)C)cc1C]

(hereinafter referred to as “the present compound 26”).

¹H-NMR (CDCl₃) δ: 1.01 (9H, s), 1.20 (3H, t, J=7.0 Hz), 2.05 (2H, d, J=25.1 Hz), 2.22 (6H, s), 2.98 (3H, s), 3.35 (2H, br s), 5.79 (1H, d, J=21.0 Hz), 6.55 (1H, s), 6.73 (1H, s), 7.39 (1H, s).

### Preparation Example 27 of the Present Compound

To 0.38 g of 4,4,4-trifluoro-(4-amino-2,5-dimethylphenoxy)but-2-yne, 5 ml of N,N-dimethylformamide dimethylacetal was added at room temperature. The mixture was stirred at 90° C. for 1 hour. The reaction mixture was allowed to stand and cooled to about room temperature, then the reaction mixture was concentrated under reduced pressure. The resultant residue was subjected to silica gel column chromatography to obtain 0.22 g of formula:

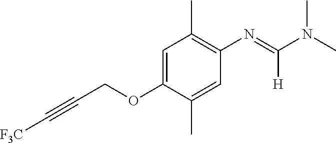 [SMILES: Cc1cc(OCC#CC(F)(F)F)c(C)cc1/N=C/N(C)C]

(hereinafter referred to as “the present compound 27”).

¹H-NMR (CDCl₃) δ: 2.18 (3H, s), 2.24 (3H, s), 2.99 (6H, s), 4.73 (2H, q, J=3.1 Hz), 6.56 (1H, s), 6.69 (1H, s), 7.38 (1H, s).

Next, reference production examples will be shown for illustrating production of a production intermediate of the present compound.

### Reference Production Example 1

To 10 g of 4-hydroxy-2,5-dimethylaniline, 60 ml of trimethyl orthoformate and 1.4 g of para-toluenesulfonic acid monohydrate were added, and the mixture was refluxed for 1 hour. The reaction mixture was allowed to stand and cooled to about room temperature, then, to the reaction mixture, an aqueous saturated sodium hydrogen carbonate solution was added. The mixture was concentrated under reduced pressure. The resultant residue was washed with an aqueous saturated sodium hydrogen carbonate solution and mixed solvent of hexane and MTBE successively, and gave 13 g of Methyl N-(4-hydroxy-2,5-dimethylphenyl)formimidate.

### Methyl N-(4-hydroxy-2,5-dimethylphenyl)formimidate

¹H-NMR (CDCl₃) δ: 2.17 (3H, s), 2.19 (3H, s), 3.87 (3H, s), 6.55 (1H, s), 6.61 (1H, s), 7.64 (1H, s).

To 13 g of Methyl N-(4-hydroxy-2,5-dimethylphenyl)formimidate, 200 ml of 1,4-dioxane was added at room temperature. To the mixture, 12 ml of ethylmethylamine was added at room temperature, and the mixture was stirred at 80° C. for 2 hours. The reaction mixture was allowed to stand and cooled to about room temperature, and concentrated under reduced pressure. The resulting solid was collected by filtration and washed with MTBE to obtain 8.1 g of N-ethyl-N′-(4-hydroxy-2,5-dimethylphenyl)-N-methyformamidine.

### N-ethyl-N′-(4-hydroxy-2,5-dimethylphenyl)-N-methylormamidine

¹H-NMR (CDCl₃) δ: 1.19 (3H, t, J=7.2 Hz), 2.18 (3H, s), 2.19 (3H, s), 2.97 (3H, s), 3.34 (2H, br s), 6.51 (1H, s), 6.58 (1H, s), 7.38 (1H, s).

### Reference Production Example 2

To 1.0 litre of acetonitrile, 2,5-dimethyl-4-hydroxybenzene and 44 g of potassium carbonate were added at room temperature. To the mixture, 56 g of bromomethyl (2,2-dimethylpropyl)ketone was added at room temperature, then the mixture was refluxed for 1 hour. The reaction mixture was allowed to stand and cooled to about room temperature, then filtered through Celite®, and the filtrate was concentrated under reduced pressure. To the resultant residue, water was added, and extracted with MTBE. The organic layer was successively washed with 1% aqueous sodium hydroxide solution and saturated brine, then dried over sodium sulfate, and concentrated under reduced pressure. The resultant residue was subjected to silica gel column chromatography to obtain 72 g of 4,4-dimethyl-(2,5-dimethyl-4-nitrophenoxy)pentan-2-one.

### 4,4-dimethyl-(2,5-dimethyl-4-nitrophenoxy)pentan-2-one

¹H-NMR (CDCl₃) δ: 1.07 (9H, s), 2.32 (3H, s), 2.48 (2H, s), 2.59 (3H, s), 4.59 (2H, s), 6.47 (1H, s), 7.95 (1H, s).

To 22 g of 4,4-dimethyl-(2,5-dimethyl-4-nitrophenoxy)pentan-2-one, 52 g of bis(2-methoxyethyl)aminosulfur trifluoride was added, and the mixture was stirred at 70° C. for 5 hours and 30 minutes. The reaction mixture was allowed to stand and cooled to about room temperature, diluted with MTBE. The obtained dilution was poured into water, and extracted with MTBE. The organic layer was washed with an aqueous saturated sodium hydrogen carbonate solution and saturated brine successively, then dried over sodium sulfate, and concentrated under reduced pressure. The resultant residue was subjected to silica gel column chromatography to obtain g of 2,2-difluoro-4,4-dimethyl-(2,5-dimethyl-4-nitrophenoxy)pentane.

To 13 g of 2,2-difluoro-4,4-dimethyl-(2,5-dimethyl-4-nitrophenoxy)pentane, 450 ml of chloroform and 200 ml of methanol were added at room temperature. An ozone gas was blown into the mixture with stirring at the range of −40° C. to −35° C. for 1 hour. A nitrogen gas was blown into the mixture with stirring at the range of −40° C. to −35° C. for 30 minutes. To the mixture, 8.8 g of sodium borohydride was added at the range of −40° C. to −35° C., and the mixture was stirred at 0° C. for 30 minutes. To the reaction mixture, conc. HCl was added until pH value of the mixture had reached to more than 10, and concentrated under reduced pressure. To the resultant residue, water was added, and extracted with MTBE. The organic layer was washed with an aqueous saturated sodium hydrogen carbonate solution and saturated brine successively, then dried over sodium sulfate, and concentrated under reduced pressure. The resultant residue was subjected to silica gel column chromatography to obtain 13 g of 2,2-difluoro-4,4-dimethyl-(2,5-dimethyl-4-nitrophenoxy)pentane.

### 2,2-difluoro-4,4-dimethyl-(2,5-dimethyl-4-nitrophenoxy)pentane

¹H-NMR (CDCl₃) δ: 1.10 (9H, s), 2.01 (2H, t, J=20.0 Hz), 2.27 (3H, s), 2.62 (3H, s), 4.13 (2H, t, J=11.6 Hz), 6.63 (1H, s), 7.94 (1H, s).

13 g of 2,2-difluoro-4,4-dimethyl-(2,5-dimethyl-4-nitrophenoxy)pentane, 0.9 g of 10% paradium carbon was added, then to the mixture, 150 ml of ethanol was added. The mixture was stirred under 0.40 Mpa of hydrogen gas atmosphere for 3 hours. The reaction mixture was filtered through Celite®, and the filtrate was concentrated under reduced pressure to obtain 11 g of 2,2-difluoro-(4-amino-2,5-dimethylphenoxy)pentane.

### 2,2-difluoro-(4-amino-2,5-dimethylphenoxy)pentane

¹H-NMR (CDCl₃) δ: 1.09 (9H, s), 2.00 (2H, t, J=20.1 Hz), 2.14 (3H, s), 2.16 (3H, s), 3.97 (2H, t, J=12.0 Hz), 6.52 (1H, s), 6.54 (1H, s).

### Reference Production Example 3

To 10 ml of DMF, 1.0 g of 2,5-dimethyl-4-hydroxybromobenzene and 0.69 g of potassium carbonate were added. To the mixture, 0.72 g of bromomethyl ethyl ketone was added at room temperature, and the mixture was stirred at room temperature for 4 hours. To the reaction mixture, water was added and extracted with MTBE. The organic layer was washed with an aqueous 1% sodium hydroxide solution and a saturated brine, then dried over sodium sulfate, and concentrated under reduced pressure. The resultant residue was washed with mixed-solvent of hexane and MTBE to obtain 0.78 g of (4-bromo-2,5-dimethylphenoxy)butan-2-one.

### (4-bromo-2,5-dimethylphenoxy)butan-2-one

¹H-NMR (CDCl₃) δ: 1.12 (3H, t, J=7.2 Hz), 2.24 (3H, s), 2.33 (3H, s), 2.66 (2H, q, J=14.1 Hz), 4.51 (2H, s), 6.53 (1H, s), 7.31 (1H, s).

To 10 ml of chloroform, 0.52 g of (4-bromo-2,5-dimethylphenoxy)butan-2-one was added. To the mixture, 0.40 ml of diethylaminosulfur trifluoride was added at 0° C., and stirred at room temperature for 13 hours and 30 minutes. To the reaction mixture, an aqueous saturated sodium hydrogen carbonate solution was added, and extracted with chloroform. The organic layer was washed with saturated brine, then dried over sodium sulfate, and concentrated under reduced pressure. The resultant residue was subjected to silica gel column chromatography to obtain 0.38 g of 2,2-difluoro-(4-bromo-2,5-dimethylphenoxy)butane.

### 2,2-difluoro-(4-bromo-2,5-dimethylphenoxy)butane

¹H-NMR (CDCl₃) δ: 1.08 (3H, t, J=7.6 Hz), 2.05-2.12 (2H, m), 2.17 (3H, s), 2.35 (3H, s), 4.08 (2H, t, J=11.5 Hz), 6.66 (1H, s), 7.29 (1H, s).

To 0.56 g of 2,2-difluoro-(4-bromo-2,5-dimethylphenoxy)butane, 0.088 g of tris(dibenzylideneacetone)dipalladium, 0.63 g of triphenylsilylamine and 0.080 g of 2-(dicyclohexylphosphino)biphenyl were added at room temperature. To the mixture, 2.5 ml of 1N solution in toluene of lithium hexamethyldisilazide was added, and the mixture was stirred at 100° C. for 9 hours. The reaction mixture was allowed to stand and cooled to about room temperature. To the reaction mixture, 10 ml of 1N hydrochloric acid was added, and the mixture was stirred at room temperature for 30 minutes. To the reaction mixture, an aqueous saturated sodium hydrogen carbonate solution was added until pH value of the mixture had reached to less than 10, then, extracted with ethyl acetate. The organic layer was washed with saturated brine, then dried over sodium sulfate, and concentrated under reduced pressure. The resultant residue was subjected to silica gel column chromatography to obtain 0.34 g of 2,2-difluoro-(4-amino-2,5-dimethylphenoxy)butane.

### 2,2-difluoro-(4-amino-2,5-dimethylphenoxy)butane

¹H-NMR (CDCl₃) δ: 1.07 (3H, t, J=7.6 Hz), 2.03-2.12 (2H, m), 2.13 (3H, s), 2.15 (3H, s), 3.34 (2H, br s), 4.03 (2H, t, J=11.7 Hz), 6.51 (1H, s), 6.56 (1H, s).

### Reference Production Example 4

To 30 ml of DMF, 2.0 g of 2,5-dimethyl-4-hydroxybromobenzene and 1.4 g of potassium carbonate were added. To the mixture, 1.7 g of bromomethyl 2-methylpropyl ketone was added at room temperature, then the mixture was stirred at room temperature for 2 hours. To the reaction mixture, water was added, then extracted with MTBE. The organic layer was washed with an aqueous 1% sodium hydroxide solution and saturated brine successively, then dried over sodium sulfate, and concentrated under reduced pressure. The resultant residue was washed with mixed-solvent of hexane and MTBE to obtain 1.7 g of 4-methyl-2,5-dimethyl-4-bromophenoxy)pentan-2-one.

### 4-methyl-2,5-dimethyl-4-bromophenoxy)pentan-2-one

¹H-NMR (CDCl₃) δ: 0.96 (6H, d, J=6.8 Hz), 2.22-2.25 (4H, m), 2.32 (3H, s), 2.48 (2H, d, J=6.8 Hz), 4.48 (2H, s), 6.51 (1H, s), 7.31 (1H, s).

To 15 ml of chloroform, 1.2 g of 4-methyl-2,5-dimethyl-4-bromophenoxy)pentan-2-one was added at room temperature. To the mixture, 0.45 ml of diethylaminosulfur trifluoride was added at 0° C., the mixture was stirred at room temperature for 15 hours and 30 minutes. To the reaction mixture, an aqueous saturated sodium hydrogen carbonate solution was added, then extracted with chloroform. The organic layer was washed with saturated brine, then dried over sodium sulfate, and concentrated under reduced pressure. The resultant residue was subjected to silica gel column chromatography to obtain 0.62 g of 2,2-difluoro-4-methyl-(2,5-dimethyl-4-bromophenoxy)pentane.

### 2,2-difluoro-4-methyl-(2,5-dimethyl-4-bromophenoxy)pentane

¹H-NMR (CDCl₃) δ: 1.02 (6H, d, J=5.9 Hz), 1.94-1.98 (3H, m), 2.18 (3H, s), 2.35 (3H, s), 4.06 (2H, t, J=11.6 Hz), 6.65 (1H, s), 7.29 (1H, s).

To 0.56 g of 2,2-difluoro-4-methyl-(2,5-dimethyl-4-bromophenoxy)pentane, 0.080 g of tris(dibenzilideneacetone)dipalladium, 0.58 g of triphenylsilylamine and 0.074 g of 2-(dicyclohexylphosphino)biphenyl were added at room temperature. To the mixture, 2.3 ml of 1N toluene solution of lithium hexamethyldisilazide was added, and stirred at 100° C. for 8 hours and 30 minutes. The reaction mixture was allowed to stand and cooled to about room temperature. To the reaction mixture, 10 ml of 1N hydrochloric acid was added, then, the mixture was stirred at room temperature for 1 hour and 30 minutes. To the reaction mixture, an aqueous saturated sodium hydrogen carbonate solution was added until pH value of the mixture had reached to less than 10, then, extracted with ethyl acetate. The organic layer was washed with saturated brine, then dried over sodium sulfate, and concentrated under reduced pressure. The resultant residue was subjected to silica gel column chromatography to obtain 0.33 g of 2,2-difluoro-4-methyl-(2,5-dimethyl-4-aminophenoxy)pentane.

### 2,2-difluoro-4-methyl-(2,5-dimethyl-4-aminophenoxy)pentane

¹H-NMR (CDCl₃) δ: 1.01 (6H, d, J=6.1 Hz), 1.90-2.01 (3H, m), 2.13 (3H, s), 2.16 (3H, s), 3.34 (2H, br s), 4.01 (2H, t, J=11.8 Hz), 6.51 (1H, s), 6.55 (1H, s).

### Reference Production Example 5

To 20 ml of 1,4-dioxane, 1.2 g of 2,2-difluoro-4,4-dimethyl-(4-amino-2,5-dimethylphenoxy)pentane was added. To the mixture, 3.1 g of potassium tert-butoxide was added, then the mixture was refluxed for 7 hours. The reaction mixture was allowed to stand and cooled to about room temperature. To the reaction mixture, water was added, and extracted with ethyl acetate. The organic layer was washed with saturated brine, then dried over sodium sulfate, and concentrated under reduced pressure. The resultant residue was subjected to silica gel column chromatography to obtain 0.51 g of (Z)-2-fluoro-4,4-dimethyl-(4-amino-2,5-dimethylphenoxy)pentan-2-ene.

### (Z)-2-fluoro-4,4-dimethyl-(4-amino-2,5-dimethylphenoxy)pentan-2-ene

¹H-NMR (CDCl₃) δ: 1.00 (9H, s), 2.12 (3H, s), 2.20 (3H, s), 3.38 (2H, br s), 4.55 (2H, s), 5.72 (1H, d, J=21.3 Hz), 6.50 (1H, s), 6.68 (1H, s).

### Reference Production Example 6

To 200 ml of toluene, 10 g of 2,5-dimethyl-4-hydroxynitrobenzene, 7.5 g of 4,4,4-trifluorobutan-2-ol and 16 g of triphenylphosphine were added at room temperature. To the mixture, 27 ml of 2.2 M toluene solution of diethyl azodicarboxylate was added at 0° C., then, the mixture was stirred at room temperature for 1 hour. The reaction mixture was concentrated under reduced pressure, then the resultant residue was subjected to silica gel column chromatography and recrystallization from mixed solvent of hexane and chloroform to obtain 1.5 g of 4,4-dimethyl-(2,5-dimethyl-4-nitrophenoxy)pentan-2-one. Then, the mother liquid obtained by the recrystallization was concentrated. The resulting residue was subjected to silica gel column chromatography and recrystallization from mixed solvent of hexane and chloroform to obtain 0.8 g of 4,4-dimethyl-(2,5-dimethyl-4-nitrophenoxy)pentan-2-one.

### 4,4-dimethyl-(2,5-dimethyl-4-nitrophenoxy)pentan-2-one

¹H-NMR (CDCl₃) δ: 2.26 (3H, s), 2.64 (3H, s), 4.90 (2H, q, J=3.0 Hz), 6.71 (1H, s), 7.94 (1H, s).

To 4 ml of water, 2.0 g of iron powder, 1.9 g of 4,4-dimethyl-(2,5-dimethyl-4-nitrophenoxy)pentan-2-one and 28 ml of acetic acid were added at room temperature, and stirred at 80° C. for 1 hour and 30 minutes. The reaction mixture was allowed to stand and cooled to about room temperature, then filtered through Celite®. The filterate was concentrated under reduced pressure. The resulting residue was subjected to silica gel column chromatography and high performance liquid chromatography successively to obtain 0.38 g of 4,4,4-trifluoro-(4-amino-2,5-dimethylphenoxy)butan-2-yne.

### 4,4,4-trifluoro-(4-amino-2,5-dimethylphenoxy)butan-2-yne

¹H-NMR (CDCl₃) δ: 2.14 (3H, s), 2.15 (3H, s), 3.37 (2H, br s), 4.67 (2H, q, J=3.1 Hz), 6.50 (1H, s), 6.64 (1H, s).

### Formulation Example 1

Fifty parts of any one of the present compounds 1-27, 3 parts of calcium ligninsulfonate, 2 parts of magnesium laurylsulfate, and 45 parts of synthetic hydrous silicon oxide are thoroughly ground and mixed to obtain a formulation.

### Formulation Example 2

Twenty parts of any one of the present compounds 1-27 and 1.5 parts of sorbitan trioleate are mixed with 28.5 parts of an aqueous solution containing 2 parts of polyvinyl alcohol, and the mixture is pulverized by wet pulverizing method. Then, 40 parts of an aqueous solution containing 0.05 parts of xanthan gum and 0.1 parts of aluminum magnesium silicate are added thereto, and further added 10 parts of propylene glycol, followed by stirring and mixing to obtain a formulation.

### Formulation Example 3

Two parts of any one of the present compounds 1-27, 88 parts of kaolin clay and 10 parts of talc are thoroughly ground and mixed to obtain a formulation.

### Formulation Example 4

Five parts of any one of the present compounds 1-27, 14 parts of polyoxyethylenestyrylphenyl ether, 6 parts of calcium dodecylbenzenesulfonate, and 75 parts of xylene are thoroughly mixed to obtain a formulation.

### Formulation Example 5

Two parts of any one of the present compound 1-27, 1 part of synthetic hydrous silicon oxide, 2 parts of calcium ligninsulfonate, 30 parts of bentonite and 65 parts of kaolin clay are thoroughly ground and mixed, then water is added thereto, followed by thoroughly kneading and granulation drying to obtain a formulation.

### Formulation Example 6

Ten parts of any one of the present compound 1-27, 35 parts of white carbon containing 50 parts of polyoxyethylene alkyl ether sulfate ammonium salt, and 55 parts of water are mixed, and the mixture is pulverized by wet pulverizing method to obtain a formulation.

Hereinafter, usefulness of the present compounds for controlling plant diseases is shown by test examples.

Here, the controlling effect was evaluated by comparing the area of lesions on test plants treated with the present compound with that on untreated plants through visual observation of the area of lesion on the test plant at testing.

### Test Example 1

A Plastic pot was stuffed with soil, then, rice plant (plant variety; Nihonbare) was sowed on this, and allowed to grow in a greenhouse for 20 days. Each of the present compounds 1, 15 and 22 was formulated according to Formulation Example 2, and the formulation was diluted with water so that the concentration of active ingredients was 200 ppm. Then, the dilution was carried out so that the dilution might adhere sufficiently to the surfaces of leaves of the grown rice. After the foliage application, the plant was air-dried and then grown in contact with a rice seedling (plant variety; Nihonbare) infected with blast fungus (Magnaporthe grisea), for 6 days at 24° C. and a high humidity in the daytime and at 20° C. and a high humidity in the nighttime. Then, the area of lesions was investigated. As a result, it was found that the area of lesions on the plant treated with each of the present compounds 1, 15 and 22 was 30% or less of the area of lesions on an untreated plant.

### Test Example 2

A plastic pot was stuffed with soil, then, wheat (variety; Shirogane) was sown on this, and allowed to grow in a greenhouse for 9 days. Then the plant was inoculated with spores of leaf rust (Puccinia recondita) by sprinkling. After inoculation the plant was allowed to stand under dark and highly humid condition at 23° C. for one day, then, the plant was air-dried. Each of the present compounds 1 and 2 was formulated according to Formulation Example 2, and the formulation was diluted with water so that the concentration of active ingredients was 200 ppm. Then, the dilution was carried out so that the dilution might adhere sufficiently to the surfaces of leaves of grown wheat. After completion of the foliar application, the plant was air-dried, and allowed to stand for 7 days under illumination, then, the lesion area was investigated. As a result, it was found that the area of lesions on the plant treated with each of the present compounds 1 and 2 was 30% or less of the area of lesions on an untreated plant.

### Test Example 3

A Plastic pot was stuffed with soil, then, wheat (variety; Shirogane) was sowed on this, and allowed to grow in a greenhouse for 9 days. Each of the present compounds 1, 2, 3, 4, 5, 8, 12, 13, 14, 15, 16, 17, 18, 19, 20, 21, 22, 23, 24, 25 and 26 was formulated according to Formulation Example 2, and the formulation was diluted with water so that the concentration of active ingredients was 200 ppm. Then, the dilution was carried out so that the dilution might adhere sufficiently to the surfaces of leaves of the grown rice. After the foliage application, the plant was air-dried and allowed to stand at 18° C. for 5 days under illumination. Then the plant was inoculated with spores of leaf rust (Puccinia recondita) by sprinkling. After inoculation the plant was first allowed to stand under dark for one day, further, allowed to stand at 18° C. under illumination for 8 days, then, the area of lesions was investigated. As a result, it was found that the area of lesions on the plant treated with each of the present compounds 1, 2, 3, 4, 5, 8, 12, 13, 14, 15, 16, 17, 18, 19, 20, 21, 22, 23, 24, 25 and 26 was 30% or less of the area of lesions on an untreated plant.

### Test Example 4

A Plastic pot was stuffed with soil, then, cucumber (plant variety; Sagamihanjiro) was sowed on this, and allowed to grow in a greenhouse for 12 days. Each of the present compounds 1, 2, 3, 4, 5, 8, 9, 10, 11, 12, 13, 14, 15, 17, 18, 19, 20, 21, 22 and 26 was formulated according to Formulation Example 2, and the formulation was diluted with water so that the concentration of active ingredients was 200 ppm. Then, the dilution was carried out so that the dilution might adhere sufficiently to the surfaces of leaves of the grown cucumber. After completion of the foliar application, the plant was air-dried, and inoculated with spores of powdery mildew (Sphaerotheca fuliginea) by sprinkling. After inoculation the plant was placed in a greenhouse for 11 days at 24° C. in the daytime and at 20° C. in the nighttime. Then, the area of lesions was investigated. As a result, it was found that the area of lesions on the plant treated with each of the present compounds 1, 2, 3, 4, 5, 8, 9, 10, 11, 12, 13, 14, 15, 17, 18, 19, 20, 21, 22 and 26 was 30% or less of the area of lesions on an untreated plant.

### Test Example 5

A Plastic pot was stuffed with soil, then, wheat (variety: Apogee) was sowed on this, and allowed to grow in a greenhouse for 10 days. Each of the present compounds 1, 8, 15, 16, 18, 19, 20, 21, 22, 24 and 25 was formulated according to Formulation Example 2, and the formulation was diluted with water so that the concentration of active ingredients was 200 ppm. Then, the dilution was carried out so that the dilution might adhere sufficiently to the surfaces of leaves of the grown wheat. After completion of the foliar application, the plant was air-dried, and two days after, inoculated with an aqueous suspension of Septoria tritici spores by spraying. After inoculation, the plant was first allowed to stand at 18° C. and a high humidity for 3 days, further, allowed to stand for 14 to 18 days under illumination, then, the lesion area was investigated. As a result, the lesion area on the plant treated with each of the present compounds 1, 8, 15, 16, 18, 19, 20, 21, 22, 24 and 25 was 30% or less of the area of lesions on an untreated plant.

### Test Example 6

A Plastic pot was stuffed with soil, then, barley (variety; Nishinohoshi) was sown on this, and allowed to grow in a greenhouse for 7 days. Each of the present compounds 1, 2, 8, 13, 14, 15, 16, 17, 20, 21, 22, 23 and 25 was formulated according to Formulation Example 2, and the formulation was diluted with water so that the concentration of active ingredients was 200 ppm. Then, the dilution was carried out so that the dilution might adhere sufficiently to the surfaces of leaves of the grown barley. After completion of the foliar application, the plant was air-dried, and two days after, inoculated with an aqueous suspension of Pyrenophora teres spores by spraying. After inoculation, the plant was first allowed to be placed in a greenhouse for 3 days at 23 C and a high humidity in the daytime and at 20° C. and a high humidity in the nighttime, further, allowed to stand for 7 days in greenhouse, then the lesion area was investigated. As a result, the lesion area on the plant treated with each of the present compounds 1, 2, 8, 13, 14, 15, 16, 17, 20, 21, 22, 23 and 25 was 30% or less of the area of lesions on an untreated plant.

### Test Example 7

A Plastic pot was stuffed with soil, then, cucumber (plant variety; Sagamihanjiro) was sowed on this, and allowed to grow in a greenhouse for 12 days. Each of the present compounds 6 and 7 was formulated according to Formulation Example 2, and the formulation was diluted with water so that the concentration of active ingredients was 50 ppm. Then, the dilution was carried out so that the dilution might adhere sufficiently to the surfaces of leaves of the grown cucumber. After completion of the foliar application, the plant was air-dried, and inoculated with spores of powdery mildew (Sphaerotheca fuliginea) by sprinkling. After inoculation the plant was placed in a greenhouse for 11 days at 24° C. in the daytime and at 20° C. in the nighttime. Then, the area of lesions was investigated. As a result, it was found that the area of lesions on the plant treated with each of the present compounds 6 and 7 was 30% or less of the area of lesions on an untreated plant.

### Test Example 8

A Plastic pot was stuffed with soil, then, barley (variety; Nishinohoshi) was sown on this, and allowed to grow in a greenhouse for 7 days. The present compound 7 was formulated according to Formulation Example 2, and the formulation was diluted with water so that the concentration of active ingredients was 50 ppm. Then, the dilution was carried out so that the dilution might adhere sufficiently to the surfaces of leaves of the grown barley. After completion of the foliar application, the plant was air-dried, and two days after, inoculated with an aqueous suspension of Pyrenophora teres spores by spraying. After inoculation, the plant was first allowed to be placed in a greenhouse for 3 days at 23° C. and a high humidity in the daytime and at 20° C. and a high humidity in the nighttime, further, allowed to stand for 7 days in greenhouse, then, the lesion area was investigated. As a result, the lesion area on the plant treated with the present compound 7 was 30% or less of the area of lesions on an untreated plant.

### Test Example 9

A plastic pot was stuffed with soil, then, wheat (variety; Shirogane) was sown on this, and allowed to grow in a greenhouse for 9 days. Then the plant was inoculated with spores of leaf rust (Puccinia recondita) by sprinkling. After inoculation the plant was allowed to stand under dark and highly humid condition at 23° C. for one day, then, the plant was air-dried. Each of the present compounds 6 and 7 was formulated according to Formulation Example 2, and the formulation was diluted with water so that the concentration of active ingredients was 50 ppm. Then, the dilution was carried out so that the dilution might adhere sufficiently to the surfaces of leaves of grown wheat. After completion of the foliar application, the plant was air-dried, and allowed to stand for 7 days under illumination, then, the lesion area was investigated. As a result, it was found that the area of lesions on the plant treated with each of the present compounds 6 and 7 was 30% or less of the area of lesions on an untreated plant.

### Test Example 10

A Plastic pot was stuffed with soil, then, soybean (variety; Kurosengoku) was sown on this, and allowed to grow in a greenhouse for 13 days. Then the plant was inoculated with an aqueous suspension of Phakopsora pachyrhizi spores by spraying. After inoculation the plant was allowed to stand under dark and highly humid condition at 23° C. for one day, then, the plant was air-dried. Each of the present compounds 15, 26 and 27 was formulated according to Formulation Example 2, and the formulation was diluted with water so that the concentration of active ingredients was 200 ppm. Then, the dilution was carried out so that the dilution might adhere sufficiently to the surfaces of leaves of the grown soybean. After completion of the foliar application, the plant was air-dried, and allowed to stand for 14 days under illumination, then, the lesion area was investigated. As a result, the lesion area on the plant treated with each of the present compounds 15, 26 and 27 was 30% or less of the area of lesions on an untreated plant.

### INDUSTRIAL APPLICABILITY

As described hereinabove, the present compound has excellent plant disease controlling effect and hence is useful as an active ingredient of plant disease controlling agents.

1. An amidine compound represented by the formula (1): 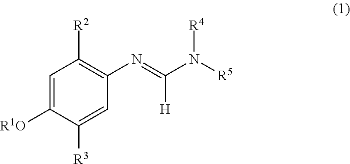
wherein R¹ represent a C1-C11 fluoroalkyl group, a C3-C11 fluoroalkenyl group or a C3-C11 fluoroalkynyl group;
R² represent a C1-C3 alkyl group;
R³ represent a C1-C3 alkyl group;
R⁴ represent a C3-C6 cycloalkyl group or a C1-C6 alkyl group optionally having one or more halogens and R⁵ represent a C3-C6 cycloalkyl group or a C1-C6 alkyl group optionally having one or more halogens.

2. The amidine compound according to claim 1, wherein R⁴ is a C1-C6 alkyl group optionally having one or more halogens and R⁵ is a C1-C6 alkyl group having one or more halogens.

3. The amidine compound according to claim 1, wherein R⁴ is a C1-C6 alkyl group and R⁵ is a C1-C6 alkyl group.

4. A plant disease controlling agent, which comprises the amidine compound according to claim 1 as an active ingredient.

5. A method for controlling plant diseases, which comprises the step of applying an effective amount of the amidine compound according to claim 1 to plants or soils.

6. Use of the amidine compound according to claim 1 for controlling plant diseases.
